(19) United States
(12) Patent Application Publication
(10) Pub. No.: US 2025/0157166 A1
(43) Pub. Date: May 15, 2025

(54) ARTIFICIAL INTELLIGENCE SYSTEMS FOR GENERATION OF HUMAN BODY PART MEASUREMENTS AND HUMAN BODY FIT INFORMATION

(71) Applicant: Bold Metrics, Inc., San Francisco, CA (US)

(72) Inventors: Morgan Linton, San Francisco, CA (US); Daina Burnes, San Francisco, CA (US); Jeff Mergy, Boulder, CO (US)

(21) Appl. No.: 18/948,446

(22) Filed: Nov. 14, 2024

Related U.S. Application Data
(60) Provisional application No. 63/598,867, filed on Nov. 14, 2023.

(51) Int. Cl. G06T 19/20; G06N 20/00

(52) U.S. Cl. CPC G06T 19/20; G06N 20/00; G06T 2219/2012

(57) ABSTRACT

Systems and methods are disclosed for generation of human body part measurements and human body fit information. In some embodiments, a body-realistic human user avatar is created based on generated body measurements for the user. The disclosure includes use of artificial intelligence models to generate extensive body measurements for the user based on minimal physical measurements provided by the user as a training input to the artificial intelligence model. Aspects of the present disclosure address shortcomings present in existing virtual environment approaches that fail to accurately represent real-world human body characteristics or require extensive user-facing hardware components.

### CROSS-REFERENCE TO RELATED APPLICATION(S)

This application claims priority to U.S. Provisional Application No. 63/598,867 filed on Nov. 14, 2023, which is incorporated by reference herein in its entirety.

### TECHNICAL FIELD

Disclosure pertains to artificial intelligence systems for generation of human body part measurements and human body fit information.

### BACKGROUND

Attempts have been made to create virtual environments that simulate real-world scenarios. These include virtual reality environments, such as wearable based virtual reality simulations (e.g., headset-based environments) and fully-immersive virtual reality environments (e.g., cave-based environments). In each instance, the virtual environment attempts to simulate a real-world scenario in order to allow the user to recreate a real-world interaction that the user might otherwise engage in. Generally speaking, these virtual environments aim for realism and immersion through the use of specialized hardware and extensive software-based user configuration.

### SUMMARY

Embodiments of the present disclosure include systems, methods and machine readable media performed by one or more computing devices including one or more processors. The one or more computing devices operate an artificial intelligence model trained based on at least one of human body measurement data and physical garment measurement data.

In some embodiments, a method includes transmitting a user prompt for presentation to a user. The user prompt includes information for prompting the user to input one or more first attributes for the user, such as physiological attributes.

In some embodiments, a method includes receiving a user response to the user prompt. The user response includes information describing one or more first attributes of the user.

In some embodiments, a method includes generating a plurality of estimated body measurements for the user. The plurality of estimated body measurements for the user are generated by applying the information describing one or more first attributes of the user as input to an artificial intelligence model.

In some embodiments, a method includes receiving a garment specification. The garment specification includes information describing sizing characteristics of a garment of clothing.

In some embodiments, a method includes receiving user fit data. The user fit data includes information describing user fit information for one or more second users for the garment of clothing.

In some embodiments, a method includes generating, based on the plurality of estimated body measurements for the user, the garment specification, and the user fit data, a garment size determination for the user for the garment of clothing.

In some embodiments, a method includes generating, based on the plurality of estimated body measurements for the user, the garment specification, and the user fit data, one or more fit descriptions for the user for one or more sizes of the garment of clothing.

In some embodiments, a method includes generating a 3D avatar visualization for the user. In such embodiments, the method may include displaying on a display component the 3D avatar visualization. In such embodiments, the method may include displaying on the display component the one or more fit descriptions for the user for one or more sizes of the garment of clothing.

In some embodiments, a method includes displaying a visualization of the garment of clothing on the 3D avatar visualization for the user.

In some embodiments the 3D avatar visualization for the user is a default 3D avatar visualization for the user.

In some embodiments, generating the 3D avatar visualization for the user includes generating a 3D representation of the body of the user based on the plurality of estimated body measurements for the user.

In some embodiments, the 3D avatar visualization is a body-realistic visualization of the user's body.

In some embodiments, a method includes transmitting a second user prompt for presentation to the user, wherein the second user prompt includes information for prompting the user to input second user information, including at least one additional body data prompt not included in the user prompt.

In some embodiments, a method includes receiving a second user response to the second user prompt, wherein the second user response includes information describing at least one additional body data characteristic of the user. The 3D representation of the body of the user is generated further based on the information describing at least one additional body data characteristic of the user.

In some embodiments, the information describing at least one additional body data characteristic of the user comprises one or more of: hair style; eye color; facial features; skin tone; tattoos; piercings.

In some embodiments, the one or more fit descriptions for the user for one or more sizes of the garment of clothing include a textual description of an estimated fit of the garment of clothing for the user at a specific body location of the user.

In some embodiments, the information describing one or more first attributes of the user comprises one or more of: age height; weight; pant waist; and bra size.

In some embodiments, the plurality of estimated body measurements for the user comprises one or more of: shoes size; hip size; waist size; belly size; chest size; neck size; shoulder size; body shape; stomach shape; hip shape; and head size.

In some embodiments, the information describing sizing characteristics of a garment of clothing comprises one or more of: available sizes for the garment of clothing; available fits for the garment of clothing; fabric properties; silhouettes of the garments; physical measurements for the garment of clothing; and other product tagging information.

In some embodiments, the information describing user fit information for one or more second users for the garment of clothing comprises one or more of: user identifier; garment identifier; garment size information; location of sale; time and date of sale; and reason for return.

In some embodiments, the garment size determination for the user for the garment of clothing is generated based on a second artificial intelligence model.

In some embodiments, the first artificial intelligence model and the second artificial intelligence model are different artificial intelligence models.

In some embodiments, the artificial intelligence model comprises one or more of: a machine learning model; and an artificial neural network.

### BRIEF DESCRIPTION OF THE DRAWINGS

FIG. 1 is a block diagram of a computing system according to some embodiments of the present disclosure.

FIG. 2 is a block diagram of a computing device according to some embodiments of the present disclosure.

FIG. 3A is a flowchart diagram of a process for generating human body part measurements information according to some embodiments of the present disclosure.

FIG. 3B is a flowchart diagram of a process for generating garment size determinations according to some embodiments of the present disclosure.

FIG. 3C is a flowchart diagram of a process for generating garment size determinations according to some embodiments of the present disclosure.

FIG. 3D is a flowchart diagram of a process for generating fit indications according to some embodiments of the present disclosure.

FIG. 4 is a flowchart diagram of a process for generating human body part measurements and garment sizing information according to some embodiments of the present disclosure.

FIG. 5 is a flowchart diagram of a process for generating human body part measurements and garment sizing information according to some embodiments of the present disclosure.

FIG. 6 is a graphical user interface according to some embodiments of the present disclosure.

FIG. 7 is a graphical user interface according to some embodiments of the present disclosure.

FIG. 8 is a graphical user interface according to some embodiments of the present disclosure.

FIG. 9 is a graphical user interface according to some embodiments of the present disclosure.

FIG. 10 is a graphical user interface according to some embodiments of the present disclosure.

FIG. 11 is a graphical user interface according to some embodiments of the present disclosure.

FIG. 12 is a graphical user interface for displaying fit indications according to some embodiments of the present disclosure.

FIG. 13 is a graphical user interface for displaying fit indications according to some embodiments of the present disclosure.

FIG. 14A is a graphical user interface for displaying fit indications according to some embodiments of the present disclosure.

FIG. 14B is a graphical user interface for displaying fit indications according to some embodiments of the present disclosure.

FIG. 14C is a graphical user interface for displaying fit indications according to some embodiments of the present disclosure.

FIG. 15A is a graphical user interface for displaying fit indications according to some embodiments of the present disclosure.

FIG. 15B is a graphical user interface for displaying fit indications according to some embodiments of the present disclosure.

FIG. 15C is a graphical user interface for displaying fit indications according to some embodiments of the present disclosure.

FIG. 16A is a graphical user interface for displaying fit indications according to some embodiments of the present disclosure.

FIG. 16B is a graphical user interface for displaying fit indications according to some embodiments of the present disclosure.

FIG. 16C is a graphical user interface for displaying fit indications according to some embodiments of the present disclosure.

FIG. 16D is a graphical user interface for displaying fit indications according to some embodiments of the present disclosure.

FIG. 16E is a graphical user interface for displaying fit indications according to some embodiments of the present disclosure.

FIG. 17 is a flowchart diagram of a process for generating fit indications according to some embodiments of the present disclosure.

FIG. 18 is a graphical user interface according to some embodiments of the present disclosure.

FIG. 19A is a graphical user interface according to some embodiments of the present disclosure.

FIG. 19B is a graphical user interface according to some embodiments of the present disclosure.

FIG. 20 is a graphical user interface according to some embodiments of the present disclosure.

FIG. 21 is a graphical user interface according to some embodiments of the present disclosure.

FIG. 22 is a graphical user interface according to some embodiments of the present disclosure.

FIG. 23 is a graphical user interface according to some embodiments of the present disclosure.

FIG. 24 is a graphical user interface according to some embodiments of the present disclosure.

FIG. 25 is a graphical user interface according to some embodiments of the present disclosure.

FIG. 26 is a graphical user interface according to some embodiments of the present disclosure.

FIG. 27 is a graphical user interface according to some embodiments of the present disclosure.

FIG. 28 is a graphical user interface according to some embodiments of the present disclosure.

FIG. 29 is a graphical user interface according to some embodiments of the present disclosure.

FIG. 30 is a graphical user interface according to some embodiments of the present disclosure.

FIG. 31 is a graphical user interface according to some embodiments of the present disclosure.

FIG. 32 is a graphical user interface according to some embodiments of the present disclosure.

FIG. 33 is a graphical user interface according to some embodiments of the present disclosure.

FIG. 34 is a graphical user interface according to some embodiments of the present disclosure.

FIG. 35 is a set of graphical user interfaces according to some embodiments of the present disclosure.

FIG. 36 is a graphical user interface according to some embodiments of the present disclosure.

FIG. 37 is a set of graphical user interfaces according to some embodiments of the present disclosure.

FIG. 38 is a set of graphical user interfaces according to some embodiments of the present disclosure.

FIG. 39 is a graphical user interface according to some embodiments of the present disclosure.

FIG. 40 is a graphical user interface according to some embodiments of the present disclosure.

### DETAILED DESCRIPTION

Prior attempts at creating virtual environments to simulate real-world scenarios have fallen short in several situations. First, many such endeavors have leveraged specialized user-facing hardware (e.g., headsets, “cave” rooms) that is not feasible in many scenarios. For example, in many scenarios, the cost or logistical challenge of providing an end user with such hardware is cost prohibitive or otherwise logistically infeasible. Second, while many such endeavors have focused on creating realism and immersion in virtual environments, they have often fallen short for attempting to recreate entire environments generally. As a result, the virtual environments tend to be at most real-world realistic in a macro sense, but fail to accurately recreate a real-world scenario for specific details.

One area in which prior techniques have proven unsuccessful is in allowing users to interact in a virtual environment in way that is realistic to their real-world physical presence. At present, the most effort in creating “realistic” human environments has focused on creating photo-realistic avatars, which generally entails creating a virtual version of the user with a face/head that is intended to mimic the user's real-world physical appearance. However, it is well understood that doing so accurately has not been readily achieved, and as such most photo-realistic avatars use cartoonized representations of the user's real-world appearance, even when detailed data on the user's real-world face/head appearance is available.

Given the inability to accurately recreate a user's face/head in virtual environments, it is not surprising that recreating a user's body—especially below the neck—has received little attention. In most virtual environments, even where an attempt at a photo-realistic avatar is used, the user's body below the neck is generally not rendered fully or only rendered in low resolution, class-based representations that has no relationship to the user's actual body measurements. Indeed, in most such environments, the user's body measurements are not actually known or even estimated.

What is needed is a system and processes whereby a body-realistic estimation of user body measurements can be generated for use in virtual environments. Doing so will allow the creation of virtual environments that allow extensive interactions not presently available with other systems. For example, users may be able to “try on” real-world garments using their virtual avatars and obtain feedback on how the real-world garment will fit the user's real-world body. Such a system may provide more accurate recommendations of garment sizes to the user, reducing significant environmental and material waste that exists in the highly-inefficient virtual garment domain at present.

What is further needed is a system and processes whereby a body-realistic estimation of user body measurements can be generated using minimal user inputs from a user, and ideally, no specialized user-facing hardware. It is known that complicated user “onboarding” activities or the need to obtain specialized hardware will discourage a user from engaging in the use of such a system. Therefore, it is desirable that estimations of a user's body measurements can be obtained based on minimal data input from the user that describes the user's body. In some embodiments, such a system can be created using artificial intelligence and/or machine learning models based on body measurement data, information on garments and garment sizing, as well as a limited number of actual body metrics provided by the specific user.

Certain examples of this disclosure are described with reference to the accompanying drawings, wherein like reference numerals denote elements. It should be understood, however, that the accompanying drawings illustrate only some of the various implementations described herein and are not meant to limit the scope of various technologies described herein. The drawings show and describe various implementations of this disclosure.

In the following description, numerous details are set forth to provide an understanding of the present disclosure. However, it will be understood by those skilled in the art that the present disclosure may be practiced without these details and that numerous variations or modifications from the described examples may be possible.

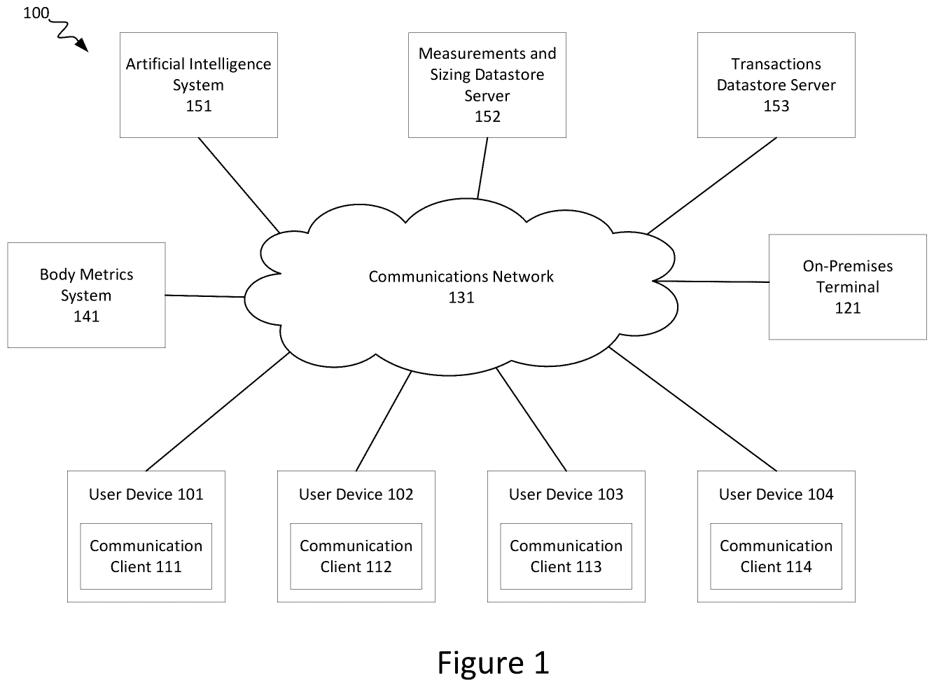

FIG. 1 is a block diagram of a computing system 100 according to some embodiments of the present disclosure. System 100 includes user devices 101, 102, 103, 104, on-premises terminal 121, communication network 131, body metrics system 141, artificial intelligence system 151, measurements and sizing datastore server 152, and transactions datastore server 153. Some other embodiments of the present disclosure may have modifications to this system structure both in terms of the organization of the elements and which elements are present in the system.

The communications network 131 may include any communications network that allows communication between users, devices, or the like. For example, the communication network 131 may be a telecommunications network, such as an IEEE 802.11 Wi-Fi network, a 4G cellular network, a 5G cellular network, a Bluetooth link, a mesh network, other telecommunications network, or some combination of the foregoing.

User devices 101, 102, 103, 104 may include computing devices operated by a user. For example, user devices 101, 102, 103, 104 can include a smartphone, a mobile phone, a tablet computer, a laptop computer, a desktop computer, or other similar devices. The user devices 101, 102, 103, 104 may connect to the communications network 131. For example, the user devices 101, 102, 103, 104 may connect to the communications network 131 through a wireless local area network (e.g., IEEE 802.11 WLAN), a cellular connection (e.g., 4G cellular network, 5G cellular network), a short-range communication connection (e.g., a Bluetooth link), other telecommunications technologies, or some combination of the foregoing. The user may use user devices 101, 102, 103, 104 to access other resources that are also connected to the communications network 131, such as on-premises terminal 121, body metrics system 141, artificial intelligence system 151, measurements and sizing datastore server 152, and transactions datastore server 153.

The user devices 101, 102, 103, 104 may include respective communication clients 111, 112, 113, 114. Communication clients 111, 112, 113, 114 may include software, hardware, or mixed software and hardware modules that configure the user devices 101, 102, 103, 104 to communicate over the communications network 131, such as with on-premises terminal 121, body metrics system 141, artificial intelligence system 151, measurements and sizing datastore server 152, and transactions datastore server 153. In some embodiments, communication clients 111, 112, 113, 114 include a web browser software application. In some embodiments, communication clients 111, 112, 113, 114 include a network adapter card, Wi-Fi transceiver, cellular transceiver, or other similar hardware, software, or mixed hardware/software modules.

On-premises terminal 121 may include computing devices accessible by a user at a physical premises location. For example, on-premises terminal 121 may include a kiosk, a point-of-sale terminal, a thin-client computer, a tablet computer or the like. The on-premises terminal 121 may connect to the communications network 131. For example, the on-premises terminal 121 may connect to the communications network 131 through a wireless local area network (e.g., IEEE 802.11 WLAN), a cellular connection (e.g., 4G cellular network, 5G cellular network), a short-range communication connection (e.g., a Bluetooth link), other telecommunications technologies, or some combination of the foregoing. The on-premises terminal 121 may access other resources that are also connected to the communications network 131, such as user devices 101, 102, 103, 104, body metrics system 141, artificial intelligence system 151, measurements and sizing datastore server 152, and transactions datastore server 153.

The on-premises terminal 121 may be a computing device provided at a physical location, such as in a retail store. The on-premises terminal 121 may be accessible to users and/or retail store employees. The user and/or retail store employees may use the on-premises terminal 121 to enroll the user in the body metrics system 141. Enrollment in the body metrics system 141 may include receiving body metrics for the user, including in response to a user body metrics survey. Other pieces of data that may be gathered at the on-premises terminal 121 are described elsewhere in the present disclosure, and my include the user's age, height, weight, waist size, hip size, arm length, leg length, shoe size, chest size, bra size, hat size, inseam size, wrist size, neck size, BODY MASS INDEX, fit preference (e.g. loose, tight, straight), age, and others. Other measurements of the user's physical body may also be included in the enrollment process. Alternatively, the enrollment process may be performed by the user with user devices 101, 102, 103, 104, including using communication client 111, 112, 113, 1114.

The body metrics system 141 may include a system for providing services related to body metrics. For example, the body metrics system 141 may include a software and/or hardware system that uses machine learning and/or artificial intelligence to determine a user's body measurements based on input body data. In some embodiments, body metrics system 141 may use artificial intelligence system 151 to determine a user's body measurements based on input body data. As a further example, the body metrics system 141 may include a software and/or hardware system that uses machine learning and/or artificial intelligence to determine items of clothing that may best fit a user based on input body data.

As an example, a user may use user device 101 to access the body metrics system 141. The user may provide body data to the user device 101, such as shoe size, height, weight, and age. The user device 101 may then provide the input body data to the body metrics system 141. Based on the input body data, the body metrics system 141 may determine body data for the user, such as biceps circumference, chest circumference, shoulder width, and hand length. The body metrics system 141 may use machine learning and/or artificial intelligence (e.g., artificial neural networks, classification trees, regression, clustering) provided by artificial intelligence system 151 to determine the body data. The body metrics system 141 may provide the determined body data to the user device 101. The user device 101 may provide the determined body data to the user.

Some examples of a body metrics system 141 may include the applicant's Virtual Tailor system and/or the applicant's Virtual Sizer system.

The artificial intelligence system 151 may include a system for training, storing, and/or using artificial intelligence and/or machine learning models. For example, artificial intelligence system 151 may include one or more artificial intelligence and/or machine learning models to determine a user's body measurements, determine garment sizing information, and/or determine fit information. The artificial intelligence and/or machine learning models may include artificial neural network models, linear regression models, non-linear regression models, clustering models, classification models, other types of models, and any combination of these types of models.

In some embodiments, the artificial intelligence system 151 may include a software and/or hardware system that trains, stores, and/or uses a machine learning model and/or artificial intelligence model to determine a user's body measurements based on input body data. In some embodiments, the artificial intelligence system 151 may determine a user's body measurements based on body input data provided by the user, such as three, four, or five body measurements of the user's body provided by the user (e.g., during enrollment in the body metrics system 141). In some embodiments, the artificial intelligence system 151 may additionally use data from the measurements and sizing datastore server 152 and/or the transactions datastore server 153 to determine a user's body measurements.

In some embodiments, the artificial intelligence system 151 may include a software and/or hardware system that trains, stores, and/or uses a machine learning model and/or artificial intelligence model to determine a garment sizing information. In some embodiments, the artificial intelligence system 151 may determine sizing information for a specific garment of clothing. For example, the artificial intelligence system 151 may determine, for a particular user, what sizes of a specific garment are expected to fit the user's body best. Determining this sizing information may include determining a ranking (e.g., best to worst) of sizes for the specific garment that will fit the user's body. In some embodiments, artificial intelligence system 151 may use data from other entities of system 100 to determine garment sizing information, such as: actual user body part measurements provided by user devices 101, 102, 103, 104 or on-premises terminal 121; estimated user body measurements determined by artificial intelligence system 151 as used by body metrics system 141; user body measurements data stored by measurements and sizing datastore server 152; garment size and measurement data stored by measurements and sizing datastore server 152; garment purchase information stored by transactions datastore server 153; garment return information stored by transactions datastore server 153; and/or other data provided by the system 100.

In some embodiments, the artificial intelligence system 151 may include a software and/or hardware system that trains, stores, and/or uses a machine learning model and/or artificial intelligence model to determine fit information. In some embodiments, the artificial intelligence system 151 may determine fit descriptions for a specific garment of clothing for a specific user's body. For example, the artificial intelligence system 151 may determine, for a particular user and a particular garment of clothing, textual descriptions of how the garment of clothing fits on different parts of the user's body. For example, the artificial intelligence system 151 may determine that a specific garment of clothing will fit “relaxed” at the hips of a particular user, “slightly relaxed” at the waist of the particular user, “just right” at the chest of the particular user, “slightly snug” at the shoulder of the user, “snug” at the neck of the user, and “slightly long” at the arm/sleeve of the user. In some embodiments, artificial intelligence system 151 may use data from other entities of system 100 to determine fit information, such as: actual user body part measurements provided by user devices 101, 102, 103, 104 or on-premises terminal 121; estimated user body measurements determined by artificial intelligence system 151 as used by body metrics system 141; user body measurements data stored by measurements and sizing datastore server 152; garment size and measurement data stored by measurements and sizing datastore server 152; garment purchase information stored by transactions datastore server 153; garment return information stored by transactions datastore server 153; and/or other data provided by the system 100.

The measurements and sizing datastore server 152 may include a system for providing measurements and sizing data. For example, the measurements and sizing datastore server 152 may include a software and/or hardware system, such as a server, that stores actual user body measurements, estimated user body measurement, garment size information, garment measurements, and other measurements and sizing data.

The transactions datastore server 153 may include a system for providing transactions data. For example, the transactions datastore server 153 may include a software and/or hardware system, such as a server, that stores transactions data, such as specific garment sales information, specific user sales information, specific garment returns information, specific user returns information, and other transactions data.

In some embodiments, artificial intelligence system 151, measurements and sizing datastore server 152, and/or transactions datastore server 153 may be provided as a component of another entity in system 100, such as body metrics system 141.

In some embodiments, the body metrics system 141 may receive data from the user device 101, 102, 103, 104, which may include the user's body metrics survey response. Other pieces of data being sent from user device 101, 102, 103, 104 will be made apparent in the present disclosure. The user's body metrics survey response 102 may include, but is not limited to, the user's age, height, weight, waist size, hip shape arm length, leg length, shoe size, chest size, bra size, hat size, inseam size, wrist size, neck size, BODY MASS INDEX, fit preference (e.g. loose, tight, straight), and age. The list is a non-exhaustive example of the data that the body metrics system 141 may receive from the user device 101, 102, 103, 104 in the initial body measurement survey. Any sizing or dimension information related to any clothing article could be included in the data received by the body metrics system 141.

In some embodiments, the body metrics system 141 may send data to the artificial intelligence system 151, such as body metrics data. Other pieces of data being sent from body metrics system 141 to the artificial intelligence system 151 will be made apparent in the present disclosure. The user's body metrics data being sent to the artificial intelligence system 151 may contain the user's survey response but may also include clothing data for the user of the user device 101, 102, 103, 104, specific garment specifications, or other data collected by the body metrics system 141 (e.g. the user's shopping history). Specific garment specifications may refer to a piece of clothing that the user of the user device 101, 102, 103, 104 wants to purchase and the dimensions, fit, styling, or other pieces of information about the clothing. As an example, in some embodiments, the body metrics data may include information of a shirt that the user of the user device 101, 102, 103, 104 may be considering purchasing. The information may include the dimensions of the shirt, if the specific type of shirt is known to fit in a certain manner (e.g. relaxed, tight, oversized), if the brand is known to fit in a certain manner, what material the shirt is made of, if that material stretches or not, the intended fit of the shirt, and the ideal body measurements that would fit into that shirt as specified in the design of that garment (e.g., the fit model body measurements or size chart data). In another example, if the user was looking at a pair of pants the information might include styling on whether the pants were designed to be worn around the waist or the hips.

In some embodiments, the artificial intelligence system 151 can be hosted on a remote server or located locally on a device that is connected to the body metrics system 141. The artificial intelligence system 151 may also be located on a device that houses both the artificial intelligence system 151 and the body metrics system 141. In some embodiments, the artificial intelligence system 151 may have its own processor and memory or may share those components as a part of the body metrics system 141. As an example, in some embodiments the artificial intelligence system 151 may be housed on a computer that is coupled to the body metrics system 141 via wiring. In some embodiments, the artificial intelligence system 151 may be stored locally on the body metrics system 141 and shares the same computer components as the body metrics system 141. A non-exhaustive list of examples that could host the artificial intelligence system 151 includes a desktop computer, laptop computer, tablet, smartphone, and server. In some embodiments, once the artificial intelligence system 151 has the received the body metrics data, the artificial intelligence system 151 may generate an estimated body measurements for the user of the user device 101, 102, 103, 104. In some embodiments, the artificial intelligence system 151 may be a part of, a subsystem of, or otherwise included in the body metrics system 141.

In some embodiments, the artificial intelligence system 151 generates estimated body measurements based on the body metrics data alone. In other embodiments, the artificial intelligence system 151 may utilize retailer information (e.g., as stored by transactions datastore server 153), past feedback from the user of the user device 101, 102, 103, 104 (e.g., as stored by transactions datastore server 153), fit data (e.g., as stored by measurements and sizing datastore server 152), and/or information about the clothing article that is collected from the internet (e.g., as stored by measurements and sizing datastore server 152). In some embodiments, the artificial intelligence system 151 can analyze feedback from aggregate reviews of previous purchasers and may determine sizing inconsistencies from said reviews. Once the information has been collected, the artificial intelligence system 151 may generate a garment recommendation.

It is to be understood that “estimated” body measurements may include, in various embodiments, body measurements for a user that are predicted, captured, approximated, or otherwise estimated. For example, an “estimated” body measurement may include a measurement for a part of the user's body that has been generated, predicted, captured, or otherwise estimated based on data about body attributes of the user. As a further example, an “estimated” body measurement may include a measurement for a part of the user's body that has been generated, predicted, captured, or otherwise estimated based on user body attributes, where the user body attributes do not include a direct physical measurement of the part of the user's body. As a further example, an “estimated” body measurement may include a measurement for a part of the user's body that has been generated, predicted, captured, or otherwise estimated using an artificial intelligence model, a machine learning model, and/or a deterministic program or algorithm. As a further example, an “estimated” body measurement may include a measurement for a part of the user's body that has been generated, predicted, captured, or otherwise estimated using an artificial intelligence model, a machine learning model, and/or a deterministic program or algorithm, where a direct physical measurement of the part of the user's body is not available.

In some embodiments, data sent from artificial intelligence system 151 to the body metrics system 141 may include the user's body measurements and the garment sizing recommended, for a particular article of clothing, for the user of the user devices 101, 102, 103, 104. Other pieces of data being sent from the artificial intelligence system 151 to the body metrics system 141 is apparent in the present disclosure. As a non-limiting example, the garment recommendation might include that, based on the user's dimensions, the intended fit by design, the fabric properties, past shopping history, user feedback, and other pieces of information, the best size shirt for the user of the user devices 101, 102, 103, 104 to buy is a size large. In some embodiments, the garment recommendation may include additional information about the article of clothing that would be pertinent for the user of the user devices 101, 102, 103, 104. In some embodiments, the garment recommendation may include information about the likelihood of the article of clothing shrinking over time, whether the material that the article of clothing is made of is able to stretch, or feedback from other users who had similar dimensions to the user of the user device 101, 102, 103, 104 and also purchased the article of clothing.

In some embodiments, the artificial intelligence system 151 may send the garment recommendation back to the user devices 101, 102, 103, 104 and/or the on-premises terminal 121. In some embodiments the user devices 101, 102, 103, 104 and/or the on-premises terminal 121 may display data to the user, including results of processing performed by system 100. In some embodiments the results may include the generated user body measurements and garment sizing recommendations. In some embodiments the results may include other pieces of data that are apparent in later portions of the present disclosure. Those results may be displayed to the user in a text manner. In some embodiments, the user devices 101, 102, 103, 104 and/or the on-premises terminal 121 may hold on to the results and store them in memory. In some embodiments a visual rendering of the user, called an avatar, may be created. The avatar may be a digitally rendered 2D or 3D visualization of the user. The avatar may be generated based on the user's body measurement data. The visual rendering of the avatar may include displaying the garment recommendation on the avatar for the user to visualize what the clothing would look like on a body that has the same body dimensions as the user. The user devices 101, 102, 103, 104 and/or the on-premises terminal 121 may display the results to the user. As an example, the avatar visualization may allow the user to visually see how tight a particular shirt would look on the user's own body. It should be noted that the results can be represented to the user in multiple ways are not limited to only one way at any given time.

When a 2D or 3D avatar is generated according to the body measurement data of the user, it may be referred to as the user's digital twin. The generation of the 2D or 3D avatar or digital twin can occur on the user devices 101, 102, 103, 104 and/or the on-premises terminal 121, the body metrics system 141, the artificial intelligence system 151, or on any suitable device such as a server, cloud infrastructure, or separate computer.

The measurements and sizing datastore server 152 and/or the transactions datastore server 153 may store data of a garment entity, such as retailers, distributors, manufacturers, stores, businesses, websites, markets, or individuals that provide clothing or have clothing data. The information sent from the sizing datastore server 152 and/or the transactions datastore server 153 to the body metrics system 141 and/or artificial intelligence system 151 may include clothing data, user shopping data, availability of merchandise, clothing specifications, clothing stock keeping unit numbers (“SKU”), and shopping trends. The measurements and sizing datastore server 152 and/or the transactions datastore server 153 may send the data digitally via the internet, hardwire, USB transfer, or any other similar method of transferring data.

In some embodiments, the user devices 101, 102, 103, 104 and/or on-premises terminal 121 may be part of a system that performs the actions described in the present disclosure in configuration with other components. such as the artificial intelligence system 151, measurements and sizing datastore server 152 and/or the transactions datastore server 153. In some embodiments, the system may not include measurements and sizing datastore server 152 and/or the transactions datastore server 153 and instead have the product specifications or other data being sent from the retailer to artificial intelligence system 151 and/or body metrics system 141 already stored on the artificial intelligence system 151 and/or body metrics system 141. In some embodiments the system may also include a server or multiple servers that facilitate the interactions described in the present disclosure between the various components. As an example, a server may host the artificial intelligence system 151 such that the model is accessible to the computing device remotely through the internet. A server may also interact with the user device, assist in processing data by providing additional computational resources, or provide other functionality such as generating and displaying a user experience through the user devices 101, 102, 103, 104 and/or on-premises terminal 121.

In various embodiments of the present disclosure, information described as being provided to/from the body metrics system 141 may instead or additionally be provided to/from the user devices 101, 102, 103, 104 and/or to/from the on-premises terminal 121.

A system implementation of the present disclosure may also include an app server in some embodiments. In some embodiments, the app server may facilitate the interactions between the user and the user device 101, 102, 103, 104 as well as the interactions between the user device 101, 102, 103, 104 and the artificial intelligence system 151. In some embodiments, the app server may facilitate interactions between the artificial intelligence system 151, the measurements and sizing datastore server 152, and/or transactions datastore server 103 with the body metrics system 141. As an example, the app server may activate the user with an account so that the user is enabled to input the user survey response to the body metrics system 141 and/or artificial intelligence system 151 via the computing devices 101, 102, 103, 104. In another example, the app server may facilitate the body metrics system 141 sending information to the user device 101, 102, 103, 104 about what clothing garments are available and in stock.

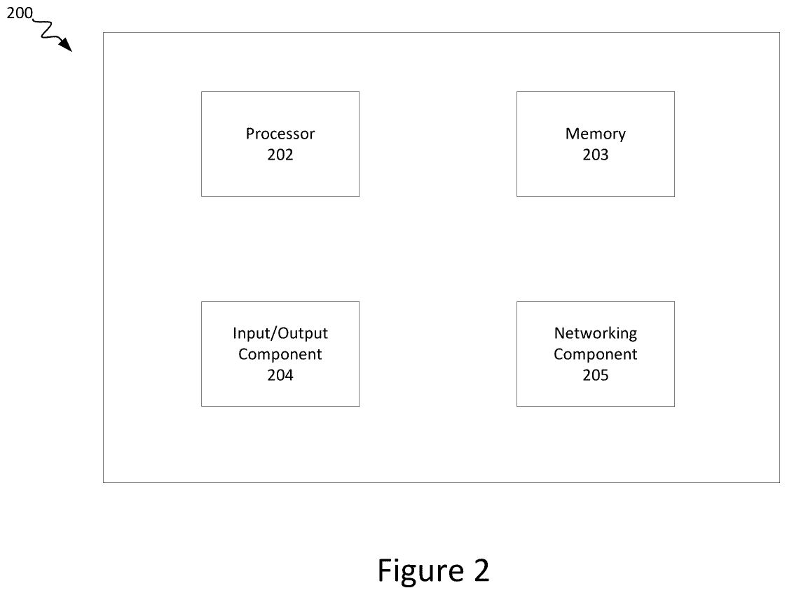

FIG. 2 is a block diagram of a computing device 200 according to some embodiments of this disclosure. The computing device 200 may be, but is not limited to, a smartphone, tablet, computer, point-of-sale terminal, laptop, server, a digital computer, or cloud computing device. Some embodiments of the present disclosure may have modifications to the computing device 200 structure both in terms of the organization of the elements and which elements are present in the system. The computing device 200 may be provided as a computing device as described elsewhere herein (e.g. user devices 101, 102, 103, 104, on-premises terminal 121, body metrics system 141, artificial intelligence system 151, measurement and sizing datastore server 152, transactions datastore server 153) in some embodiments of the present disclosure. In some embodiments the processor 202 and memory 203 may be combined into one component.

The computing device 200 contains a processor 202, connected with memory 203, input/output component 204, and a networking component 205. In some embodiments, the above components may be interconnected. In other embodiments, there may be limited connections between the individual components and the computing device 200 may have the processor 202 connect to each other component either directly or through a motherboard or similar circuit. The computing device 200 also contains a power supply that is connected to at least the processor 202. The power supply may also be connected to other components within the computing device 200. The power supply may be a battery that is within the device and must be recharged or a power supply that is directly connected to electricity depending on the embodiment. The components within the computing device 200 can be coupled together by coupling which can be wired (e.g., a wired communications bus) or wirelessly. In some embodiments only a subset of the components may be connected together directly.

The processor 202 may be, but is not limited to, a dedicated central processing unit (“CPU”), a combination of a CPU and graphics processing unit (“GPU”), a microprocessor, a logical processing unit, or other processor structures known in the art.

The processor 202 may be configured to process instructions that are located in the memory 203. In some embodiments, the processor 202 may also have its own dedicated storage that holds data or instructions. As an example, the processor 202 may receive instructions to display the results to the user and the processor 202 will retrieve the results from the memory and display the results through the input/output component 204. The processor 202 may be configured to receive data received through the networking component 205 and store said data within the memory 203. The processor 202 may be configured to receive instructions, data, or information received by the input/output component 204. The processor 202 may be configured to display or receive various information, to the user via the input/output component 204. The processor 202 may be configured to perform various data processing tasks (e.g. data serialization, managing input/output operations, pipeline and parallel processing).

The processor 202 may be configured to perform operations pertaining to artificial intelligence calculations such as matrix multiplication or vector processing. In some embodiments, the processor 202 may include tensor processing units, or custom instruction set architecture. As an example, the processor 202 may receive data from the memory 203 and perform tensor operations (e.g. tensor transformations) as well as non-linear functions to achieve the output. The processor 202 may also perform the artificial intelligence functions in concurrency or parallel utilizing multiple digital or physical cores.

The memory 203 may be a physical memory, (e.g. RAM, HDD, SSD) a virtual memory, or remote memory depending on the embodiment. The memory 203 may be configured to temporarily or permanently store information pertaining to the results, garment recommendation, or a user's body measurement data. These data may be from the processor 202 or the artificial intelligence system 151. The memory 203 may be configured to store temporary calculations used by the processor 202, for its calculations, as buffer. As an example, the memory 203 may hold data, transmitted from the network component 205, for the processor 202 as it transforms the garment recommendation into results 109 to be displayed, via the input/output component 204, to the user.

The memory 203 may be configured to store instructions for an operating system of the computing device 200. This may include instructions for any individual components to run (e.g. drivers). The memory 203 may be configured to store the data and/or instructions to run artificial intelligence models. The memory 203 may be configured to store preferences that the user enters into the computing device user device 101, 102, 103, 104 and/or the on-premises terminal 121 via the input/output component 204. As an example, the memory 203 may have the garment recommendations as well as preferences from the user wherein the processor 202 may access both sets of data to create the results. Any of the data incoming into the computing device 200 may be stored in the memory 203. That storage may be temporary, stored in different locations within memory 203, partitioned, and accessed by the processor 202 when needed. One of ordinary skill in the art would also recognize that memory, as it is used in this disclosure would encompass different types of storage used by computers and would cover a separate memory that is specific to the processor 202 as well as a separate memory component 203.

The input/output component 204 may be one element or multiple elements. In some embodiments, the input/output component 204 captures user input and displays outputs for the computing device 200. The input/output component 204 may be an element that is attached to the computing device 201 separately from the manufacture of said device. As an example, in an embodiment of the present disclosure, the computing device 200 is a smartphone and the input/output component 204 would include, but is not limited to, the microphone, speaker, camera(s), screen, and flash of the smartphone. In another embodiment, the computing device 200 may be a personal computer and the input/output component 204 would include, but is not limited to, an externally connected monitor, keyboard, mouse, speakers, microphone, and camera. Any element that can capture user input or transmit information back to the user for the computing device 200 may be an input/output component 204. The input/output component 204 may be coupled to the computing device 200 in a plurality of ways depending on the embodiment, including but not limited to wired and wireless couplings.

The input/output component 204 may be used to gather data and input from the user. As an example, the input/output component 204 when a user is filling out the body metrics survey on their smartphone may be the screen of their smartphone. The input may be the user's information/data, preferences, or decisions. The input/output component 204 may be coupled to the processor 202 directly or through an intermediary circuit or component (e.g. motherboard). The input that is captured by the input/output component 204 can be passed to the processor 202 and subsequently the memory 203.

The input captured by the input/output component 204 may include, but is not limited to, typing, verbal speech, images, and video. Images may be captured by the input/output component 204 and transferred to the body metrics system 141 and/or artificial intelligence system 151 via the processor 202 for analysis and measurement. The output captured by the input/output component 204 may include, but is not limited to, displaying results as text or images that would be depicted on a screen or display for the user. The output may also include a large language model (“LLM”) verbally reading out results, information, and questions to the user. The input/output component 204 may be in constant communication with other components of the computing device 200, the body metrics system 141, and/or artificial intelligence system 151 to provide feedback from the user and allow the computing device 200 to refresh the results or information displayed as needed.

An example of the continuous communication between the input/output component 204 may be an embodiment where the user has a camera, coupled to the computing device 200, positioned so at least a portion of the user's body is within the frame of the camera and the computing device 200 is able to provide images or video of the user to the body metrics system 141 and/or the artificial intelligence system 151 to analyze and generate body measurements and/or garment recommendations. In this embodiment, the user may be prompted with directions on a screen of the computing device 200 such that the user is able to receive feedback, via the input/output component 204, on the positioning of the camera and how to adjust the camera or the user's body.

The networking component 205 may be coupled to at least one of the components of the computing device 200. The networking component may be coupled to the processor, the input/output component 204, or other components found within particular embodiments of the present disclosure. The networking component 205 may be one element or multiple elements. The networking component 205 may be configured to create a communication link and/or coupling between two or more components, at least one component and at least one other device, or between at least two devices. The network component 205 may include, but is not limited to, wireless internet communication devices, cellular communication (e.g. CDMA2000, GSM, 4G, 5G, LTE), ethernet cables, Bluetooth, Wi-Fi, USB wire, internal computer wiring, or similar data transfer protocols. The networking component 205 may be a transmitter, a receiver, a transceiver, or other networking component structures known in the art.

The networking component 205 may be used to transfer data between different components depending on the embodiment. As an example, the networking component 205 may be a Wi-Fi enabling device on a smartphone that allows for the transfer of results between the computing device and the body metrics system 141 and/or the artificial intelligence system 151. The networking component 205 may be used to transfer data between the computing device 200 and the transactions datastore server 153 and/or the measurements and sizing datastore server 152.

The networking component 205 may be configured to transfer data between the various components including the results, retailer information, body metrics data, and garment recommendation depending on the embodiment. In some embodiments, the networking component 205 may be configured to receive information from an input/output component 204 like data captured by a sensor. As an example, the computing device 200 may be a personal computer wherein the networking component 205 includes a Bluetooth receiver that receives data from a wireless camera and an ethernet connection that connects allows for the transfer of data between the computing device 200 to the body metrics system 141 and/or the artificial intelligence system 151. In some embodiments, the networking component 205 may be configured to transfer to and from the computing device 200 multiple times or even continuously. As an example, the networking component 205 may be configured to establish a stable connection between the computing device 200 and the body metrics system 141 to allow for real-time image analysis through the user's camera. In another example, the networking component 205 may transfer data intermittently between the computing device 200 and the body metrics system 141 as the user is browsing different articles of clothing.

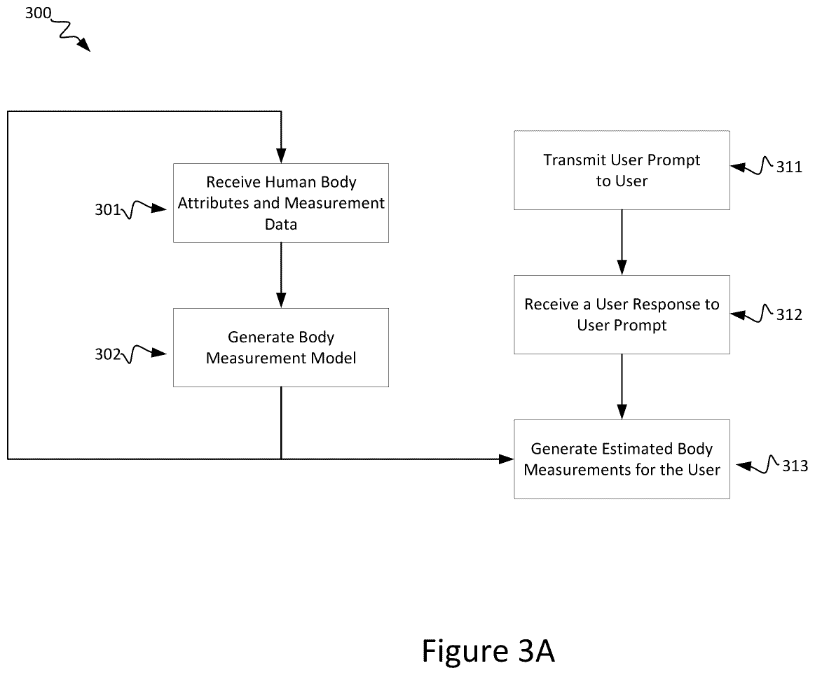

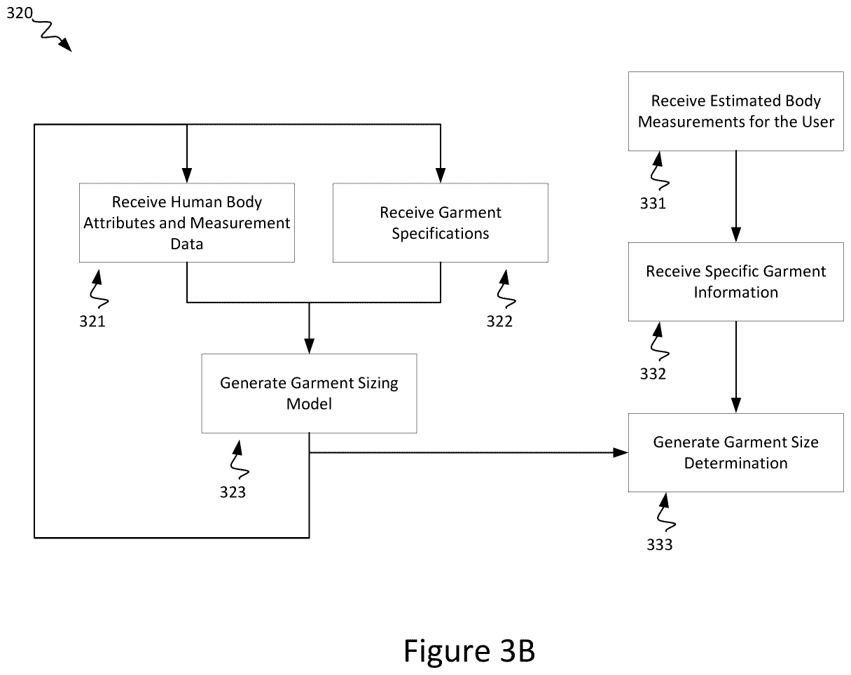

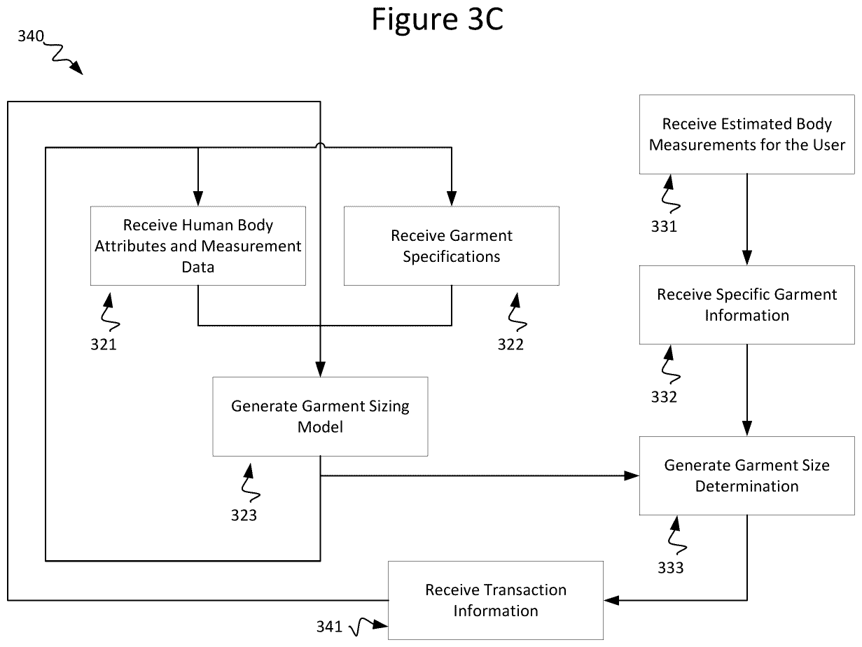

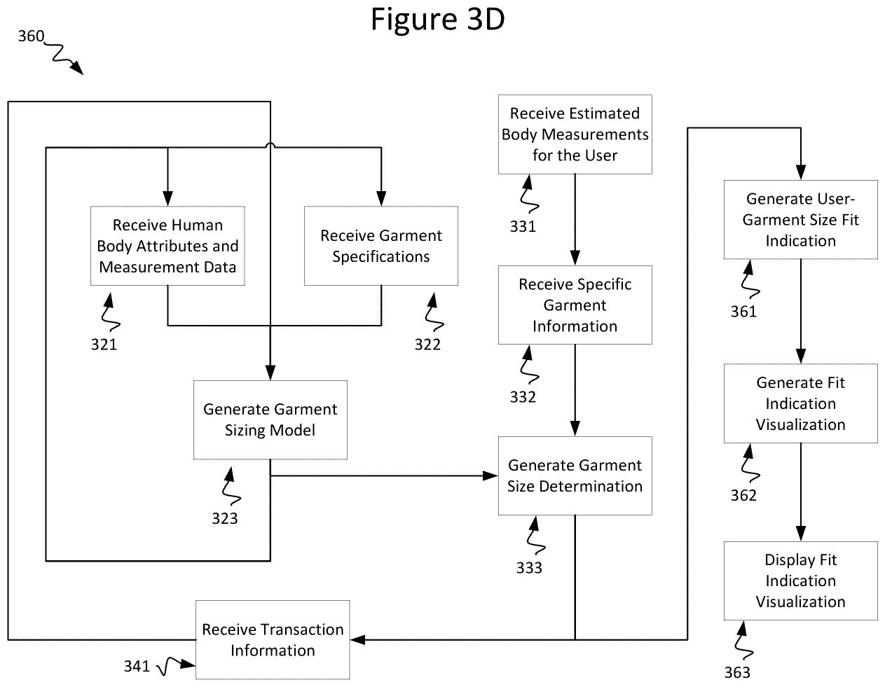

FIG. 3A is a flowchart diagram of a process 300 for generating human body part measurements information according to some embodiments of the present disclosure. Process 300 may be performed using systems and components described elsewhere herein (e.g., system 100, computing device 200).

At block 301, human body attributes and measurement data are received. Block 301 may be performed by user devices 101, 102, 103, 104, on-premises terminal 121, body metrics system 141, and/or artificial intelligence system 151. In some embodiments, block 301 may include receiving training data for training an artificial intelligence and/or machine learning model. Block 301 may include receiving data describing body attributes for each human in a set of humans. The body attributes may include measurements for parts of a human's body, the human's age, the human's gender, and/or other physiological attributes of the human, for respective humans in the set of humans. Block 301 may include receiving data describing body measurements for each human in a set of humans. The body measurements may include measurements of parts of the respective human's body. The body measurements may include, for example: the humans' height, weight, waist size, hip shape, arm length, leg length, shoe size, chest size, bra size, hat size, inseam size, wrist size, neck size, BODY MASS INDEX, etc.

At block 302, a body measurement model is generated. Block 302 may be performed by body metrics system 141 and/or artificial intelligence system 151. In some embodiments, block 302 may include providing the human body attributes data and human body measurement data received at block 301 as training data to an artificial intelligence and/or machine learning model training algorithm. For example, the human body attributes data and human body measurement data may be used to train a linear regression model that is configured to predict human body measurements based on input human body attributes. As another example, the human body attributes data and human body measurement data may be used to train an artificial neural network model that is configured to predict human body measurements based on input human body attributes. The result of block 302 may include an artificial intelligence and/or machine learning model. The artificial intelligence and/or machine learning model may be generated, stored, and/or operated by the body metrics system 141 and/or the artificial intelligence system 151.

After block 302, the process 300 may continue at block 301 and/or block 313. In some instances, new or additional human body attributes data and human body measurement data may be available. In such instances, the process 300 may return to block 301 to receive the new or additional data, and then block 302 to train or retrain the body measurement model using the new or additional data. In some instances, the body measurement model generated at block 302 is used at block 313. For example, the body measurement model generated (e.g., training stage) at block 302 is operated (e.g., inference stage) by process 300 at block 313.

At block 311, a user prompt is transmitted to a user. Block 311 may be performed by user devices 101, 102, 103, 104, on-premises terminal 121, body metrics system 141, and/or artificial intelligence system 151. At block 311, a user may be prompted to provide human body attributes of the user. In particular, the user may be prompted to provide a limited set of human body attributes, such as two human body attributes, three human body attributes, four human body attributes, five human body attributes, or six human body measurements. In some embodiments, the user may be prompted to provide fewer than ten human body attributes. For example, the user may be prompted to provide the user's gender, the user's age, the user's height, the user's weight, and the user's pant waist. As a further example, the user may be prompted to provide the user's gender, the user's age, the user's height, the user's weight, and the user's bra size.

Block 311 may include transmitting a user survey to a user. The user survey may include personal information such as the user's name, address, and date of birth. The user survey may also include, but is not limited to, the user's waist size, hip size, shirt size, pant size, jacket size, shoe size, bra size, neck size, dress size, user's BODY MASS INDEX, if the user has a fit preference (e.g. loose, tight, snug), height, weight, and age. Depending on the measurement that is being input, the format of the answer may differ for each question. As an example, a user may input that their shirt size is a “large” whereas the shoe size may be input as “size 13 Men” and the waist size may be 36″. The answers to the various sizes may differ depending on what may be easiest for the user to enter, and multiple options may be available for the user to enter their information.

Transmitting of the user survey to the user may occur by displaying the questions to the user through an input/output component 204 (e.g. screen or speaker). As an example, the transmitting of the user survey to the user may be from the user device 101 being configured to display the user survey questions on the screen (e.g., input/output component 204). The transmitting of the user survey to the user may have multiple portions that are sent to the user and returned back to the user device 101. The user may be transmitted a user survey multiple times, at different intervals, to gather more information from the user or to confirm the data is still accurate. The transmitting of the user survey to the user at block 301 may occur by transmitting the questions in an electronic message from the body metrics system 141 to the user device 101.

In some embodiments, the user survey being transmitted to the user may be the computing device 103 configured to prompt the user to upload, take, or record pictures and/or video of the user's body. The user survey being transmitted may be sent wirelessly from a server to the user device 101. As an example, the user survey can be transmitted to the user by a web browser that accesses the user survey from a remote webserver (e.g., hosted by body metrics system 141).

At block 312, a user response to a user prompt is received. Block 312 may be performed by user devices 101, 102, 103, 104, on-premises terminal 121, body metrics system 141, and/or artificial intelligence system 151. At block 312, a response to the user prompt transmitted at block 311 may be received. For instance, a user may provide a human body attributes of the user in accordance with the user prompt of block 311. In particular, the user may provide a limited set of human body attributes, such as two human body attributes, three human body attributes, four human body attributes, five human body attributes, or six human body measurements. In some embodiments, the user may provide fewer than ten human body attributes. For example, the user may provide the user's gender, the user's age, the user's height, the user's weight, and the user's pant waist. As a further example, the user may provide the user's gender, the user's age, the user's height, the user's weight, and the user's bra size.

Block 312 may include a user providing a user response to a user survey prompt. The response may be in the form of data that the user has entered manually and submitted. As an example, the user device 101 may receive a user response to the user survey prompt that includes filled out text fields wherein the user entered in their age, height, dress size, and other text fields. The user device 101 may receive the user response to the user survey prompt in encrypted form in some embodiments. Receiving the user's survey response may be done by the user selecting options that are presented to the user in the survey. As an example, there may be radio buttons to select gender, drop-down lists to select height, or other widgets aside from, or in addition to, the text fields that receive the response from the user.

In some embodiments, block 312 may include a user inputting information into a form, or the user finalizing details by pressing a “submit” or similar button. Block 312 may be repeated multiple times before block 313 occurs. As an example, the user may receive a user survey prompt, and the survey may be segmented into multiple portions that are each sent to the user device 101. The user device 101 may receive multiple responses separately from each other. In some embodiments, the user device 101 may receive the user response and proceed on to the next blocks and prompt the user for additional information again at a later time. As an example, a user may need to repeatedly change their user response to user survey as their body changes (e.g. weight loss/gain, muscle loss/gain, growing in height) and subsequently, the user device 101 may receive multiple instances of the user's body metrics data.

In some embodiments, block 302 may occur at the input/output component 204. The body metrics data may be entered by the user to an input element (e.g. keyboard, screen, picture) and the processor 202 may store the body metrics data within the memory 203. In some embodiments, receiving the body metrics data may come from another device that already has the user's data and is transferred through the networking component 205. In some embodiments, where the user's body metrics data is determined automatically via a camera that analyzes the user's body, receiving the user response is a transfer of said data between components or devices. As an example, the processor 202 may run calculations to generate the user's body metrics data from the images gathered by the input/output component 204 and transfer the generated data where it is received by the memory 203. In some embodiments, receiving the body metrics data may be a transfer of data from one device to another. As an example, the body metrics data may be stored on an online server and sent to the user device 101 and/or the body metrics system 141.

In some embodiments, after the user response to the user survey has been received, the body metrics data may be sent to the body metrics system 141, the artificial intelligence system 151, the measurements and sizing datastore server 152, and/or the transactions datastore server 153. The body metrics may include the user's survey answers and may also include the user's fit data, purchasing history, and details about the article of clothing selected. The body metrics data may then be used to generate one or more body measurements for the user via the artificial intelligence system 151. In some embodiments, the artificial intelligence system 151 may be located on the same physical device as the user device 101, the on-premises terminal 121, and/or the body metrics system 141, and the transfer of body metrics data is through internal wiring and memory transfers. In some embodiments, the artificial intelligence system 151 is located on a separate server or other device and the body metrics data is sent by the networking component 205.

At block 313, estimated body measurements for the user are generated. Block 313 may be performed by body metrics system 141 and/or artificial intelligence system 151. Block 313 may include applying the human body attributes data received at block 312 as input to the body measurement model generated at block 302 in order to generated estimated body measurements for the user. In some embodiments, block 313 may include generating a large set of human body measurements for the user, such as more than ten human body measurements, more than twenty human body measurements, more than thirty human body measurements, more than forty human body measurements, or more than fifty human body measurements. The process 300 may allow the estimation of a large number (e.g. >25) of body measurement estimates for the user based on a limited number (e.g., <10) of input body attributes for the user.

In some embodiments, generating the body measurements for the user may utilize different data depending on the embodiment. The data elements that may be used include, but is not limited to, the user's survey answers, the user's fit data, purchasing history, and details about the article of clothing selected. In some embodiments, only a subgroup of the above data elements are used as input for the artificial intelligence system 151 to generate the body measurements.

The artificial intelligence system 151 may include a trained machine learning model that is trained to generate body measurements and garment size recommendations. A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include artificial neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the artificial intelligence system 151 can be a neural network with multiple input nodes that receive the body metrics data received from the user. The input nodes can correspond to functions that receive the input and produce outputs. These outputs can be provided to one or more levels of intermediate nodes that each produce further outputs based on a combination of lower-level node outputs. A weighting factor can be applied to the output of each node before the output is passed to the next layer node. At a final layer, (“the output layer”) one or more nodes can produce a value classifying the input that, once the model is trained, can be used as an artificial intelligence model. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

An artificial intelligence model used by artificial intelligence system 151 can be trained with supervised learning, where the training data includes the body metrics data as well as the user's fit data, purchasing history, and details about the article of clothing selected as input and a desired output, such as body measurements and garment size recommendation. A representation of body measurements and garment size recommendation can be provided to the model. Outputs from the model can be compared to the desired output and, based on the comparison, the model can be modified, such as by changing weights between nodes of the neural network or parameters of the functions used at each node in the neural network (e.g., applying a loss function). After modifying the model or training inputs in this manner, the model can be trained to evaluate new body measurements and garment size recommendation.

For exemplary purposes, how an artificial intelligence model is trained to generate body measurements and garment size recommendation in accordance with some embodiments is described below. First, a large corpus of labeled training data containing a user's body metrics and the correct corresponding garment size for that set of body metrics is fed into an artificial intelligence model as a training set. One sample of the training data may be the waist size of a user being thirty-four inches, the height being six feet, and the weight being two hundred pounds with “large” being the correct garment size recommendation for a shirt. In some embodiments, the model is trained for one piece of clothing. Other embodiments have the model training to determine the garment size recommendation for multiple pieces of clothing. Once the artificial intelligence model is sufficiently trained, the model is fed a validation set of body measurements paired with garment sizes to compare the output of the model to the correct answers for the validation set. The model outputs generated garment recommendations that are then evaluated for their accuracy either automatically and/or by a human. If the accuracy of the model is determined to be too low, the model is modified by, but not limited to, node weightings, training data used, or hyperparameter tuning. Another iteration of the training is applied to the model and this cycle is repeated until the accuracy is at a satisfactory level. Once a satisfactory level is reached, the model may be used to evaluate a user's body metrics data in order to generate body measurements and garment size recommendation.

In some embodiments, once the model is trained and is generating body measurements and garment size recommendation, the user may provide feedback to the artificial intelligence model on the recommendation (e.g., via the user device 101). The feedback may be incorporated to training data for future iterations of training the model which improve the accuracy of the model. The feedback may be incorporated manually by hand or automatically by a training system for the model. The continuous iterations for feedback from users being used to train the model allows for an increase in accuracy over standard training methods. This allows for a more accurate artificial intelligence model that is trained with a reduced risk of overfitting the data thereby also increasing efficiency of training artificial intelligence models.

One advantage of incorporating user feedback into the training process is the ability to personalize the recommendations from the artificial intelligence model to each specific user. This may also be a portion of the user fit data (e.g., provided by measurements and sizing datastore server 152 and/or transactions datastore server 153). As the model receives more feedback from individual users, it can start to recognize patterns and preferences unique to each user. In some embodiments, the user fit data may also include the history of clothes bought, worn, and returned by the user. This personalization leads to more accurate and tailored garment size recommendations, enhancing the user experience. Additionally, the continuous feedback loop helps to mitigate the risk of overfitting, as the model is constantly exposed to new and diverse data points. This dynamic training approach ensures that the model remains robust and generalizes well to new, unseen data.

The efficiency of the training process may be improved by incorporating user feedback. In some embodiments, traditional training methods may be used. Traditional training methods often require large amounts of labeled data and extensive computational resources. In some embodiments, real-time training methods may be used. In contrast, feedback-driven training leverages real-time user interactions, reducing the need for extensive manual labeling and data collection. This streamlined approach not only accelerates the training process but also reduces the overall computational cost. As a result, the artificial intelligence model can be updated more frequently, ensuring that it remains accurate and effective in a rapidly changing environment.

Incorporating user feedback into the training process may differ depending on the embodiment. In some embodiments, when a user provides feedback on the garment size recommendation, this feedback is first collected and categorized. The feedback can be positive, indicating that the recommendation was accurate, or negative, suggesting that the recommendation was off. This feedback data is then preprocessed to ensure it is in a suitable format for training. Preprocessing may involve normalizing the feedback, encoding categorical feedback into numerical values, and filtering out any noise or irrelevant information. Once preprocessed, the feedback data is integrated into the existing training dataset, augmenting it with real-world user experiences.

In some embodiments, the augmented dataset, now updated with user feedback, may be used to retrain the artificial intelligence model. During retraining, the model adjusts its weights and biases to minimize the error between its predictions and the actual feedback received. This iterative process, known as fine-tuning, helps the model to learn from its mistakes and improve its future predictions. The retraining process can be automated using a training system that continuously monitors user feedback and updates the model in real-time. This system ensures that the model remains up-to-date with the latest user preferences and trends, thereby maintaining its accuracy and relevance. In some embodiments, this retraining can be done on copies of the AI model 105 that are personalized to the particular user such that the user receives more accurate recommendations.

Using process 300, the system 100 may be configured to generate a set of estimated body measurements for the user based on an input set of body attributes of the user. Using process 300, the system 100 may be configured to generate of a large number (e.g. >25) of estimated body measurement for the user based on a limited number (e.g., <10) of input body attributes for the user. This may advantageously allow generation of a realistic and accurate estimate of the user's body part measurements for use in a virtual environment or other digital environment without specialized virtual environment hardware and minimal data input provided through software.

FIG. 3B is a flowchart diagram of a process 320 for generating garment size determinations according to some embodiments of the present disclosure. Process 320 may be performed using systems and components described elsewhere herein (e.g., system 100, computing device 200).

At block 321, human body attributes and measurement data are received. Block 321 may be performed by user devices 101, 102, 103, 104, on-premises terminal 121, body metrics system 141, and/or artificial intelligence system 151. In some embodiments, block 301 may include receiving training data for training an artificial intelligence and/or machine learning model.

Block 321 may include receiving data describing body attributes for each human in a set of humans. The body attributes may include measurements for parts of a human's body, the human's age, the human's gender, and/or other physiological attributes of the human, for respective humans in the set of humans.

Block 321 may include receiving data describing body measurements for each human in a set of humans. The body measurements may include measurements of parts of the respective human's body. The body measurements may include, for example: the humans' height, weight, waist size, hip shape, arm length, leg length, shoe size, chest size, bra size, hat size, inseam size, wrist size, neck size, BODY MASS INDEX, etc.

Block 321 may include receiving estimated body measurement data for each human in a set of humans. The estimated body measurement data may include data providing estimated body measurement for a respective human in the set of humans. For example, the estimated body measurement data may be estimated body measurement data generated using a body measurement artificial intelligence or machine learning model, such as described with respect to blocks 301, 302, and 313.

In some embodiments, block 321 includes receiving only one of: human body attributes data, human body measurements data, and estimated human body measurement data. In some embodiments, block 321 includes receiving only two of: human body attributes data, human body measurements data, and estimated human body measurement data.

At block 322, a garment specification is received. Block 322 may be performed by user devices 101, 102, 103, 104, on-premises terminal 121, body metrics system 141, and/or artificial intelligence system 151. In some embodiments, block 322 may include receiving a specification describing attributes of a garment of clothing. For example, the garment specification may include: chest width, waist circumference, sleeve length, fabric properties like stretchability and thickness, and/or geographical location information or features. The garment specification may include data describing respective sizes of the garment, such as chest width for a small size of a specific shirt, chest width for a medium size of the specific shirt, etc. The garment specification may include data describing respective sizes of the garment, such as a fabric type that is used for all sizes of a specific shirt. In some embodiments, block 322 may include receiving a one or more garment specifications describing a single specific garment. In some embodiments, block 322 may include receiving a one or more garment specifications describing multiple specific garments.

In some embodiments, block 322 may include receiving details or data about a particular article of clothing being provided as an input to an artificial intelligence model used by the artificial intelligence system 151. As an example, a user might want a recommendation on what size to order for a particular brand's shirt. The artificial intelligence model may receive the garment specifications for that brand's shirt which may include the dimensions of the clothing, the material the clothing is made of, whether that material stretches, whether the material shrinks when exposed to water and/or heating elements, the ideal or average body measurements that fit into a particular garment size, and any other data that might inform how the garment is worn or fits the user. The garment specification may be sent from the retailer directly. In some embodiments, the artificial intelligence model may receive the garment specification from publicly accessible sources (e.g. internet forums, third party resources).

At block 323, a garment sizing model is generated. Block 323 may be performed by body metrics system 141 and/or artificial intelligence system 151. In some embodiments, block 323 may include providing the human body attributes data, human body measurement data, and/or estimated human body measurement data received at block 321 as training data to an artificial intelligence and/or machine learning model training algorithm. In some embodiments, block 323 may further include providing the garment specifications received at block 322 as training data to an artificial intelligence and/or machine learning model training algorithm. For example, the estimated human body measurement data and garment specifications may be used to train a linear regression model that is configured to predict a best fitting size of a garment based on the estimated human body measurements and based on the garment specifications. As another example, the estimated human body measurement data and garment specifications may be used to train a neural network model that is configured to predict a best fitting size of a garment based on the estimated human body measurements and based on the garment specifications. The result of block 323 may include an artificial intelligence and/or machine learning model. The artificial intelligence and/or machine learning model may be generated, stored, and/or operated by the body metrics system 141 and/or the artificial intelligence system 151.

The garment sizing model may be trained at block 323 as described for the body measurement model at block 302, and as described for other artificial intelligence and/or machine learning models described elsewhere herein.

After block 323, the process 320 may continue at block 321, block 322, and/or block 333. In some instances, new or additional human body attributes data, human body measurement data, and/or estimated human body measurement data may be available. In such instances, the process 320 may return to block 321 to receive the new or additional data, and then block 323 to train or retrain the garment sizing model using the new or additional data. In some instances, new or additional garment specifications may be available. In such instances, the process 320 may return to block 322 to receive the new or additional data, and then block 323 to train or retrain the garment sizing model using the new or additional data. In some instances, the garment sizing model generated at block 323 is used at block 333. For example, the garment sizing model generated (e.g., training stage) at block 323 is operated (e.g., inference stage) by process 320 at block 333.

In some embodiments, when the artificial intelligence model receives as input a garment specification, it utilizes this information to generate a garment size recommendation by analyzing the compatibility between the garment's attributes and the user's body measurements. The garment specification may include precise details such as, but not limited to, chest width, waist circumference, sleeve length, fabric properties like stretchability and thickness, and/or geographical location information or features. These specifications may be used as input into the artificial intelligence model alongside the user's body measurements and fit preferences. The artificial intelligence model, trained on extensive datasets of garment specifications and user feedback, may process this information through its layers of interconnected nodes. By leveraging its learned patterns and relationships, the artificial intelligence model is configured to accurately match the garment's dimensions and material characteristics with the user's physical attributes. This enables the artificial intelligence model to predict the most suitable size for the user, taking into account the nuances of garment design and fabric behavior.

In some embodiments, the user may also select how and where the clothing is worn which may affect the sizing recommendation. As an example, the user may select that jeans will be worn around their hips rather than their waist which may affect the generated garment size recommendation made by the artificial intelligence model. In another example, the user may select that a buttoned shirt will be worn completely buttoned closed, buttoned open, or half and half and the generated garment size recommendation may be affected. Certain articles of clothing may be modified in how or where they are worn depending on the piece of clothing and the brand or manufacturer.

At block 331, estimated body measurement for the user are received. Block 331 may be performed by user devices 101, 102, 103, 104, on-premises terminal 121, body metrics system 141, and/or artificial intelligence system 151. In some embodiments, block 331 may include receiving estimated boy measurements for a user, as generated using a body measurement model. For example, block 331 may include receiving some or all of estimated body measurements generated as described with respect to block 313.

At block 332, specific garment information is received. Block 332 may be performed by user devices 101, 102, 103, 104, on-premises terminal 121, body metrics system 141, and/or artificial intelligence system 151. In some embodiments, block 332 may include receiving an identifier for a specific garment. The identifier may identify a specific garment, e.g., for which a garment specification or other garment data is stored by measurements and sizing datastore server 152. For example, block 332 may include receiving (e.g., by body metrics system 141) an identifier of a specific garment of clothing that the user is currently reviewing on a retailer's website. In some embodiments, block 332 may include receiving a garment specification for a specific garment.

At block 333, a garment size determination is generated. Block 333 may be performed by user devices 101, 102, 103, 104, on-premises terminal 121, body metrics system 141, and/or artificial intelligence system 151. Block 333 may include applying the estimated body measurements received at block 331 and the specific garment information received at block 332 as input to the garment sizing model generated at block 323 in order to generated garment size determinations for the user. For example, block 333 may include using the garment sizing model to determine a best fitting size of the specific garment for the user's body. As further example, block 333 may include using the garment sizing model to determine a best fitting sizes of the specific garment for the user's body, with an ordered ranking of the each size of the specific garment from best to worst.

In some embodiments, block 333 may include using the specific garment information received at block 332 to select a previously-trained garment sizing model from among one or more garment sizing models stored or used by artificial intelligence system 151. In such embodiments, the estimated body measurements received at block 331 may be applied as input to the garment sizing model generated at block 323 in order to generated garment size determinations for the user. In such embodiment, the specific garment information may be used to select a garment sizing model, but not applied as input to the garment sizing model.

The garment sizing model may be used at block 333 as described for the body measurement model at block 313, and as described for other artificial intelligence and/or machine learning models described elsewhere herein.

In some embodiments, block 331 includes receiving a user's fit preferences upon, for example along with the user's body attributes data at block 312. A user's fit preferences may also be collected afterwards at various times depending on the embodiment. As an example, the user's fit preferences may be collected later on during a feedback cycle on one of the artificial intelligence model's garment size recommendations. In such embodiments, block 333 may include using the user's fit preferences as part of generating a garment size determination for the user and the specific garment.

In some embodiments, in process 320, the user may have selected an article of clothing from a particular brand, like a shirt, and the artificial intelligence system 151 may query a database (e.g., provided by measurement and sizing datastore server 152) to determine if the dimensions of that article of clothing are accessible. If these dimensions are accessible, the artificial intelligence system 151 may integrate this data with the user's body measurements to generate a tailored size recommendation, e.g., by using an artificial intelligence model. This involves applying machine learning algorithms that have been trained to map body dimensions to clothing sizes, taking into account the unique sizing conventions of the brand in question.

In some embodiments, the artificial intelligence system 151 may employ alternative strategies to infer input information. In some embodiments, this involves leveraging a generalized sizing model that has been trained on a broad dataset encompassing various brands and garment types. This model may use statistical techniques and pattern recognition to estimate the likely dimensions of the clothing based on the brand's typical sizing patterns and the type of garment. Additionally, the artificial intelligence model may utilize collaborative filtering methods, drawing on data from other users with similar body dimensions and their reported fit experiences with the same or similar brands. By synthesizing these diverse data sources, the artificial intelligence model may generate a robust and reliable garment recommendation, even in the absence of direct access to the specific garment's dimensions. This multi-faceted approach ensures that the size recommendation is both accurate and personalized, enhancing the user's shopping experience.

In some embodiments, block 333 may be performed without the user selecting a particular brand. In these embodiments, the artificial intelligence system 151 may generate a garment recommendation that includes a range of sizes according to different brands and/or a generalized size that averages the various size details between different brands. In some embodiments, generating the garment recommendation may be translated to a result for the user that is in text and displayed to the user through the user devices 101, 102, 103, 104 and/or the on-premises terminal 121. In some embodiments, the result may be a picture or visual representation, displayed by the user devices 101, 102, 103, 104 and/or the on-premises terminal 121, that allows the user to visualize the size. In some embodiments, the results may be represented by a visual avatar, that is displayed to the user through the user devices 101, 102, 103, 104 and/or the on-premises terminal 121, that has the article of clothing projected on to the avatar's body as an accurate depiction of what the clothing would look like on the user. In some embodiments, the results include a large language model reciting the results to the user through the user devices 101, 102, 103, 104 and/or the on-premises terminal 121. In some embodiments, the results may include a subcombination of any of the above methods of delivering the results to the user.

In some embodiments, the results being delivered to the user may include the fit type for that piece of clothing. As an example, the model may determine, that a pair of pants may fit the user loosely when at size 34 and tightly at size 33. The model may deliver the results with this indication. The indication of the fit, for a particular piece of clothing as applied to the user, may be in the form of a text label displayed by the user devices 101, 102, 103, 104 and/or the on-premises terminal 121 and accompanying the rest of the information provided. In some embodiments the indication of the fit may be provided visually through the displayed user avatar. In some embodiments the indication of the fit may be provided by both text and the avatar.

In some embodiments, the user may select a particular size and allow the artificial intelligence system 151 to determine if and how the size would fit the user rather than the model determining the best size to choose. How the size would fit the user may be provided as text or visually via the user devices 101, 102, 103, 104 and/or the on-premises terminal 121. As an example, the user may select a jacket in size medium and the model determines that the jacket would be loose on the user and visually display the rendering on a user avatar via the user devices 101, 102, 103, 104 and/or the on-premises terminal 121. In some embodiments, the artificial intelligence model is trained to do both generating the recommended garment sizing (including the user's preference on how the clothes fit) and determining how a selected piece of clothing would fit the user. In situations where the clothing is too small to fit the user, the visual rendering of the clothing on the avatar may be replaced with text or visual indicator for the user that the selection would not fit.

FIG. 3C is a flowchart diagram of a process 340 for generating garment size determinations according to some embodiments of the present disclosure. Process 340 may be performed using systems and components described elsewhere herein (e.g., system 100, computing device 200). Process 340 includes blocks 321, 322, 323, 331, 332, and 333 as described with respect to process 320 of FIG. 3B. In process 340, blocks 321, 322, 323, 331, 332, and 333 may operate substantially as described with respect to process 320.

At block 341, transaction information is received. Block 321 may be performed by body metrics system 141, artificial intelligence system 151, and/or transactions datastore server 153. The transactions information may be received from one or more retailer entities, one or more brand entities, one or more third-party logistics providers, and/or from other entities. In some embodiments, block 341 may include receiving purchase data and/or returns data for garments of clothing. For example, block 341 may include receiving data describing garments purchased by users, including the specific garments purchase, the specific sizes of the garments that were purchased, the sizes of the garments that were identified to the user as the best fit sizes for the user, etc. As a further example, block 341 may include receiving data describing garments returned by users, including the specific garments returned, the specific sizes of the garments that were returned, the sizes of the garments that were identified to the user as the best fit sizes for the user, etc. Block 321 may include receiving transaction information on a periodic, batch, or bulk transfer basis.

In some embodiments, after transaction information is received at block 341, process 340 continues at block 323. In such embodiments, at block 323, the garment sizing model may be trained or retrained using the received transaction information, as well as other information described with respect to blocks 321, 322, and 323. In such embodiments, the garment sizing model may be trained using transaction information as a data input for training the garment sizing model. For example, the garment sizing model trained using transaction information may reflect garment sizes that are more frequently returned than others, so that the garment sizing determination (e.g., at block 333) can be improved.

FIG. 3D is a flowchart diagram of a process 360 for generating fit indications according to some embodiments of the present disclosure. Process 360 may be performed using systems and components described elsewhere herein (e.g., system 100, computing device 200). Process 360 includes blocks 321, 322, 323, 331, 332, 333, and 341 as described with respect to process 320 of FIG. 3B and process 340 of FIG. 3C. In process 360, blocks 321, 322, 323, 331, 332, 333, and 341 may operate substantially as described with respect to processes 320 and 340.

At block 361, user-garment size fit indications are generated. Block 361 may be performed by body metrics system 141 and/or artificial intelligence system 151. Block 361 may include applying the estimated body measurements received at block 331, the specific garment information received at block 332, and the garment size determination generated at block 333 as input to a fit indication model in order to generate fit indications for the user for the determined size for the specific garment. In some embodiments, one or more of these inputs may used to select among different fit indication models instead of being provided as input to the model. More or fewer inputs to the fit indication model may be used in various embodiments.

The fit indication generated at 361 may include one or more indicators that are selected to indicate how the determined size of the specific garment is determined to fit on the user's body at one or more points of measure. The fit indication may include text, shapes, images, colors, or other indicators of garment fit. The fit indication may include both a fit description value (e.g., a textual description, a color selected from a predefined color scheme) as well as a corresponding point of measure on the user's body. Block 361 may be configured to generate fit indications for critical points of measure along the user's body for the given garment, in order to indicate to the user how the garment will fit the user's body at one or more critical locations.

The fit indication model used at block 361 may be an artificial intelligence model and/or machine learning model trained on estimated human body measurements, garments specifications, garment size determinations, and/or received transaction information (e.g., purchase data, return data). In some embodiments, the fit indication model is a linear regression model or a neural network model. In some embodiments, block 361 may use a generative artificial neural network model that generates fit indications, such as by using a generative adversarial network approach.

In some embodiments, block 361 may be performed without using an artificial intelligence model or a machine learning model. In such embodiments, a deterministic algorithm may be used to selected points of measure on the user's body and to generate fit indications corresponding to those points of measure.

At block 362, a fit indication visualization is generated. Block 362 may be performed by body metrics system 141 and/or artificial intelligence system 151. Block 362 may include generating a visual representation of the fit indication generated at block 361. For example, block 362 may include selecting an avatar (e.g., default avatar, personalized avatar) for the user that represents the user's body. Block 362 may include overlaying, combining, or otherwise surfacing one or more fit indications generated at block 361 on the avatar. Block 362 may include overlaying, combining, or otherwise surfacing a fit indication at block 361 on a point of measure on the body of the avatar, for the point of measure that the fit indication corresponds to.

For example, when block 361 includes generating a textual fit description for the fit of the determined size of the specific garment at a specific point of measure on the user's body, block 362 may include rendering the textual fit description on the avatar visualization at a location on or adjacent to the point of measure on the avatar's body. The textual fit description may be color-coded to correspond to the fit indication (e.g., red colors for tighter fit, green colors for “just right” fit, blue colors for relaxed fit). The textual fit description may be accompanied by a line or other indicator associating the textual fit description with the corresponding point of measure along the avatar's body, such as a line or ring along the point of measure on the avatar's body.

At block 363, a fit indication visualization is displayed. Block 363 may be performed by user devices 101, 102, 103, 104, on-premises terminal 121, body metrics system 141, and/or artificial intelligence system 151. In some embodiments, block 363 may include generating a graphical rendering that includes the fit indication visualization generated at block 362. For example, block 363 may include generating a 2D model, a 3D model, a static image (e.g., .png file), a static webpage, a dynamic webpage, etc. In some embodiments, block 363 may include transmitting the graphical rendering that includes the fit indication visualization generated at block 362. For example, block 363 may include body metrics system 141 generating and transmitting to the user device 101 an electronic message or messages containing data that the user device 101 is capable of using to recreate and render a graphical rendering that includes the fit indication visualization generated at block 362. In some embodiments, block 363 may include displaying on a display component a graphical rendering that includes the fit indication visualization generated at block 362. For example, block 363 may include displaying a 3D model including an avatar and overlaid fit descriptions on input/output component 204 (e.g., display screen) of user device 101.

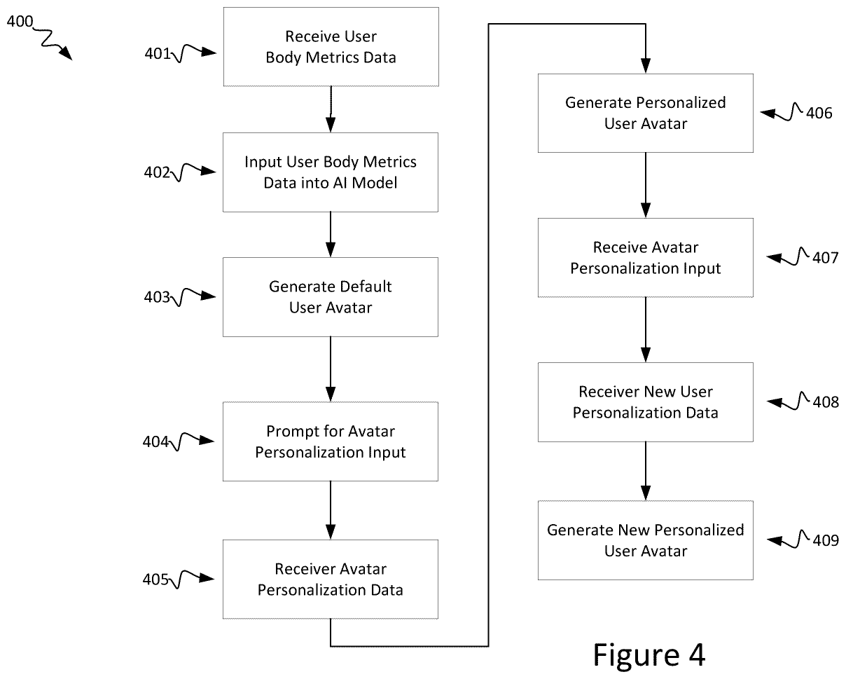

FIG. 4 is a flowchart diagram of a process 400 for generating human body part measurements and garment sizing information according to some embodiments of the present disclosure. Process 400 may be performed using systems and components described elsewhere herein (e.g., system 100, computing device 200).

At block 401, user body metrics are received (e.g., by user devices 101, 102, 103, 104, on-premises terminal 121, and/or body metrics system 141). Block 401 may be performed substantially as described in the present disclosure with respect to block 312.

At block 402, user body metrics data are provided as input into an artificial intelligence model (e.g., by artificial intelligence system 151). Block 402 may be performed substantially as described previously as described in the present disclosure with respect to block 313.

At block 403, a default user avatar is generated. The default user avatar may be generated by the body metrics system 141 and/or the artificial intelligence system 151, using the user's body metrics data and/or one or more artificial intelligence models.

In some embodiments, the artificial intelligence model that generates the body measurements and garment size recommendations is the same artificial intelligence model that generates the user avatar. In some embodiments, the artificial intelligence models are distinct from one another. Training the artificial intelligence models to map user body metrics data to create a 3D avatar with proportions similar to the user may occur before, after, or simultaneously to training the artificial intelligence models to generate body measurements and garment size recommendations. In some embodiments, such as when the artificial intelligence model generates both the garment recommendations and the 3D avatar, training the model may be done once to enable the model. In some embodiments, there may be distinct rounds of training for the model to be able to perform each task. The techniques, methods, data, and description previously described in the present disclosure to describe training the artificial intelligence model to generate garment size recommendations may be used for training the model to create 3D avatars. Additionally, training the artificial intelligence models to map user body metrics data to generate a 3D avatar may include data sets of clothing sizes corresponding to avatar limb size and visual proportions of humans.

Once the artificial intelligence model is trained, the user's body metrics data is input into the artificial intelligence model and the model processes this data through its network layers. Each layer may extract and transform features relevant to the avatar generation, such as body proportions and shape characteristics. The model applies its learned weights and biases to these features, producing a detailed and accurate three-dimensional representation of the user's body. This default user avatar is generated by synthesizing the extracted features into a cohesive and realistic digital model, which can be visualized and manipulated in various applications. The avatar generation process may also involve the use of computer graphics techniques, such as mesh generation and texture mapping, to enhance the visual fidelity and realism of the avatar. By leveraging the artificial intelligence model, block 403 ensures that the default user avatar is a precise and personalized representation of the user's physical attributes, facilitating virtual try-ons, personalized clothing recommendations, and other interactive experiences.

The default user avatar may lack certain human physical features in some embodiments. In some embodiments, the default user avatar may lack facial features like a mouth, nose, eyes, or ears. In some embodiments, the default avatar may be the physical silhouette of the user's body. Some embodiments of the default avatar may include the height, weight, gender, and body mass index (“BMI”) of the user along with the generated body measurements in generating and displaying an accurate default user avatar.

In some embodiments, the default user avatar may be a generic avatar for a human being, such as a generic human form factor, a generic woman form factor, a generic man form factor, a generic youth form factor, or a generic toddler form factor. In such embodiments, the default avatar may not be updated based on any body measurements of the user.

In some embodiments, the default user avatar is sent from the artificial intelligence system 151 to the body metrics system 141, the user devices 101, 102, 103, 104 and/or the on-premises terminal 121 and displayed to the user.

At block 404, a user is prompted to provide avatar personalization input (e.g., at the artificial intelligence system 151, the body metrics system 141, the user devices 101, 102, 103, 104 and/or the on-premises terminal 121). In some embodiments, the user may be prompted to input additional information to further personalize the user's default avatar. The user may not choose to further personalize the default avatar. In such a situation, the clothing garment(s) and suggestions may be displayed virtually on the default avatar for the user to view (e.g., on the user devices 101, 102, 103, 104 and/or the on-premises terminal 121).

At block 405, avatar personalization input is received (e.g., at the artificial intelligence system 151, the body metrics system 141, the user devices 101, 102, 103, 104 and/or the on-premises terminal 121). The user may input data that binds to the avatar to personalize the default avatar and create a personalized user avatar at block 406. Receiving the user's personalization data may be through text fields, drop-down lists, radio buttons, sensed data (e.g. images or video) captured by sensors of the user devices 101, 102, 103, 104, and/or on-premises terminal 121, augmented reality interfaces (e.g. virtual body scanning), smart mirrors, and through modifying the default avatar manually in a graphical user interface. Inputs to personalize the user's avatar may include, but are not limited to, hair color, eye color, lip size, lip shape, hair style and texture, jewelry (e.g. piercings or worn jewelry), tattoos, nail length, nail color, skin tone, blemishes or marks on the skin, eyebrow shape and color, presence of accessories (e.g. sunglasses), and body hair. Not all available inputs must be set to personalize the avatar. The input personalization data received may be any combination of subsets of the above inputs or all the above inputs.

At block 406, a personalized user avatar is generated (e.g., by user devices 101, 102, 103, 104, on-premises terminal 121, body metrics system 141, and/or by artificial intelligence system 151). The personalized user avatar may be generated using the received personalization data and the user's default avatar or body metrics data. The generation of the personalized avatar may be done incrementally as the user provides input. As an example, initially there may only be the default avatar displayed which shows the user's body silhouette on the user devices 101, 102, 103, 104 and/or on-premises terminal 121. The user may input a personalization relating to the user's hair being long, brown, and curly. The artificial intelligence system 151, the body metrics system 141, the user devices 101, 102, 103, 104 and/or on-premises terminal 121 may then update the 3D avatar to display said long and brown curly hair. The user may continue to update the avatar and make changes (block 407) to the same feature or other features (block 408) with each change causing the artificial intelligence system 151, the body metrics system 141, the user devices 101, 102, 103, 104 and/or on-premises terminal 121 to generate the new personalized avatar (block 409) and display the new personalized avatar to the user. In some embodiments, this process may be repeated until the user is satisfied. In some embodiments, the personalization avatar may not be updated for every iteration of change to the personalization data and will only be rendered once the user has finished inputting the personalization data.

Receiving the user's personalization data at block 405 may be per selection wherein the data is received as the user makes each selection or received together as one package when the user submits or finalizes the changes they would like.

In some embodiments, the default avatar and personalized avatars are both rendered in 3D virtual environments displayed to the user (e.g., digital environments, virtual reality environments, through the user devices 101, 102, 103, 104 and/or on-premises terminal 121). The virtual reality environments allow the user to view the rendered avatar from any direction or angle and/or rotate the avatar. As an example, the user may rotate the virtual camera view so that the rendering displays a top-down view of the avatar. In another example, the user may choose to keep the rendered angle at center level and have the avatar slowly rotate in a 360-degree fashion across the x-axis. In some embodiments, the virtual environment may allow the user to rotate the rendered view across any combination of the x, y, or z axis in any degree such that the user is able to view the avatar from any direction or angle.

The user may also be able to specify where and how the avatar is wearing a piece of clothing in the rendering. As an example, the user may specify jeans worn at the waist rather than at the hip. Another example may be the user specifying that a buttoned shirt is fully buttoned or fully open.

The virtual environment may be generated by the artificial intelligence system 151, the body metrics system 141, the user devices 101, 102, 103, 104 and/or on-premises terminal 121. To generate a virtual environment that provides the rendered view and see different angles of a 3D virtual avatar, the artificial intelligence system 151, the body metrics system 141, the user devices 101, 102, 103, 104, and/or on-premises terminal 121 may employ a combination of graphics rendering techniques, user input handling, and real-time processing. In some embodiments, the avatar is imported into a graphics engine which is responsible for rendering the avatar in a virtual environment. In some embodiments, a graphics engine, within the computing device 103, uses a rendering pipeline to convert the 3D model into a 2D image that can be displayed. This may involve vertex transformation, lighting calculations, and texture mapping.

To enable a rotated view, the artificial intelligence system 151, the body metrics system 141, the user devices 101, 102, 103, 104 and/or on-premises terminal 121 may capture user input through the input/output component 204 of the user devices 101, 102, 103, 104 and/or on-premises terminal 121. As an example, when the user drags a mouse or swipes on a touchscreen, the input is translated into rotation angles around the avatar's axes (typically the x, y, and z axes). The graphics engine updates the camera's position and orientation based on these input angles, effectively changing the viewpoint from which the avatar is rendered. This involves recalculating the camera's transformation matrix and applying it to the scene. The updated view is then rendered in real-time, providing the user with the ability to view the avatar from different angles. The user devices 101, 102, 103, 104 and/or on-premises terminal 121 may continuously process user inputs and update the rendered view, ensuring that the virtual environment responds dynamically to the user's actions.

In some embodiments, the virtual environment may include a background that may be a static and plain background such as a color that contrasts from the foreground of the avatar. In some embodiments the virtual background may be a selectable pattern or design. In some embodiments the screen displaying the virtual environment may be partitioned such that a portion of the screen displays a floating graphical user interface (“GUI”) that contains buttons or controls that modify the virtual environment or 3D avatar as it is being displayed to the user. As an example, one button on the GUI may be a change button background that functions to allow the user to select a different visual pattern to apply to the virtual background. The buttons or controls featured on the GUI may include, but are not limited to, angle or direction controls for the current view, changing the background, options to change features for the personalized avatar, and selecting articles of clothing for the body metrics system 141 and/or the artificial intelligence system 151 to generate garment size recommendations.

In some embodiments, the GUI may also have a button or control that displays a smart size chart on the screen.

In some embodiments, the GUI may also have a button or control that displays an apparel insights dashboard.

In some embodiments, the GUI may also have a button or control that displays a body data insights panel.

In various embodiments, any of the avatars may have clothing garments displayed on them to create a visualization of what the article of clothing would look like for the user. Multiple articles of clothing and garments may be displayed on a user avatar simultaneously. As an example, a user avatar may have rendered on a pair of pants in a certain size as well as a shirt wherein the body metrics system 141 or the artificial intelligence system 151 will provide garment sizing recommendations for all selected articles of clothing.

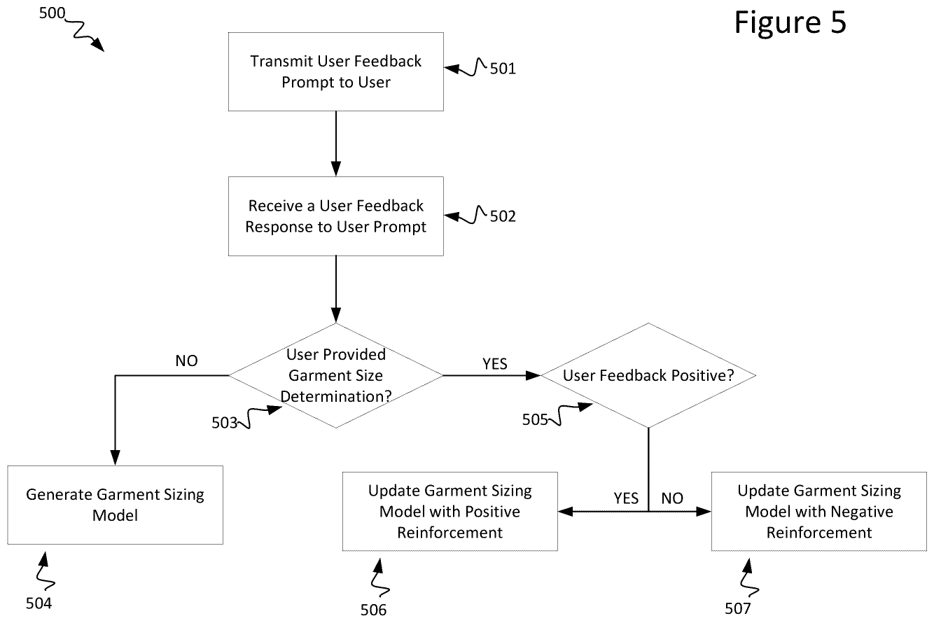

FIG. 5 is a flowchart diagram of a process 500 for generating human body part measurements and garment sizing information according to some embodiments of the present disclosure. Process 500 may be performed using systems and components described elsewhere herein (e.g., system 100, computing device 200).

At block 501, a user feedback prompt is transmitted to a user. Block 501 may be performed by user devices 101, 102, 103, 104, on-premises terminal 121, body metrics system 141, and/or artificial intelligence system 151. At block 501, a user may be prompted to provide feedback on a recent transaction. For example, the user may be prompted to provide feedback on whether a specific garment with a specific size purchased by the user fit well on the user's body. The user may be prompted to provide feedback on how the specific garments with the specific size fit on one or more locations on the user's body, such as the waist, chest, and neck. The user may be prompted to provide feedback on an overall fit of the specific garment with the specific size on the user's body. In some embodiments, the user may be prompted to provide information identifying the specific garment and the specific size of the specific garment.

In some situations, the user may have completed the recent transaction without being provided with a garment size recommendation (e.g., without being presented with the result of block 333). In such situations, the user may be prompted to provide additional information and/or to enroll in the body metrics system 141. For example, the user may be prompted to provide human body attributes of the user (e.g., as described with respect to block 311).

At block 502 a user feedback response is received. Block 502 may be performed by user devices 101, 102, 103, 104, on-premises terminal 121, body metrics system 141, and/or artificial intelligence system 151. At block 502, a response to the user prompt transmitted at block 501 may be received. For example, a user may provide feedback on the fit of a garment recently purchased by the user. User feedback may be received indicating whether a specific garment with a specific size purchased by the user fit well on the user's body. User feedback may be received indicating how the specific garments with the specific size fit on one or more locations on the user's body, such as the waist, chest, and neck. User feedback may be received indicating an overall fit of the specific garment with the specific size on the user's body. In some embodiments, user feedback may be received identifying the specific garment and the specific size of the specific garment.

In some situations, the user may have completed the recent transaction without being provided with a garment size recommendation (e.g., without being presented with the result of block 333). In such situations, user feedback may be received identifying additional information and/or enrolling the user in the body metrics system 141. For example, user feedback may be received identifying human body attributes of the user (e.g., as described with respect to block 311).

At block 503, a determination is made as to whether the user was provided a garment size determination. Block 502 may be performed by user devices 101, 102, 103, 104, on-premises terminal 121, body metrics system 141, and/or artificial intelligence system 151. For example, a determination may be made as to whether, during a purchase of a specific garment with a specific size, the user was provided a garment size determination (e.g., as generated at block 333). If the user was not provided a garment size determination as part of the purchase process, the user may not be enrolled in the body metrics system 141 and/or a garment sizing model may not exist for the specific garment of clothing in the body metrics system 141 and/or the artificial intelligence system 151.

If it is determined at block 503 that the user was not provided a garment size determination, then process 500 continues at block 504. Block 504 may be performed by user body metrics system 141 and/or artificial intelligence system 151. In some embodiments, block 504 may be performed substantially as described for block 323 in process 320. In addition to the operations described with respect to block 323, block 504 may include training a garment sizing model additionally using user feedback response information (e.g., as received at block 502). In some embodiments, block 504 may be performed after a plurality (e.g., >1,000) user feedback responses have been received (e.g., >1,000 iterations of block 502). In this way, process 500 may allow a garment sizing model to be trained for the specific garment even if some garment information (e.g., a garment specification of block 322) is not available.

If it is determined at block 503 that the user was provided a garment size determination, then process 500 continues at block 505. Block 505 may be performed by user body metrics system 141 and/or artificial intelligence system 151. At block 505, a determination is made as to whether user feedback (e.g., as received at block 502) was positive?

If it is determined at block 505 that the user feedback was positive, then process 500 continues at block 506. Block 506 may be performed by user body metrics system 141 and/or artificial intelligence system 151. At block 506, a garment sizing model is updated with positive reinforcement. In some embodiments, block 506 may include updating the garment sizing model used to provide the garment size determination to the user during the purchase of the specific garment. For example, block 506 may include providing additional training data inputs to retrain the garment sizing model (e.g., as described for block 323). The additional training data inputs may indicate that the determination of the specific size of the specific garment for this user should be reinforced, confirmed, or otherwise maintained (e.g., increase corresponding weights in a neural network model). It is to be understand that block 506 may use, but is not limited to, reinforcement learning techniques.

If it is determined at block 505 that the user feedback was negative, then process 500 continues at block 507. Block 507 may be performed by user body metrics system 141 and/or artificial intelligence system 151. At block 507, a garment sizing model is updated with negative reinforcement. In some embodiments, block 507 may include updating the garment sizing model used to provide the garment size determination to the user during the purchase of the specific garment. For example, block 507 may include providing additional training data inputs to retrain the garment sizing model (e.g., as described for block 323). The additional training data inputs may indicate that the determination of the specific size of the specific garment for this user should not be reinforced, confirmed, or otherwise maintained (e.g., decrease corresponding weights in a neural network model). It is to be understand that block 507 may use, but is not limited to, reinforcement learning techniques.

In some embodiments, blocks 505, 506, and 507 may be omitted. In such embodiments, if it is determined at block 503 that the user was provided a garment size determination, then process 500 continues to block 504 to retrain or otherwise update the garment sizing model. For example, the user feedback response received at block 502 may be combined with other data (e.g., as received at block 321, block 322, and/or block 341) to update an already-existing garment sizing model.

In some embodiments, the retailer data being sent to the artificial intelligence model of the artificial intelligence system 151 may include whether the particular size recommended for the user is in stock. If the size the artificial intelligence model recommends is not in stock, the artificial intelligence model may include this information in the recommendation. In some embodiments, the artificial intelligence model may send what the recommended garment sizing should be and also include alternative sizes that may fit the user if possible. As an example, if the artificial intelligence model determines that the garment size recommendation should be size 34 for a pair of pants but those are out of stock, it may include in its garment size recommendation that the correct size should be 34 but since that size is out of stock, the user can try size 35 for a slightly looser fit. In some embodiments, if the artificial intelligence system 151 receives data that the clothing article is in stock, it may include a digital signal to the user devices 101, 102, 103, 104 to display a hyperlink or option for the user to purchase the article of clothing from the retailer.

In some embodiments, the user may provide the user devices 101, 102, 103, 104 and/or the on-premises terminal 121 with access to their purchase data and/or return data with various retailer(s). This data may include, but is not limited to, their purchase history, return history, specific garment item names, garment stock keeping unit number (“SKU”), and size data for the garments. This data may be provided by the user manually inputting said data into the user devices 101, 102, 103, 104 and/or the on-premises terminal 121 or automatically allowing access through the use of application programming interface(s) (“API”).

In some embodiments, the user devices 101, 102, 103, 104 and/or the on-premises terminal 121 may send the purchase data and/or return data along with the user body survey data to the body metrics system 141, the artificial intelligence system 151, the measurements and sizing datastore server 152, and/or the transactions datastore server 153. An artificial intelligence model used by the artificial intelligence system 151 may use this data to assist in generating the recommended garment sizing for an article of clothing. As an example, the artificial intelligence model may determine that a particular size may be a proper sizing for the user but that the user does not want that fit (e.g. the user may prefer looser fitting clothing).

In some embodiments, the retailer may provide the purchase data and/or return data to the artificial intelligence model. The retailer may provide purchase data and/or return data by tracking their own purchases and returns along with a user identifier that they then provide to the body metrics system 141 and/or the artificial intelligence system 151. If the body metrics system 141 and/or the artificial intelligence system 151 determines that a user matches with a user identifier provided by the retailer, it will incorporate that purchase data and/or return data history to be applied to the user's profile and generate body measurements and garment sizing recommendations based on that data. In some embodiments, the artificial intelligence model may first send a digital signal to the user devices 101, 102, 103, 104 and/or the on-premises terminal 121 to have the user confirm whether the purchase data and/or return data received from the retailer is the user's.

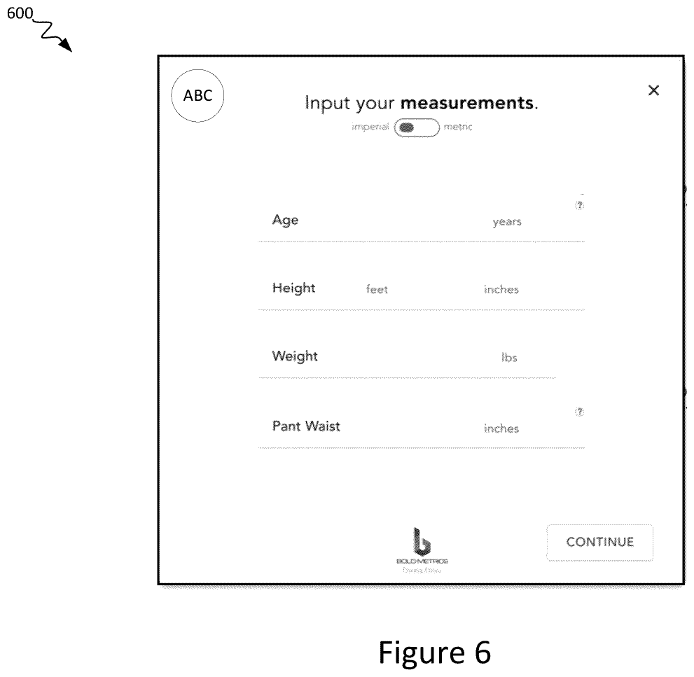

FIG. 6 is a graphical user interface 600 according to some embodiments of the present disclosure. Graphical user interface 600 includes fields for receiving body metrics of a user. For example, graphical user interface 600 may allow a user to enter the user's age, the user's height, the user's weight, and the user's pant waist. In some embodiments, the graphical user interface 600 may receive measurements of parts of the user's body, which may be used by body metrics system 141 and/or artificial intelligence system 151 to estimate additional measurements of other parts of the user's body. In some embodiments, graphical user interface 600 may be presented to a user during enrollment in body metrics system 141. In some embodiments, graphical user interface 600 may be presented when the user is a man.

In some embodiments, graphical user interface 600, and other graphical user interfaces disclosed herein, may be displayed in a webpage hosted by a web server, an application server, or other computing devices known in the art. In some embodiments, graphical user interface 600, and other graphical user interfaces disclosed herein, may be display on a purchasing website for a retailer, clothing brand, or other similar entity, referred to herein as “ABC”.

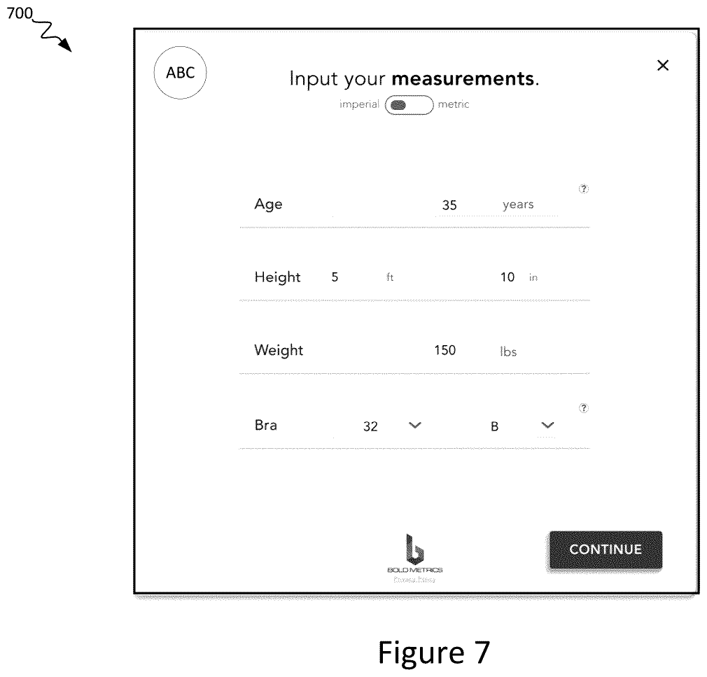

FIG. 7 is a graphical user interface 700 according to some embodiments of the present disclosure. Graphical user interface 700 includes fields for receiving body metrics of a user. For example, graphical user interface 700 may allow a user to enter the user's age, the user's height, the user's weight, and the user's bra size. In some embodiments, the graphical user interface 700 may receive measurements of parts of the user's body, which may be used by body metrics system 141 and/or artificial intelligence system 151 to estimate additional measurements of other parts of the user's body. In some embodiments, graphical user interface 700 may be presented to a user during enrollment in body metrics system 141. In some embodiments, graphical user interface 700 may be presented when the user is a woman.

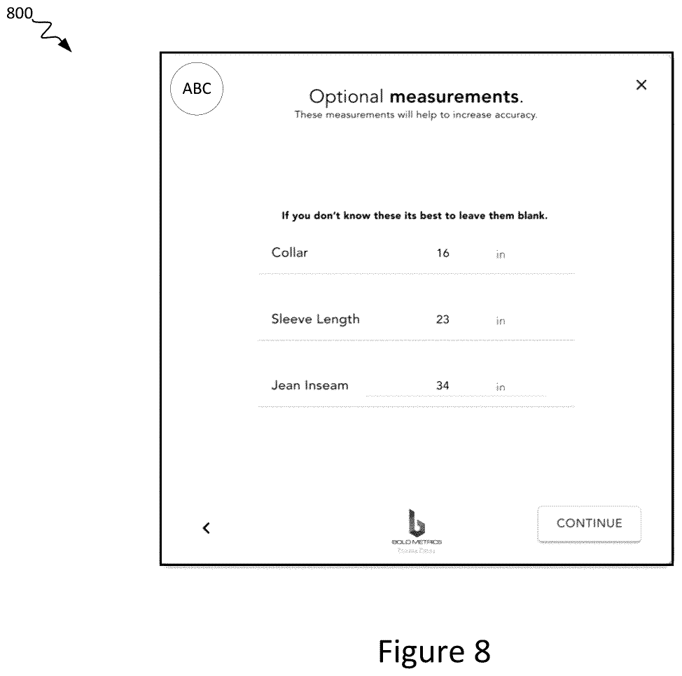

FIG. 8 is a graphical user interface 800 according to some embodiments of the present disclosure. Graphical user interface 800 includes fields for receiving body metrics of a user. For example, graphical user interface 800 may allow a user to enter the user's collar size, the user's sleeve length, and the user's jean inseam. In some embodiments, the graphical user interface 800 may receive measurements of parts of the user's body, which may be used by body metrics system 141 and/or artificial intelligence system 151 to estimate additional measurements of other parts of the user's body. In some embodiments, graphical user interface 800 may be presented to a user during enrollment in body metrics system 141. In some embodiments, graphical user interface 800 may be presented when the user is a woman or a man.

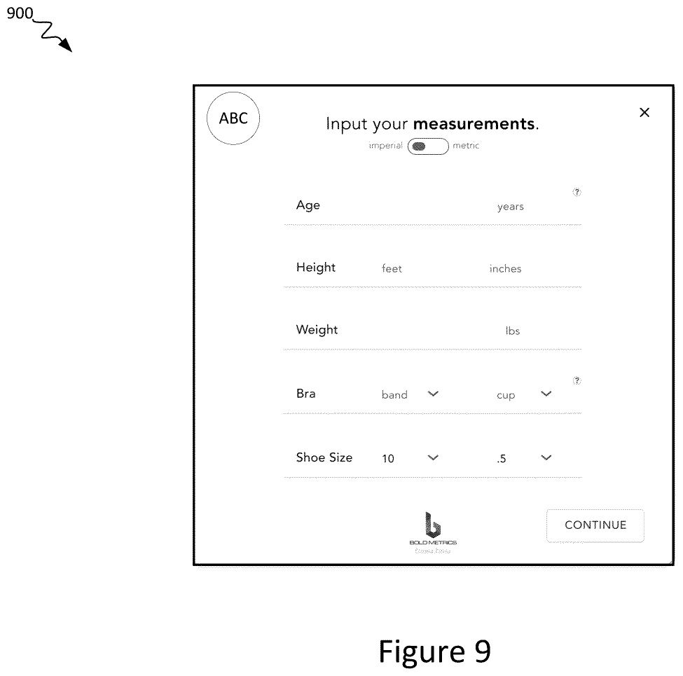

FIG. 9 is a graphical user interface 900 according to some embodiments of the present disclosure. Graphical user interface 900 includes fields for receiving body metrics of a user. For example, graphical user interface 900 may allow a user to enter the user's age, the user's height, the user's weight, the user's bra size, and the user's shoe size. In some embodiments, the graphical user interface 900 may receive measurements of parts of the user's body, which may be used by body metrics system 141 and/or artificial intelligence system 151 to estimate additional measurements of other parts of the user's body. In some embodiments, graphical user interface 900 may be presented to a user during enrollment in body metrics system 141. In some embodiments, graphical user interface 700 may be presented when the user is a woman. In some embodiments, a user that is a man may also be prompted to enter a shoe size.

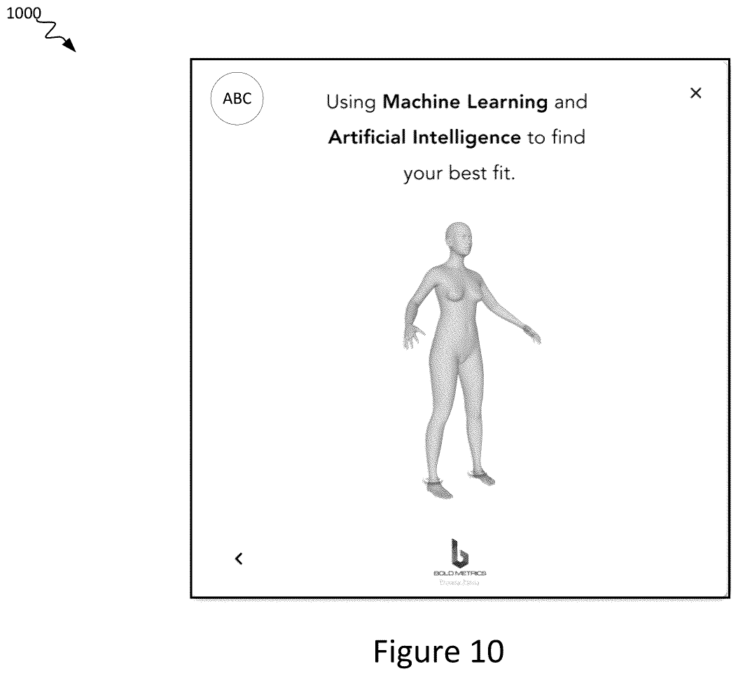

FIG. 10 is a graphical user interface 1000 according to some embodiments of the present disclosure. Graphical user interface 1000 includes a message to the user indicating that machine learning and artificial intelligence are used to determine garment sizing information for the user. In some embodiments, graphical user interface 1000 may be displayed to the user after the user provides body metrics (e.g., using graphical user interfaces 600, 700, 800, 900). In some embodiments, graphical user interface 1000 may be displayed to the user simultaneously with the body metrics system 141 and/or artificial intelligence system 151 using the body metrics provided by the user (e.g., using graphical user interfaces 600, 700, 800, 900) to determine additional body measurements for the user. In some embodiments, graphical user interface 1100 may be displayed to the user simultaneously with the body metrics system 141 and/or artificial intelligence system 151 using the body metrics provided by the user (e.g., using graphical user interfaces 600, 700, 800, 900) to determine garment sizing information for the user.

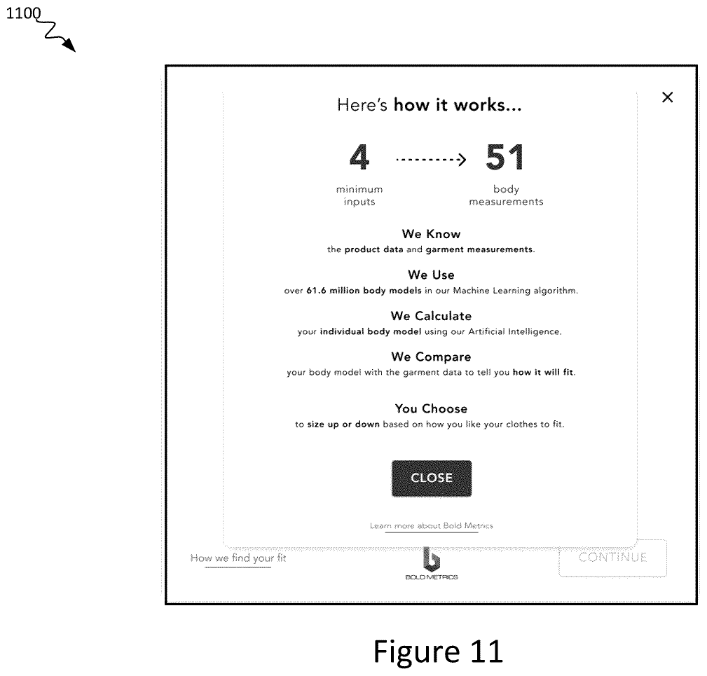

FIG. 11 is a graphical user interface 1100 according to some embodiments of the present disclosure. Graphical user interface 1100 includes a message to the user indicating the services and/or functionality provided by the body metrics system 141. In some embodiments, graphical user interface 1100 may be displayed to the user after the user provides body metrics (e.g., using graphical user interfaces 600, 700, 800, 900). In some embodiments, graphical user interface 1100 may be displayed to the user simultaneously with the body metrics system 141 and/or artificial intelligence system 151 using the body metrics provided by the user (e.g., using graphical user interfaces 600, 700, 800, 900) to determine additional body measurements for the user. In some embodiments, graphical user interface 1100 may be displayed to the user simultaneously with the body metrics system 141 and/or artificial intelligence system 151 using the body metrics provided by the user (e.g., using graphical user interfaces 600, 700, 800, 900) to determine garment sizing information for the user.

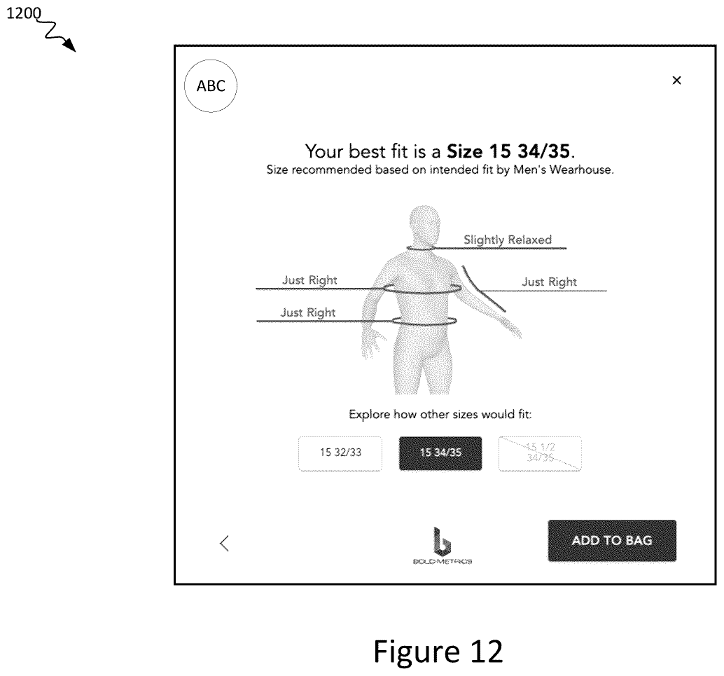

FIG. 12 is a graphical user interface 1200 for displaying fit indications according to some embodiments of the present disclosure. Graphical user interface 1200 may be displayed to a user on a computer device (e.g., user devices 101, 102, 103, 104 and/or on-premises terminal 121).

Graphical user interface 1200 may include information indicating to the user the garment sizing information determined for the user. For example, graphical user interface 1200 indicates to the user the determined best size of the specific garment for the user's body (e.g., as determined at block 333).

Graphical user interface 1200 may include one or more fit indications (e.g., as generated at block 361). For example, graphical user interface 1200 includes a fit indication corresponding to the waist point of measure, indicating with a textual fit description (“Just Right”), a color coding (grey), and a visual indicator (line and circumferential ring) that the determined size of the specific garment is expected to fit just right (e.g., ideal fit) at the waist of the user. As another example, graphical user interface 1200 includes a fit indication corresponding to the chest point of measure, indicating with a textual fit description (“Just Right”), a color coding (grey), and a visual indicator (line and circumferential ring) that the determined size of the specific garment is expected to fit just right (e.g., ideal fit) at the chest of the user. As another example, graphical user interface 1200 includes a fit indication corresponding to the neck point of measure, indicating with a textual fit description (“Slightly Relaxed”), a color coding (blue), and a visual indicator (line and circumferential ring) that the determined size of the specific garment is expected to fit slightly relaxed (e.g., slightly loose) at the chest of the user. As another example, graphical user interface 1200 includes a fit indication corresponding to the sleeve or arm length point of measure, indicating with a textual fit description (“Just Right”), a color coding (grey), and a visual indicator (line) that the determined size of the specific garment is expected to fit just right (e.g., ideal fit) along the sleeve or arm length of the user.

Graphical user interface 1200 may include a fit indication visualization (e.g., as generated at block 362). For example, graphical user interface 1200 includes a 3D rendering of an avatar with fit indications surfaced on the avatar's body at corresponding points of measure.

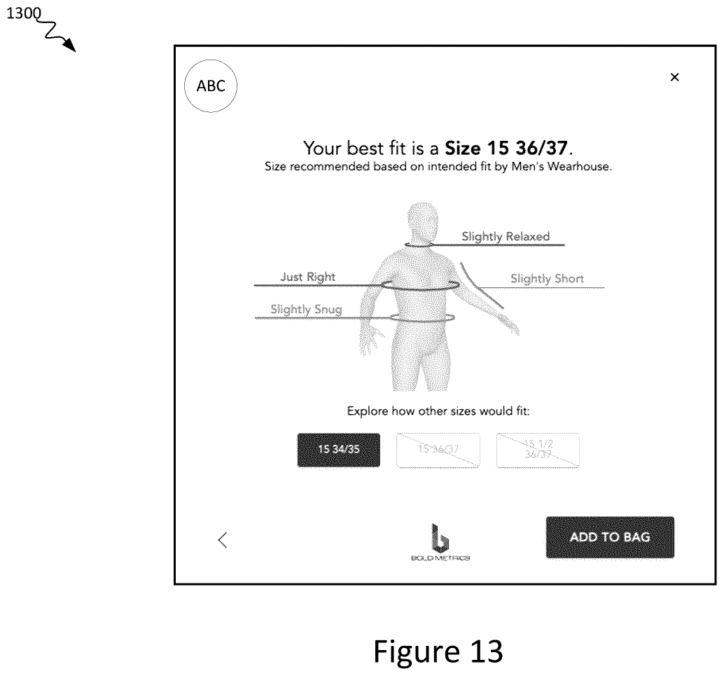

FIG. 13 is a graphical user interface 1300 for displaying fit indications according to some embodiments of the present disclosure. Graphical user interface 1300 may be displayed to a user on a computer device (e.g., user devices 101, 102, 103, 104 and/or on-premises terminal 121).

Graphical user interface 1300 may include information indicating to the user the garment sizing information determined for the user. For example, graphical user interface 1300 indicates to the user the determined best size of the specific garment for the user's body (e.g., as determined at block 333).

Graphical user interface 1300 may include one or more fit indications (e.g., as generated at block 361). For example, graphical user interface 1300 includes a fit indication corresponding to the waist point of measure, indicating with a textual fit description (“Slightly Snug”), a color coding (dark yellow), and a visual indicator (line and circumferential ring) that the determined size of the specific garment is expected to fit slightly snug (e.g., slightly tight) at the waist of the user. As another example, graphical user interface 1300 includes a fit indication corresponding to the chest point of measure, indicating with a textual fit description (“Just Right”), a color coding (grey), and a visual indicator (line and circumferential ring) that the determined size of the specific garment is expected to fit just right (e.g., ideal fit) at the chest of the user. As another example, graphical user interface 1300 includes a fit indication corresponding to the neck point of measure, indicating with a textual fit description (“Slightly Relaxed”), a color coding (blue), and a visual indicator (line and circumferential ring) that the determined size of the specific garment is expected to fit slightly relaxed (e.g., slightly loose) at the chest of the user. As another example, graphical user interface 1300 includes a fit indication corresponding to the sleeve or arm length point of measure, indicating with a textual fit description (“Slightly Short”), a color coding (dark yellow), and a visual indicator (line) that the determined size of the specific garment is expected to fit slightly short along the sleeve or arm length of the user.

Graphical user interface 1300 may include a fit indication visualization (e.g., as generated at block 362). For example, graphical user interface 1300 includes a 3D rendering of an avatar with fit indications surfaced on the avatar's body at corresponding points of measure.

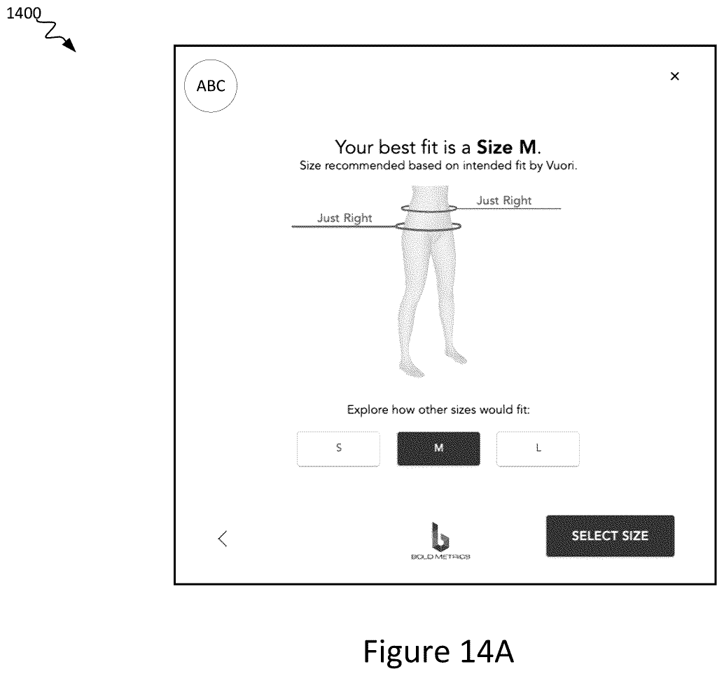

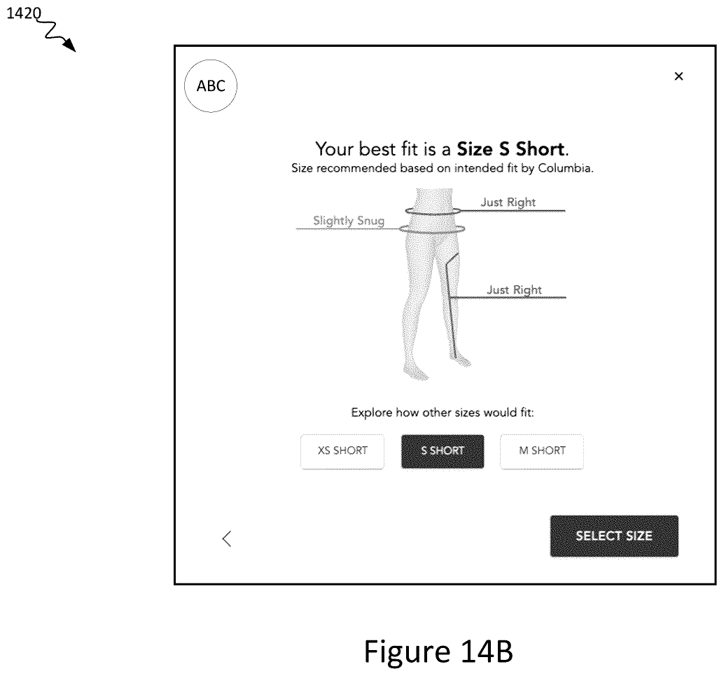

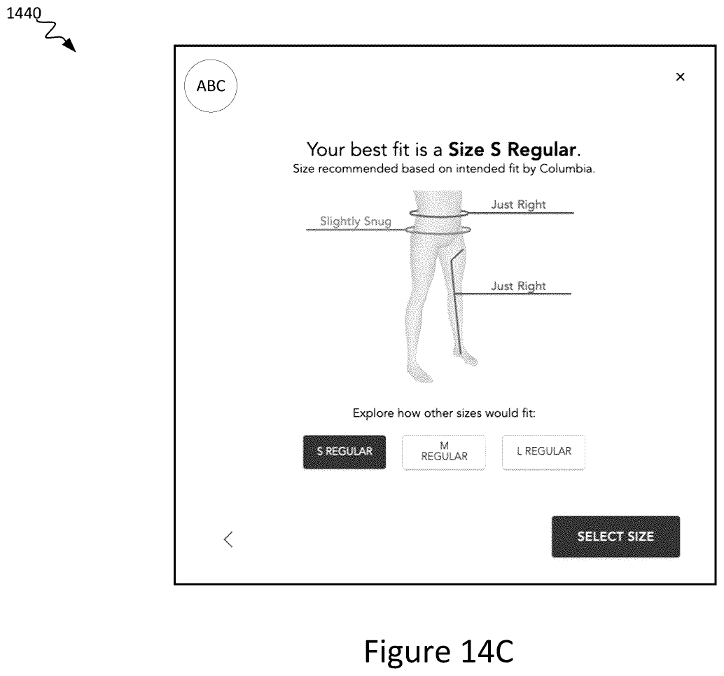

FIG. 14A is a graphical user interface 1400 for displaying fit indications according to some embodiments of the present disclosure. Graphical user interface 1400 may be displayed to a user on a computer device (e.g., user devices 101, 102, 103, 104 and/or on-premises terminal 121). Graphical user interface 1400 may include information indicating to the user the garment sizing information determined for the user. For example, graphical user interface 1400 indicates to the user the determined best size of the specific garment for the user's body (e.g., as determined at block 333). Graphical user interface 1400 may include one or more fit indications (e.g., as generated at block 361) as described elsewhere herein. Graphical user interface 1400 may include a fit indication visualization (e.g., as generated at block 362). For example, graphical user interface 1420 includes a 3D rendering of an avatar with fit indications surfaced on the avatar's body at corresponding points of measure.

FIG. 14B is a graphical user interface for displaying fit indications according to some embodiments of the present disclosure. Graphical user interface 1420 may be displayed to a user on a computer device (e.g., user devices 101, 102, 103, 104 and/or on-premises terminal 121). Graphical user interface 1420 may include information indicating to the user the garment sizing information determined for the user. For example, graphical user interface 1420 indicates to the user the determined best size of the specific garment for the user's body (e.g., as determined at block 333). Graphical user interface 1420 may include one or more fit indications (e.g., as generated at block 361) as described elsewhere herein. Graphical user interface 1420 may include a fit indication visualization (e.g., as generated at block 362). For example, graphical user interface 1420 includes a 3D rendering of an avatar with fit indications surfaced on the avatar's body at corresponding points of measure.

FIG. 14C is a graphical user interface 1440 for displaying fit indications according to some embodiments of the present disclosure. Graphical user interface 1440 may be displayed to a user on a computer device (e.g., user devices 101, 102, 103, 104 and/or on-premises terminal 121). Graphical user interface 1440 may include information indicating to the user the garment sizing information determined for the user. For example, graphical user interface 1440 indicates to the user the determined best size of the specific garment for the user's body (e.g., as determined at block 333). Graphical user interface 1440 may include one or more fit indications (e.g., as generated at block 361) as described elsewhere herein. Graphical user interface 1440 may include a fit indication visualization (e.g., as generated at block 362). For example, graphical user interface 1440 includes a 3D rendering of an avatar with fit indications surfaced on the avatar's body at corresponding points of measure.

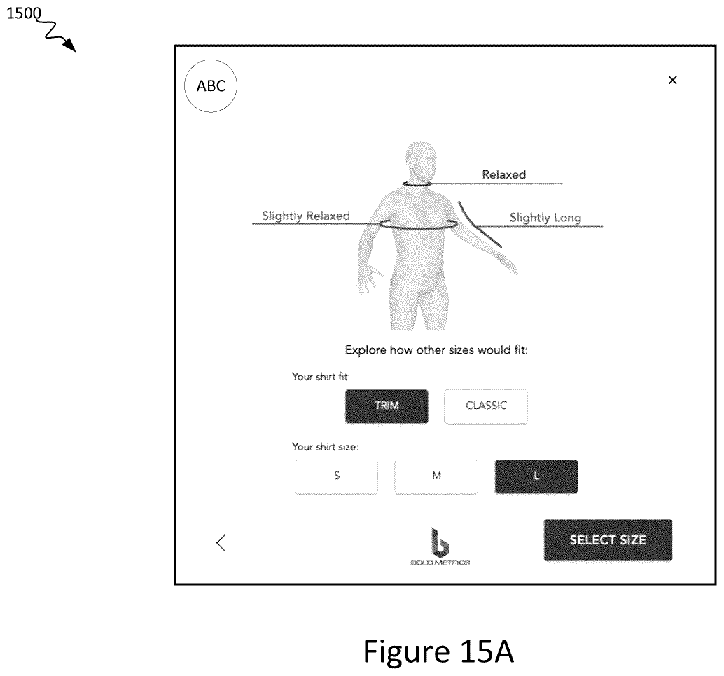

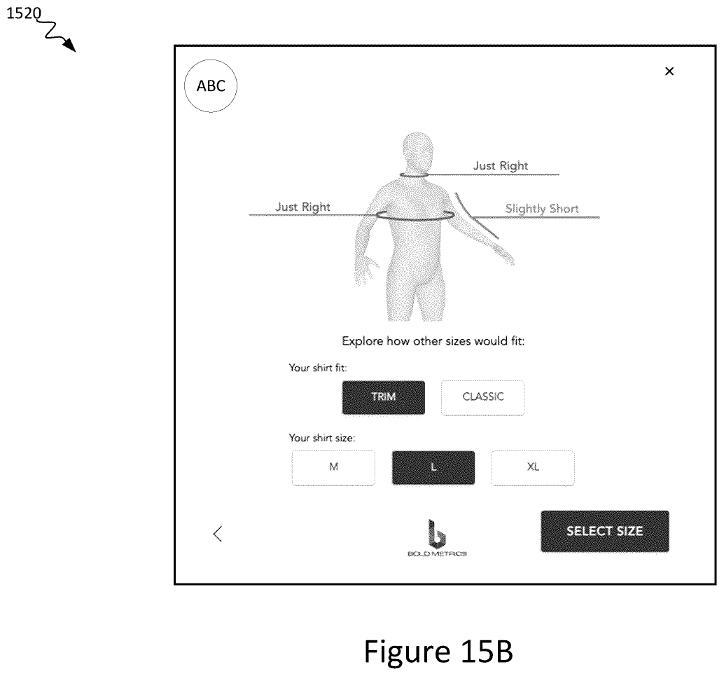

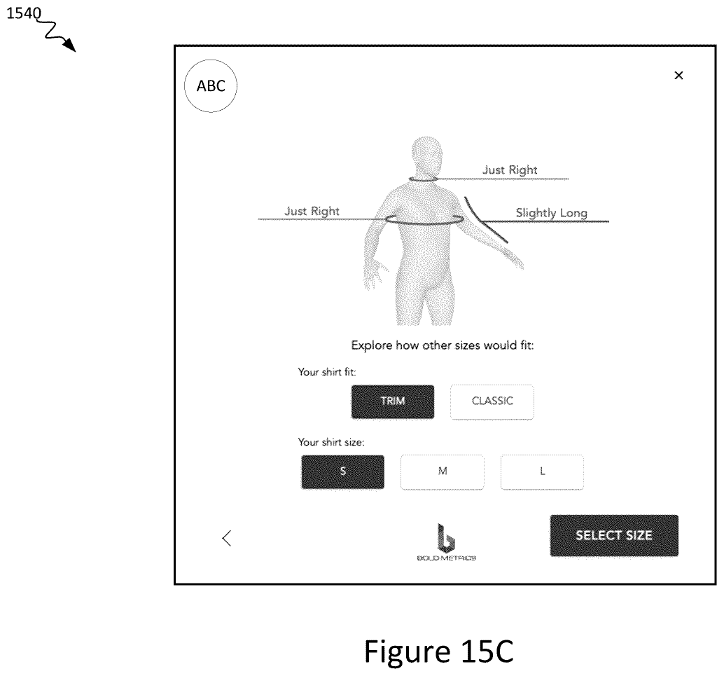

FIG. 15A is a graphical user interface 1500 for displaying fit indications according to some embodiments of the present disclosure. Graphical user interface 1500 may be displayed to a user on a computer device (e.g., user devices 101, 102, 103, 104 and/or on-premises terminal 121). Graphical user interface 1500 may include information indicating to the user the garment sizing information determined for the user. For example, graphical user interface 1500 indicates to the user the determined best size of the specific garment for the user's body (e.g., as determined at block 333). Graphical user interface 1500 may include one or more fit indications (e.g., as generated at block 361) as described elsewhere herein. Graphical user interface 1500 may include a fit indication visualization (e.g., as generated at block 362). For example, graphical user interface 1500 includes a 3D rendering of an avatar with fit indications surfaced on the avatar's body at corresponding points of measure.

FIG. 15B is a graphical user interface 1520 for displaying fit indications according to some embodiments of the present disclosure. Graphical user interface 1520 may be displayed to a user on a computer device (e.g., user devices 101, 102, 103, 104 and/or on-premises terminal 121). Graphical user interface 1520 may include information indicating to the user the garment sizing information determined for the user. For example, graphical user interface 1520 indicates to the user the determined best size of the specific garment for the user's body (e.g., as determined at block 333). Graphical user interface 1520 may include one or more fit indications (e.g., as generated at block 361) as described elsewhere herein. Graphical user interface 1520 may include a fit indication visualization (e.g., as generated at block 362). For example, graphical user interface 1520 includes a 3D rendering of an avatar with fit indications surfaced on the avatar's body at corresponding points of measure.

FIG. 15C is a graphical user interface 1540 for displaying fit indications according to some embodiments of the present disclosure. Graphical user interface 1540 may be displayed to a user on a computer device (e.g., user devices 101, 102, 103, 104 and/or on-premises terminal 121). Graphical user interface 1540 may include information indicating to the user the garment sizing information determined for the user. For example, graphical user interface 1540 indicates to the user the determined best size of the specific garment for the user's body (e.g., as determined at block 333). Graphical user interface 1540 may include one or more fit indications (e.g., as generated at block 361) as described elsewhere herein. Graphical user interface 1540 may include a fit indication visualization (e.g., as generated at block 362). For example, graphical user interface 1540 includes a 3D rendering of an avatar with fit indications surfaced on the avatar's body at corresponding points of measure.

Each of graphical user interfaces 1200, 1300, 1400, 1420, 1440, 1500, 1520, 1540 may be displayed to the user after the user provides body metrics (e.g., using graphical user interfaces 600, 700, 800, 900). Each of graphical user interfaces 1200, 1300, 1400, 1420, 1440, 1500, 1520, 1540 may be displayed after the body metrics system 141 and/or artificial intelligence system 151 has used the body metrics provided by the user (e.g., using graphical user interfaces 600, 700, 800, 900) and/or a garment specification (e.g., stored by measurements and sizing datastore server 152) to determine additional body measurements for the user and garment sizing information for the user. Each of graphical user interfaces 1200, 1300, 1400, 1420, 1440, 1500, 1520, 1540 may include a default avatar and/or a user-personalized avatar on which the graphical fit indication is shown.

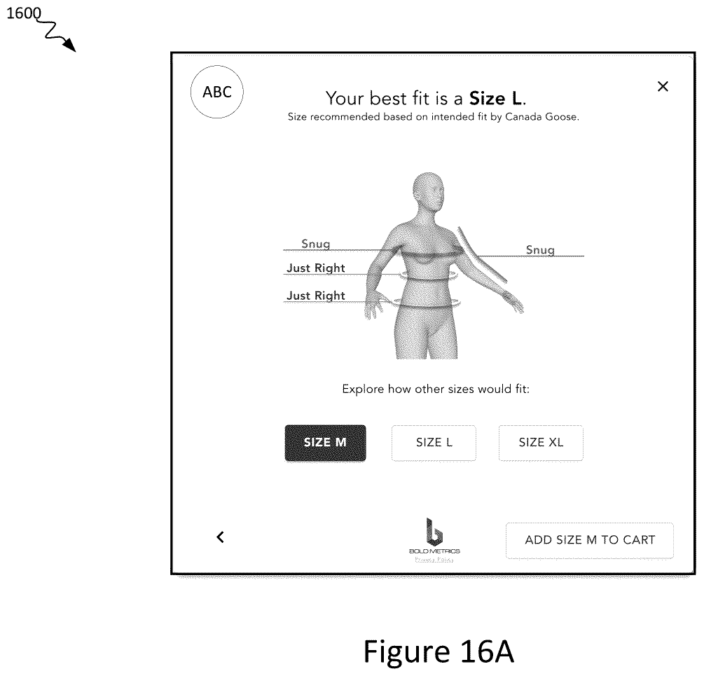

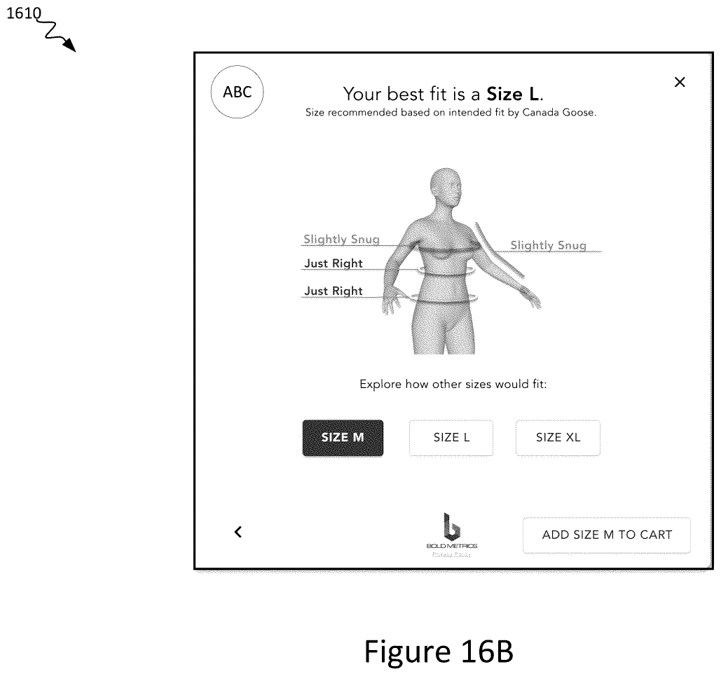

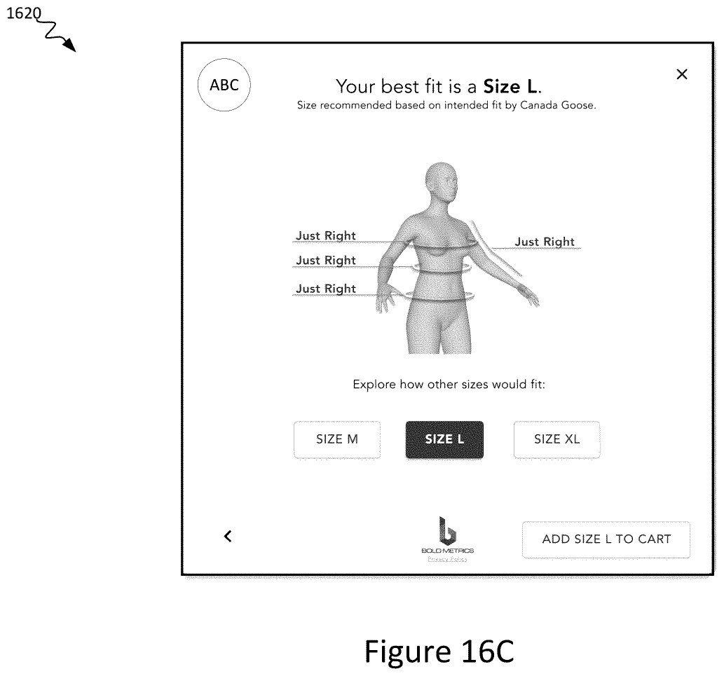

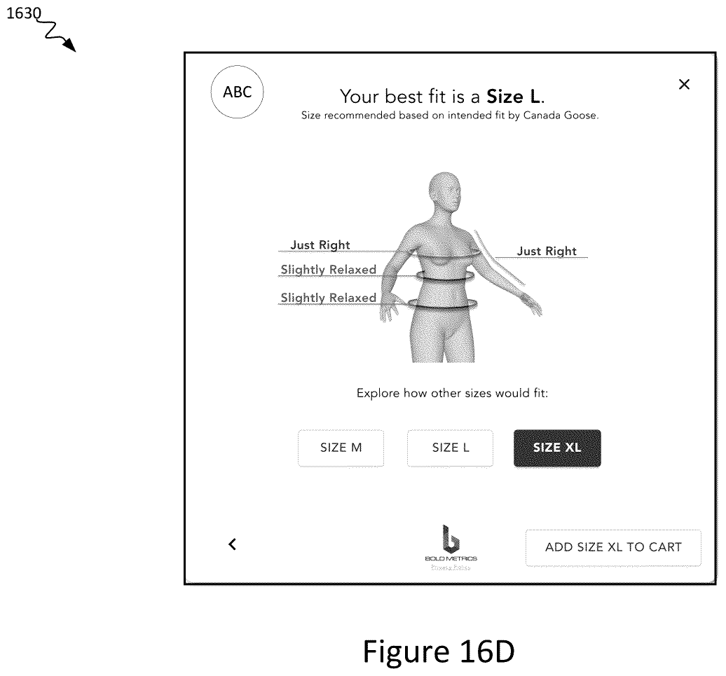

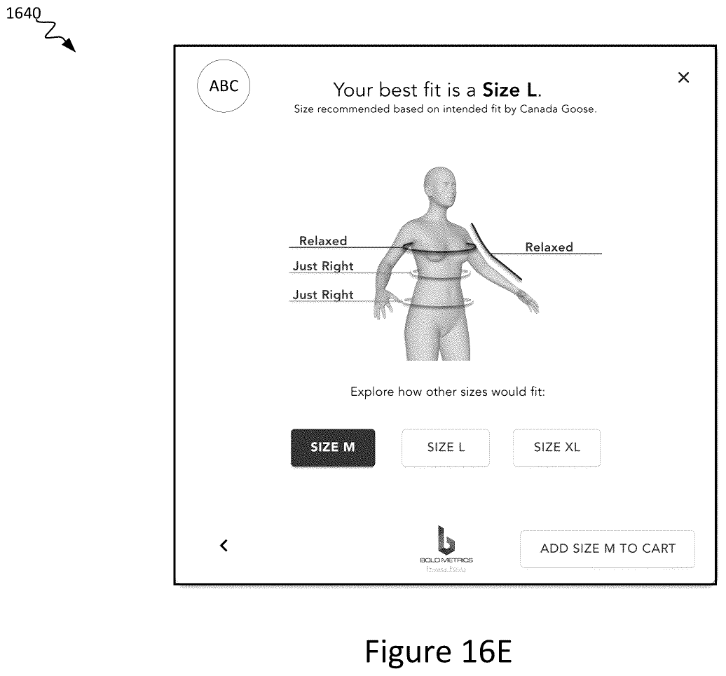

FIG. 16A is a graphical user interface 1600 for displaying fit indications according to some embodiments of the present disclosure. Graphical user interface 1600 includes information indicating to the user the garment sizing information determined for the user. In some embodiments, graphical user interface 1600 may be displayed to the user after the user provides body metrics (e.g., using graphical user interfaces 600, 700, 800, 900). In some embodiments, graphical user interface 1600 may be displayed after the body metrics system 141 and/or artificial intelligence system 151 has used the body metrics provided by the user (e.g., using graphical user interfaces 600, 700, 800, 900) and/or a garment specification (e.g., stored by measurements and sizing datastore server 152) to determine additional body measurements for the user and garment sizing information for the user. For example, graphical user interface 1600 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “snug” or “just right.” Graphical user interface 1600 may include a default avatar and/or a user-personalized avatar on which the graphical fit indication is shown.

FIG. 16B is a graphical user interface 1610 for displaying fit indications according to some embodiments of the present disclosure. Graphical user interface 1610 includes information indicating to the user the garment sizing information determined for the user. In some embodiments, graphical user interface 1610 may be displayed to the user after the user provides body metrics (e.g., using graphical user interfaces 600, 700, 800, 900). In some embodiments, graphical user interface 1300 may be displayed after the body metrics system 141 and/or artificial intelligence system 151 has used the body metrics provided by the user (e.g., using graphical user interfaces 600, 700, 800, 900) and/or a garment specification (e.g., stored by measurements and sizing datastore server 152) to determine additional body measurements for the user and garment sizing information for the user. For example, graphical user interface 1610 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “slightly snug” or “just right.” Graphical user interface 1610 may include a default avatar and/or a user-personalized avatar on which the graphical fit indication is shown.

FIG. 16C is a graphical user interface 1620 for displaying fit indications according to some embodiments of the present disclosure. Graphical user interface 1620 includes information indicating to the user the garment sizing information determined for the user. In some embodiments, graphical user interface 1620 may be displayed to the user after the user provides body metrics (e.g., using graphical user interfaces 600, 700, 800, 900). In some embodiments, graphical user interface 1400 may be displayed after the body metrics system 141 and/or artificial intelligence system 151 has used the body metrics provided by the user (e.g., using graphical user interfaces 600, 700, 800, 900) and/or a garment specification (e.g., stored by measurements and sizing datastore server 152) to determine additional body measurements for the user and garment sizing information for the user. For example, graphical user interface 1620 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “just right.” Graphical user interface 1620 may include a default avatar and/or a user-personalized avatar on which the graphical fit indication is shown.

FIG. 16D is a graphical user interface 1630 for displaying fit indications according to some embodiments of the present disclosure. Graphical user interface 1630 includes information indicating to the user the garment sizing information determined for the user. In some embodiments, graphical user interface 1630 may be displayed to the user after the user provides body metrics (e.g., using graphical user interfaces 600, 700, 800, 900). In some embodiments, graphical user interface 1630 may be displayed after the body metrics system 141 and/or artificial intelligence system 151 has used the body metrics provided by the user (e.g., using graphical user interfaces 600, 700, 800, 900) and/or a garment specification (e.g., stored by measurements and sizing datastore server 152) to determine additional body measurements for the user and garment sizing information for the user. For example, graphical user interface 1630 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “slightly relaxed” or “just right.” Graphical user interface 1630 may include a default avatar and/or a user-personalized avatar on which the graphical fit indication is shown.

FIG. 16E is a graphical user interface 1640 for displaying fit indications according to some embodiments of the present disclosure. Graphical user interface 1640 includes information indicating to the user the garment sizing information determined for the user. In some embodiments, graphical user interface 1640 may be displayed to the user after the user provides body metrics (e.g., using graphical user interfaces 600, 700, 800, 900). In some embodiments, graphical user interface 1640 may be displayed after the body metrics system 141 and/or artificial intelligence system 151 has used the body metrics provided by the user (e.g., using graphical user interfaces 600, 700, 800, 900) and/or a garment specification (e.g., stored by measurements and sizing datastore server 152) to determine additional body measurements for the user and garment sizing information for the user. For example, graphical user interface 1640 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “relaxed” or “just right.” Graphical user interface 1640 may include a default avatar and/or a user-personalized avatar on which the graphical fit indication is shown.

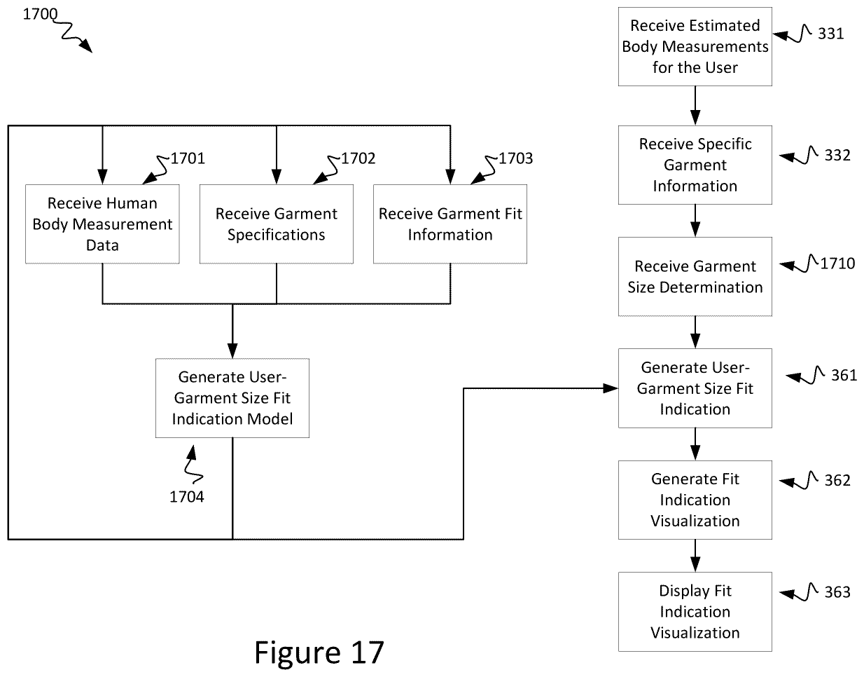

FIG. 17A is a flowchart diagram of a process 1700 for generating fit indications according to some embodiments of the present disclosure. Process 1700 may be performed using systems and components described elsewhere herein (e.g., system 100, computing device 200). Process 340 includes blocks 331, 332, 361, 362, and 363 as described with respect to process 360 of FIG. 3D, and elsewhere herein. In process 1700, blocks 331, 332, 361, 362, and 363 may operate substantially as described with respect to process 340.

At block 1701, human body measurement data is received. Block 1701 may be performed by body metrics system 141 and/or artificial intelligence system 151. In some embodiments, block 1701 may be performed substantially as described with respect to block 321 of process 360, or as described elsewhere herein.

At block 1702, garment specifications are received. Block 1702 may be performed by body metrics system 141 and/or artificial intelligence system 151. In some embodiments, block 1702 may be performed substantially as described with respect to block 322 of process 360, or as described elsewhere herein.

At block 1703, garment fit information is received. Block 1703 may be performed by body metrics system 141 and/or artificial intelligence system 151. In some embodiments, block 1703 may include receiving fit indications, as described elsewhere herein. The fit indications received may include a training set of fit indications to be used with information received at blocks 1701 and 1702 to train a fit indication model.

At block 1704, a user garment size fit indication model is generated. Block 1704 may be performed by body metrics system 141 and/or artificial intelligence system 151. In some embodiments, the fit indication model may be generated by training an artificial intelligence model and/or machine learning model using the information received at blocks 1701, 1702, and/or 1703 as training data. [The fit indication model may be an artificial intelligence model and/or machine learning model trained on estimated human body measurements, garments specifications, garment size determinations, received transaction information (e.g., purchase data, return data), and/or fit indications. In some embodiments, the fit indication model is a linear regression model or a neural network model. In some embodiments, block 361 may use a generative artificial neural network model that generates fit indications, such as by using a generative adversarial network approach. Training of the fit indication model at block 1704 may be performed substantially similar to block 323 of process 360, using additional or different types of training data.

At block 1710, a garment size determination is generated. Block 1710 may be performed by body metrics system 141 and/or artificial intelligence system 151. In some embodiments, block 1710 may be performed by receiving a garment size fit indication that is generated as described elsewhere herein (e.g., block 333).

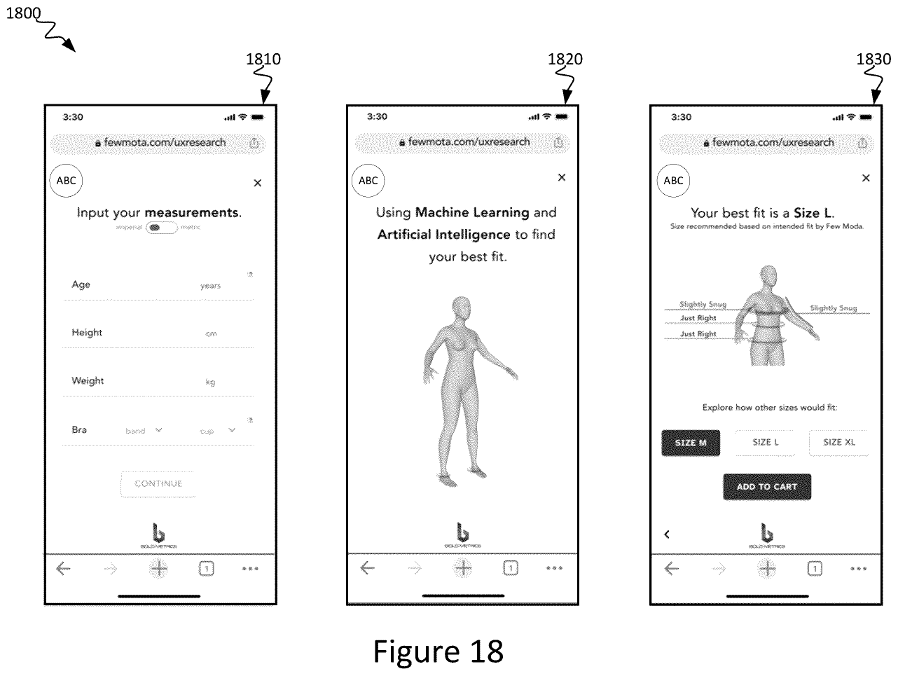

FIG. 18 is a set of graphical user interfaces 1800 according to some embodiments of the present disclosure. The set of graphical user interfaces 1800 includes graphical user interface 1810, graphical user interface 1820, and graphical user interface 1830. Graphical user interface 1810 may include a different format of graphical user interfaces 600, 700, 800, 900, such as a format optimized for a mobile device screen. Graphical user interface 1820 may include a different format of graphical user interface 1000, such as a format optimized for a mobile device screen. Graphical user interface 1830 may include a different format of graphical user interfaces 1200, 1300, 1400, 1500, 1600, such as a format optimized for a mobile device screen.

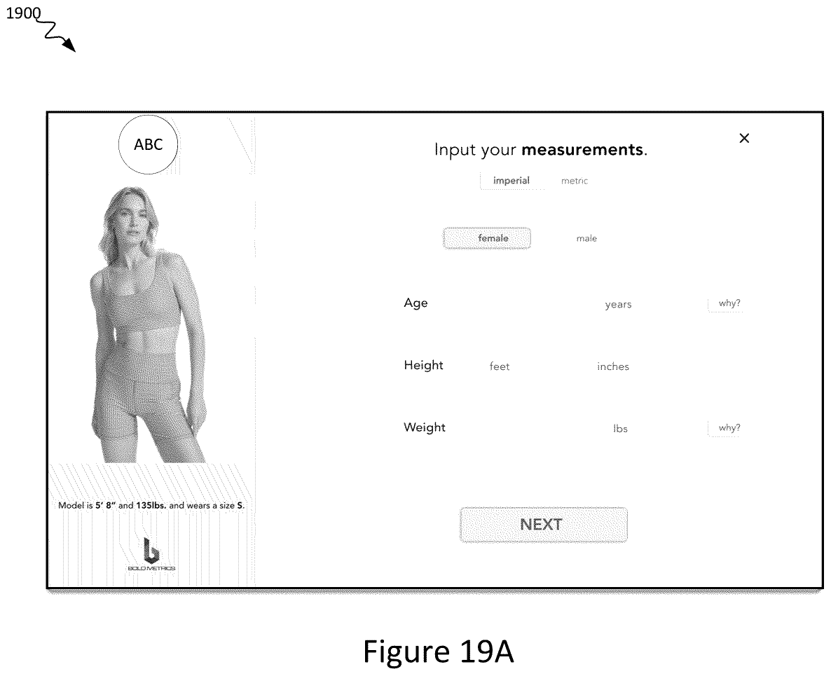

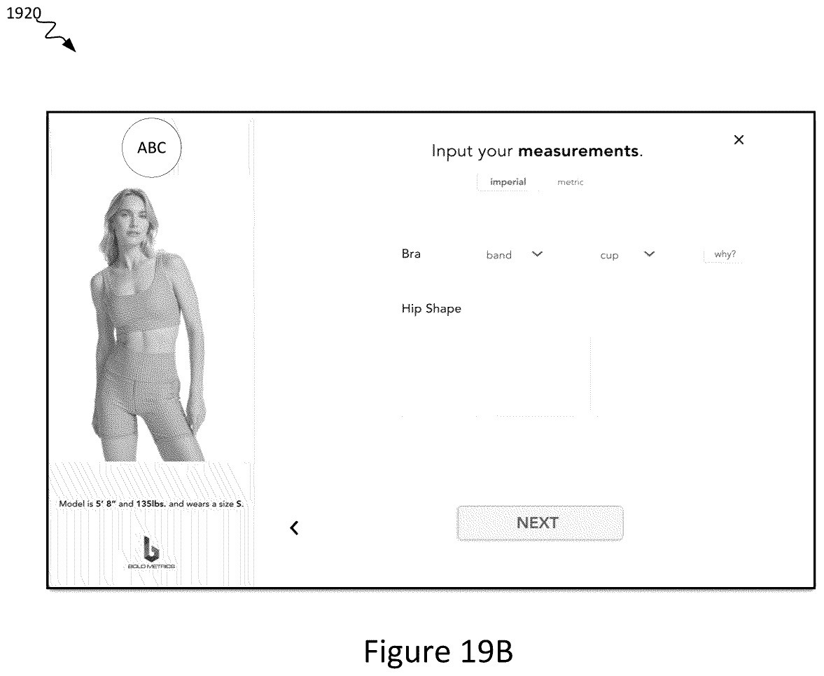

FIG. 19A is a graphical user interface 1900 according to some embodiments of the present disclosure. Graphical user interface 1900 includes fields for receiving body metrics of a user. For example, graphical user interface 1900 may allow a user to enter the user's age, the user's height, and the user's weight. In some embodiments, the graphical user interface 1900 may receive measurements of parts of the user's body, which may be used by body metrics system 141 and/or artificial intelligence system 151 to estimate additional measurements of other parts of the user's body. In some embodiments, graphical user interface 1900 may be presented to a user during enrollment in body metrics system 141. In some embodiments, graphical user interface 1900 may be presented when the user is a woman. The graphical user interface 1900 may include a graphical representation of the garment of clothing for which the garment sizing information has been determined. In some embodiments, the graphical representation of the garment may correspond to a specific size of the garment for which the garment sizing information will be determined.

FIG. 19B is a graphical user interface 1920 according to some embodiments of the present disclosure. Graphical user interface 1920 includes fields for receiving body metrics of a user. For example, graphical user interface 1920 may allow a user to enter the user's bra size and the user's hip shape. The graphical user interface 1920 may present the user with a predefined set of hip shape types to choose from, including an illustration and/or a textual label for each type of hip shape. In some embodiments, the graphical user interface 1920 may receive measurements of parts of the user's body, which may be used by body metrics system 141 and/or artificial intelligence system 151 to estimate additional measurements of other parts of the user's body. In some embodiments, graphical user interface 1900 may be presented to a user during enrollment in body metrics system 141. In some embodiments, graphical user interface 1920 may be presented when the user is a woman. The graphical user interface 1920 may include a graphical representation of the garment of clothing for which the garment sizing information has been determined. In some embodiments, the graphical representation of the garment may correspond to a specific size of the garment for which the garment sizing information will be determined.

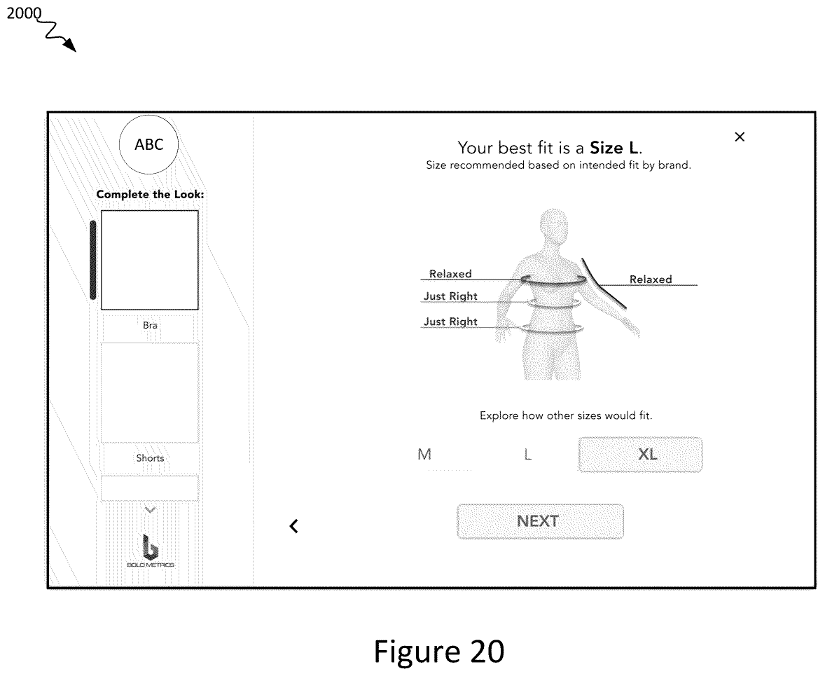

FIG. 20 is a graphical user interface 2000 according to some embodiments of the present disclosure. Graphical user interface 2000 includes information indicating to the user the garment sizing information determined for the user. In some embodiments, graphical user interface 2000 may be displayed to the user after the user provides body metrics (e.g., using graphical user interfaces 600, 700, 800, 900, 1800, 1900, 2300, 2400, 2500). In some embodiments, graphical user interface 2000 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 2000 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “relaxed” or “just right.” Graphical user interface 2000 may include a default avatar and/or a user-personalized avatar on which the graphical fit indication is shown. The graphical user interface 2000 may include a graphical representation of the garment of clothing for which the garment sizing information has been determined. In some embodiments, the graphical representation of the garment may correspond to a specific size of the garment for which the garment sizing information has been determined.

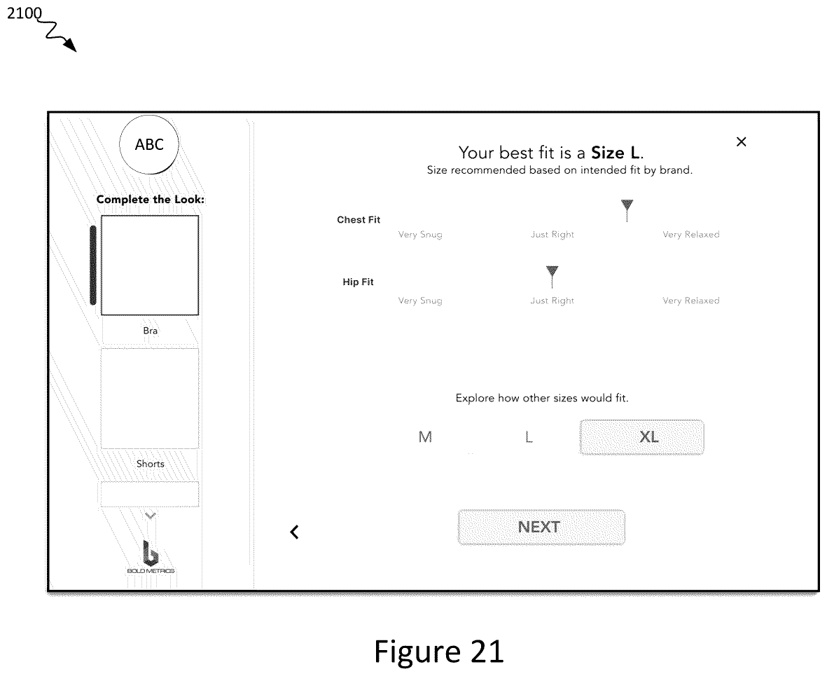

FIG. 21 is a graphical user interface 2100 according to some embodiments of the present disclosure. Graphical user interface 2100 includes information indicating to the user the garment sizing information determined for the user. In some embodiments, graphical user interface 2100 may be displayed to the user after the user provides body metrics (e.g., using graphical user interfaces 600, 700, 800, 900, 1800, 1900, 2300, 2400, 2500). In some embodiments, graphical user interface 2100 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 2100 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a chart fit indication of a fit of the specific garment size on the user's body, such as a line chart for one or more parts of the body and an indication of the fit of the garment on the line chart. The fit information may include a textual fit indication of a fit of the specific garment size on the user's body, such as “relaxed” or “just right.” Graphical user interface 2100 may include a default avatar and/or a user-personalized avatar on which the graphical fit indication is shown. The graphical user interface 2100 may include a graphical representation of the garment of clothing for which the garment sizing information has been determined. In some embodiments, the graphical representation of the garment may correspond to a specific size of the garment for which the garment sizing information has been determined.

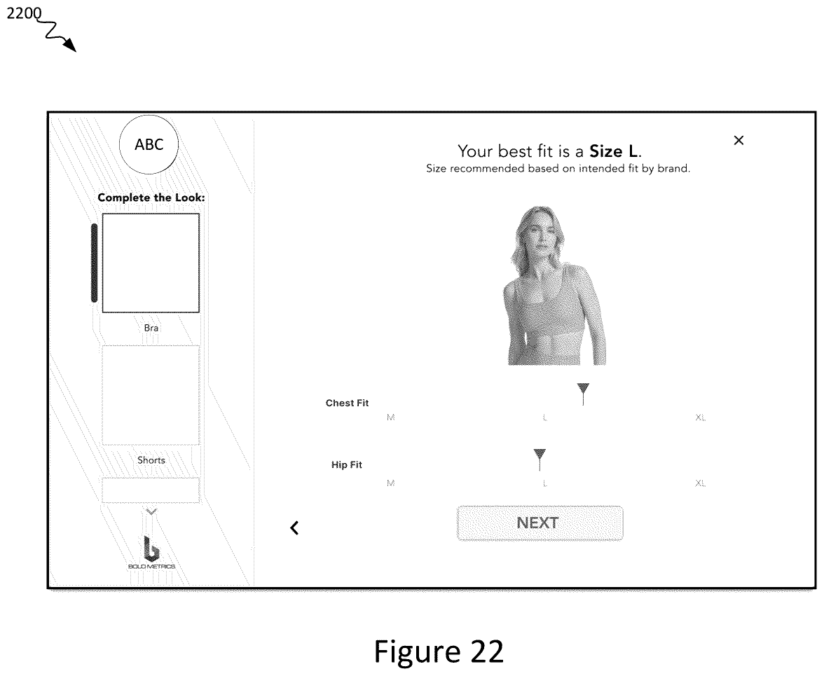

FIG. 22 is a graphical user interface according to some embodiments of the present disclosure. Graphical user interface 2200 includes information indicating to the user the garment sizing information determined for the user. In some embodiments, graphical user interface 2200 may be displayed to the user after the user provides body metrics (e.g., using graphical user interfaces 600, 700, 800, 900, 1800, 1900, 2300, 2400, 2500). In some embodiments, graphical user interface 2200 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 2200 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a chart fit indication of a fit of the specific garment size on the user's body, such as a line chart for one or more parts of the body and an indication of the fit of the garment on the line chart. The fit information may include a textual fit indication of a fit of the specific garment size on the user's body, such as “relaxed” or “just right.” Graphical user interface 2200 may include a default avatar and/or a user-personalized avatar on which the graphical fit indication is shown. The graphical user interface 2200 may include a graphical representation of the garment of clothing for which the garment sizing information has been determined. In some embodiments, the graphical representation of the garment may correspond to a specific size of the garment for which the garment sizing information has been determined.

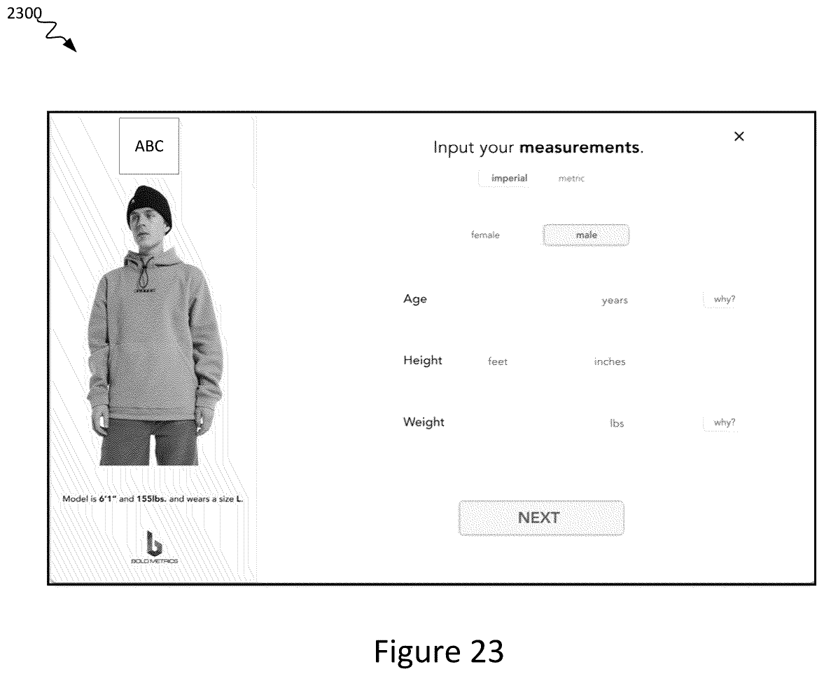

FIG. 23 is a graphical user interface 2300 according to some embodiments of the present disclosure. Graphical user interface 2300 includes fields for receiving body metrics of a user. For example, graphical user interface 2300 may allow a user to enter the user's age, the user's height, and the user's weight. In some embodiments, the graphical user interface 2300 may receive measurements of parts of the user's body, which may be used by body metrics system 141 and/or artificial intelligence system 151 to estimate additional measurements of other parts of the user's body. In some embodiments, graphical user interface 2300 may be presented to a user during enrollment in body metrics system 141. In some embodiments, graphical user interface 2300 may be presented when the user is a man. The graphical user interface 2300 may include a graphical representation of the garment of clothing for which the garment sizing information has been determined. In some embodiments, the graphical representation of the garment may correspond to a specific size of the garment for which the garment sizing information will be determined.

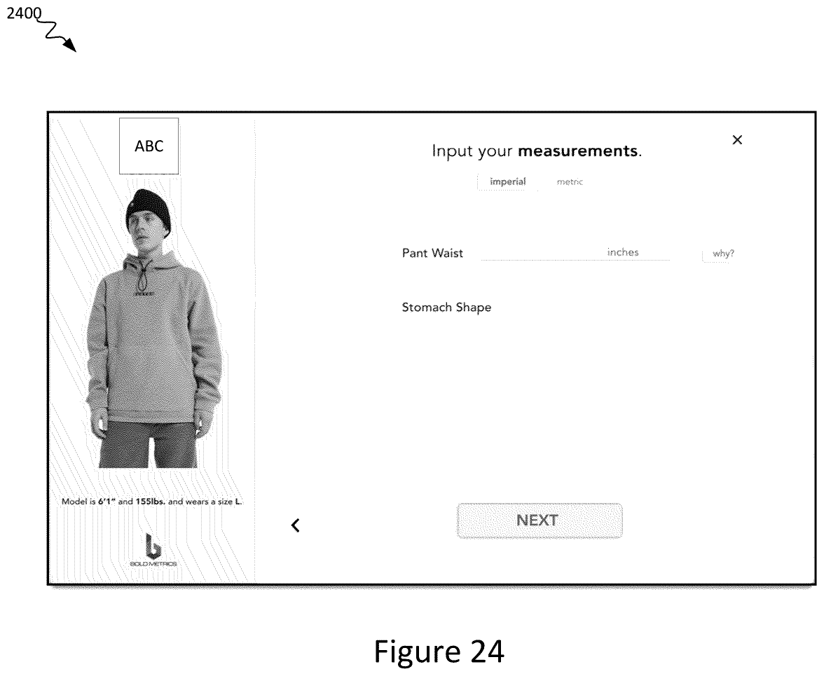

FIG. 24 is a graphical user interface 2400 according to some embodiments of the present disclosure. Graphical user interface 2400 includes fields for receiving body metrics of a user. For example, graphical user interface 2400 may allow a user to enter the user's pant waste and the user's stomach shape. The graphical user interface 2400 may present the user with a predefined set of stomach shape types to choose from, including an illustration and/or a textual label for each type of stomach shape. In some embodiments, the graphical user interface 2400 may receive measurements of parts of the user's body, which may be used by body metrics system 141 and/or artificial intelligence system 151 to estimate additional measurements of other parts of the user's body. In some embodiments, graphical user interface 2400 may be presented to a user during enrollment in body metrics system 141. In some embodiments, graphical user interface 2400 may be presented when the user is a man. The graphical user interface 2400 may include a graphical representation of the garment of clothing for which the garment sizing information has been determined. In some embodiments, the graphical representation of the garment may correspond to a specific size of the garment for which the garment sizing information will be determined.

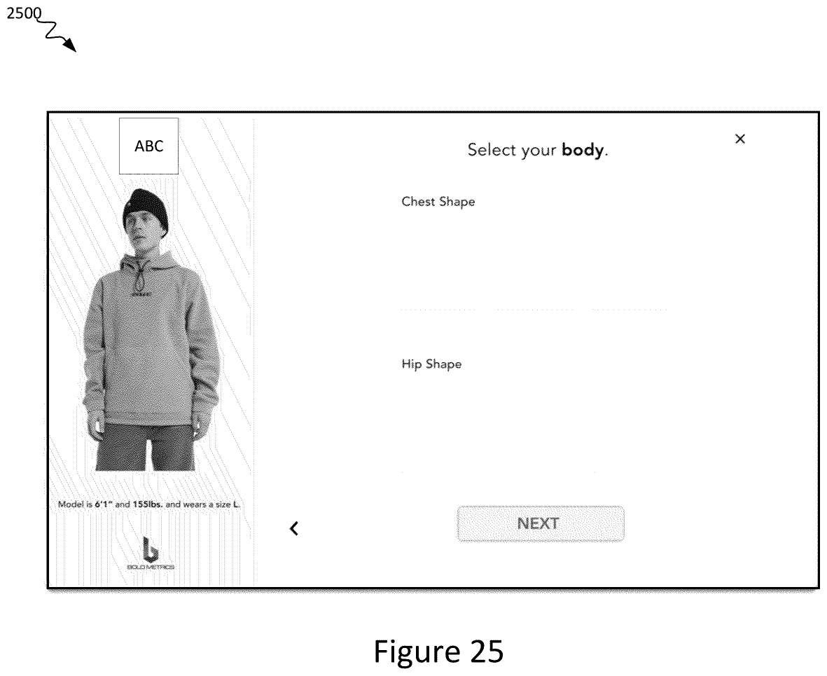

FIG. 25 is a graphical user interface 2500 according to some embodiments of the present disclosure. Graphical user interface 2500 includes fields for receiving body metrics of a user. For example, graphical user interface 2500 may allow a user to enter the user's chest shape and the user's hip shape. The graphical user interface 2500 may present the user with a predefined set of chest shape types to choose from, including an illustration and/or a textual label for each type of chest shape. The graphical user interface 2500 may present the user with a predefined set of hip shape types to choose from, including an illustration and/or a textual label for each type of hip shape. In some embodiments, the graphical user interface 2500 may receive measurements of parts of the user's body, which may be used by body metrics system 141 and/or artificial intelligence system 151 to estimate additional measurements of other parts of the user's body. In some embodiments, graphical user interface 2500 may be presented to a user during enrollment in body metrics system 141. In some embodiments, graphical user interface 2500 may be presented when the user is a man. The graphical user interface 2500 may include a graphical representation of the garment of clothing for which the garment sizing information has been determined. In some embodiments, the graphical representation of the garment may correspond to a specific size of the garment for which the garment sizing information will be determined.

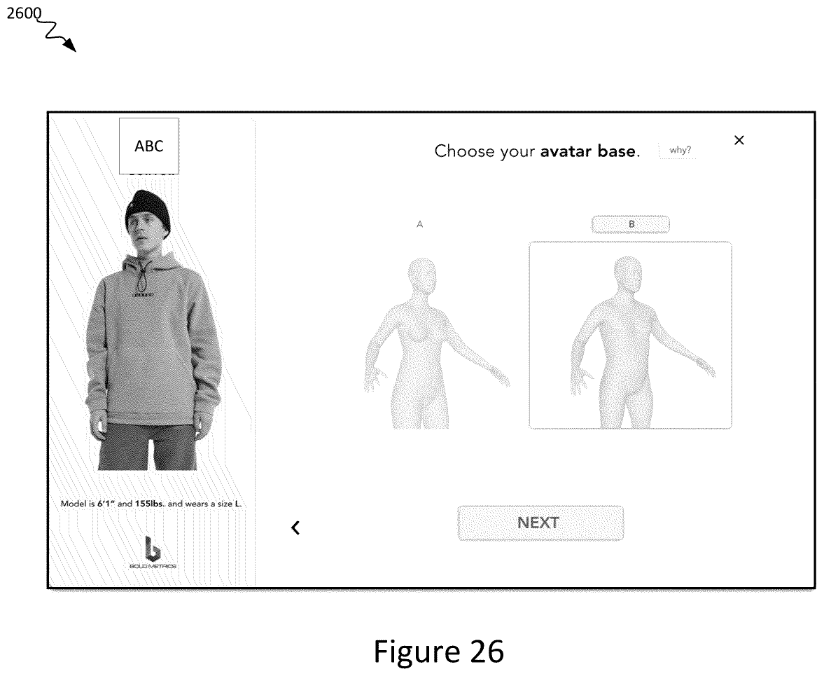

FIG. 26 is a graphical user interface 2600 according to some embodiments of the present disclosure. Graphical user interface 2600 includes an interface that allows a user to select an avatar base. The graphical user interface 2600 may present the user with a predefined set of avatar base types to choose from, including an illustration and/or a textual label for each type of avatar base. For example, the graphical user interface 2600 may present the user with an avatar base for a man and an avatar base for a woman. As another example, the graphical user interface 2600 may present the user with an avatar base for a youth, an avatar base for a child, and an avatar base for a toddler.

In some embodiments, the user device 101, 102, 103, 104, the on-premises terminal 121, and/or the body metrics system 141 may use the avatar base as the default avatar for the user.

In some embodiments, the body metrics system 141 and/or the artificial intelligence system may use the avatar base and the received body metrics information to customize the avatar base to create a personalized avatar for the user. For example, the body metrics system 141 and/or the artificial intelligence system may use the received body metrics of the user (e.g., received with user interfaces 600, 700, 800, 900, 1800, 1900, 2300, 2400, 2500) to increase/decrease the height of the base avatar, increase/decrease the waist circumference of the base/avatar, increase/decrease the bust size of the base avatar, increase/decrease the visualized body weight of the base avatar, change the hip shape of the base avatar, change the stomach shape of the base avatar, change the chest shape of the base avatar, and/or change other features of the base avatar in order to generate the personalized avatar for the user.

In some embodiments, the body metrics system 141 and/or the artificial intelligence system may use the avatar base, the received body metrics information, and/or estimated body information (e.g., as estimated by body metrics system 141 and/or artificial intelligence system 151) to customize the avatar base to create a personalized avatar for the user. For example, the body metrics system 141 and/or the artificial intelligence system may use the received body metrics of the user (e.g., received with user interfaces 600, 700, 800, 900, 1800, 1900, 2300, 2400, 2500) and/or estimated body information (e.g., as estimated by body metrics system 141 and/or artificial intelligence system 151) to increase/decrease the height of the base avatar, increase/decrease the waist circumference of the base/avatar, increase/decrease the bust size of the base avatar, increase/decrease the visualized body weight of the base avatar, change the hip shape of the base avatar, change the stomach shape of the base avatar, change the chest shape of the base avatar, increase/decrease the neck size of the base avatar, increase/decrease the thigh circumference of the base avatar, increase/decrease the shoulder width of the base avatar, increase/decrease the arms length of the base avatar and/or change other features of the base avatar in order to generate the personalized avatar for the user.

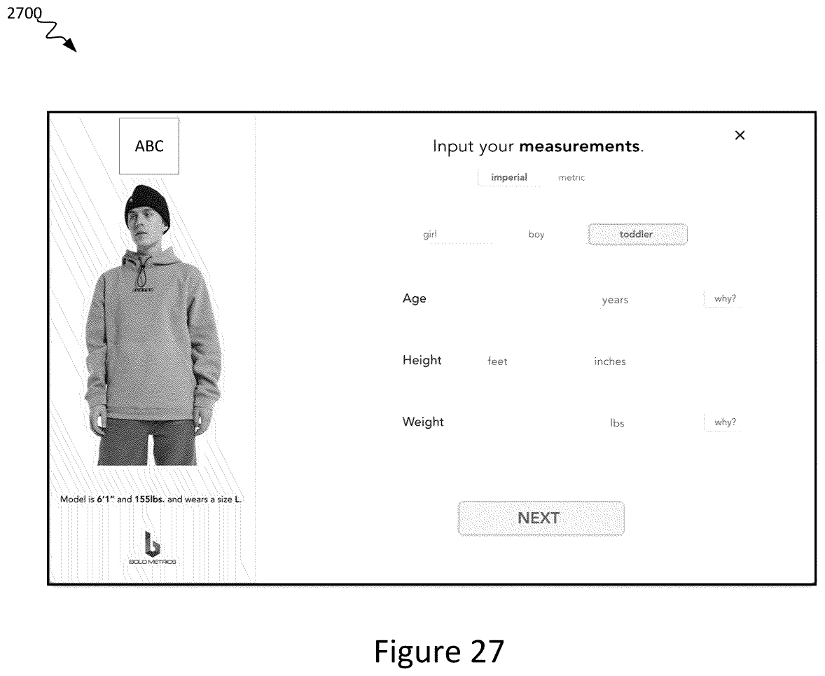

FIG. 27 is a graphical user interface 2700 according to some embodiments of the present disclosure. Graphical user interface 2700 includes fields for receiving body metrics of a user. For example, graphical user interface 2700 may allow a user to enter the user's age, the user's height, and the user's weight. In some embodiments, the graphical user interface 2700 may receive measurements of parts of the user's body, which may be used by body metrics system 141 and/or artificial intelligence system 151 to estimate additional measurements of other parts of the user's body. In some embodiments, graphical user interface 2700 may be presented to a user during enrollment in body metrics system 141. In some embodiments, graphical user interface 2700 may be presented when the user is a toddler. The graphical user interface 2700 may include a graphical representation of the garment of clothing for which the garment sizing information has been determined. In some embodiments, the graphical representation of the garment may correspond to a specific size of the garment for which the garment sizing information will be determined.

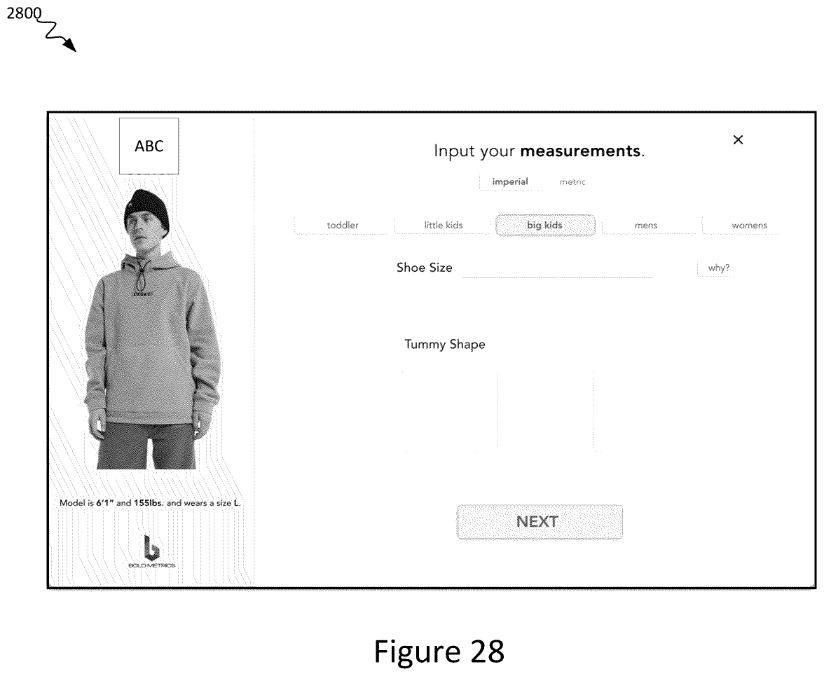

FIG. 28 is a graphical user interface 2800 according to some embodiments of the present disclosure. Graphical user interface 2800 includes fields for receiving body metrics of a user. For example, graphical user interface 2800 may allow a user to enter the user's shoe size and the user's tummy shape. The graphical user interface 2800 may present the user with a predefined set of tummy shape types to choose from, including an illustration and/or a textual label for each type of tummy shape. In some embodiments, the graphical user interface 2800 may receive measurements of parts of the user's body, which may be used by body metrics system 141 and/or artificial intelligence system 151 to estimate additional measurements of other parts of the user's body. In some embodiments, graphical user interface 2800 may be presented to a user during enrollment in body metrics system 141. In some embodiments, graphical user interface 2800 may be presented when the user is a big kid. The graphical user interface 2800 may include a graphical representation of the garment of clothing for which the garment sizing information has been determined. In some embodiments, the graphical representation of the garment may correspond to a specific size of the garment for which the garment sizing information will be determined.

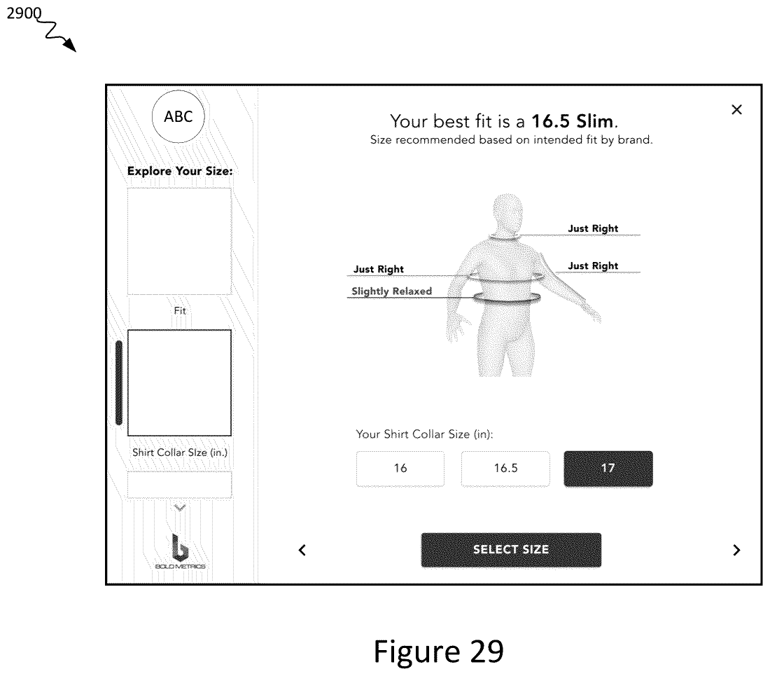

FIG. 29 is a graphical user interface 2900 according to some embodiments of the present disclosure. Graphical user interface 2900 includes information indicating to the user the garment sizing information determined for the user. In some embodiments, graphical user interface 2900 may be displayed to the user after the user provides body metrics (e.g., using graphical user interfaces 600, 700, 800, 900, 1800, 1900, 2300, 2400, 2500). In some embodiments, graphical user interface 2900 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 2900 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “slightly relaxed” or “just right.” Graphical user interface 2900 may include a default avatar and/or a user-personalized avatar on which the graphical fit indication is shown. The graphical user interface 2900 may include a graphical representation of the garment of clothing for which the garment sizing information has been determined. In some embodiments, the graphical representation of the garment may correspond to a specific size of the garment for which the garment sizing information has been determined.

Graphical user interface 2900 may further include: the best neck fit size for a specific garment for the user; a selected current neck size for the specific garment; and fit information for the selected current neck size for the specific garment for the user. The neck fit information may include a graphical fit indication (such as a shape-based indication, a color-based indication, and other graphical indications) and/or textual fit indication of a fit of the specific garment size on the user's neck, such as “just right.”

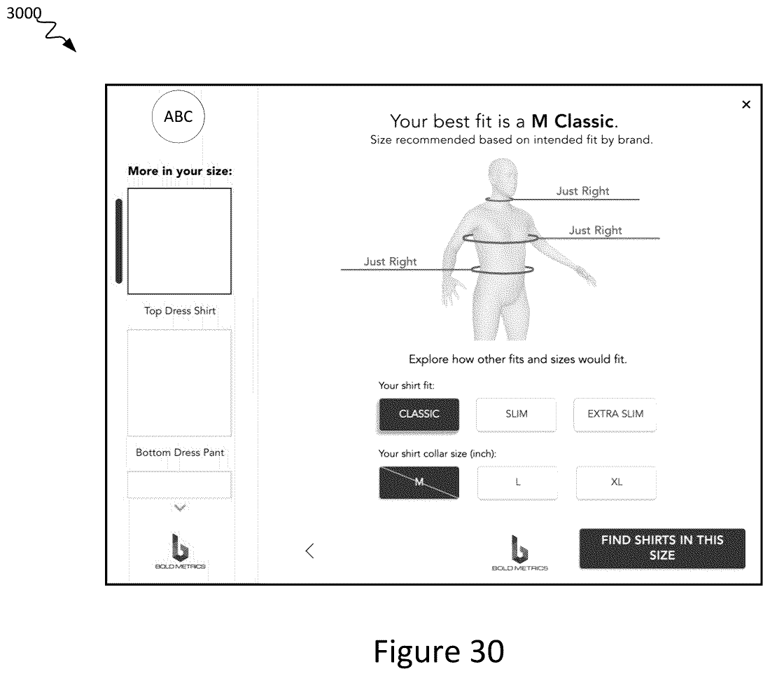

FIG. 30 is a graphical user interface 3000 according to some embodiments of the present disclosure. Graphical user interface 3000 includes information indicating to the user the garment sizing information determined for the user. In some embodiments, graphical user interface 3000 may be displayed to the user after the user provides body metrics (e.g., using graphical user interfaces 600, 700, 800, 900, 1800, 1900, 2300, 2400, 2500). In some embodiments, graphical user interface 3000 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 3000 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “just right.” Graphical user interface 3000 may include a default avatar and/or a user-personalized avatar on which the graphical fit indication is shown. The graphical user interface 3000 may include a graphical representation of the garment of clothing for which the garment sizing information has been determined. In some embodiments, the graphical representation of the garment may correspond to a specific size of the garment for which the garment sizing information has been determined.

Graphical user interface 3000 may further include garment sizing information and/or fit information for a specific size of the specific garment and also for a specific fit of the specific garment. In various embodiments, a specific fit for a specific garment may include: classic fit; slim fit; extra slim fit; relaxed fit; regular fit; athletic fit; modern fit; narrow leg fit; wide leg fit; bootcut fit; tapered leg fit; stretch fit; etc.

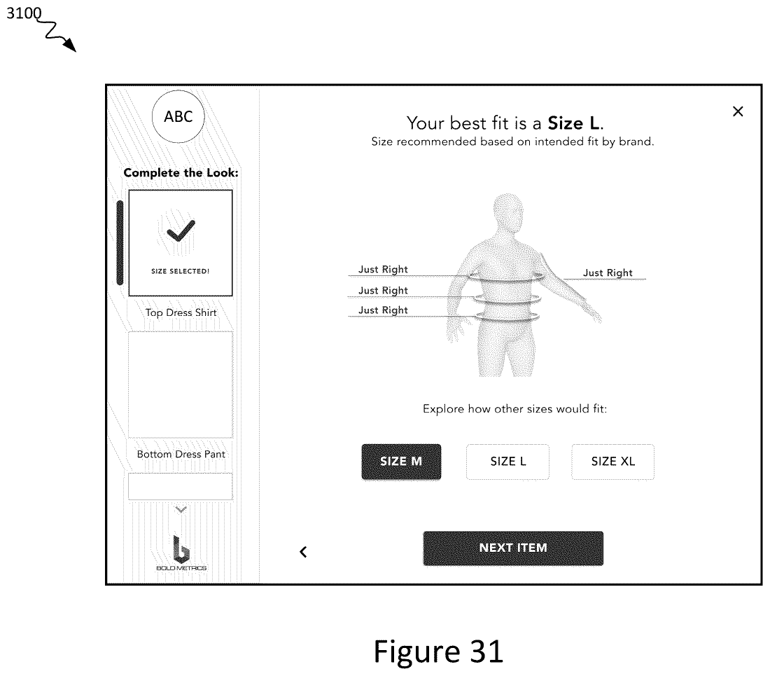

FIG. 31 is a graphical user interface 3100 according to some embodiments of the present disclosure. Graphical user interface 3100 includes information indicating to the user the garment sizing information determined for the user. In some embodiments, graphical user interface 3100 may be displayed to the user after the user provides body metrics (e.g., using graphical user interfaces 600, 700, 800, 900, 1800, 1900, 2300, 2400, 2500). In some embodiments, graphical user interface 3100 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 3100 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “just right.” Graphical user interface 3100 may include a default avatar and/or a user-personalized avatar on which the graphical fit indication is shown. The graphical user interface 3100 may include a graphical representation of the garment of clothing for which the garment sizing information has been determined. In some embodiments, the graphical representation of the garment may correspond to a specific size of the garment for which the garment sizing information has been determined. Graphical user interface 3100 may include garment set information, indicating a set of two or more garment items selected by or to be selected by the user.

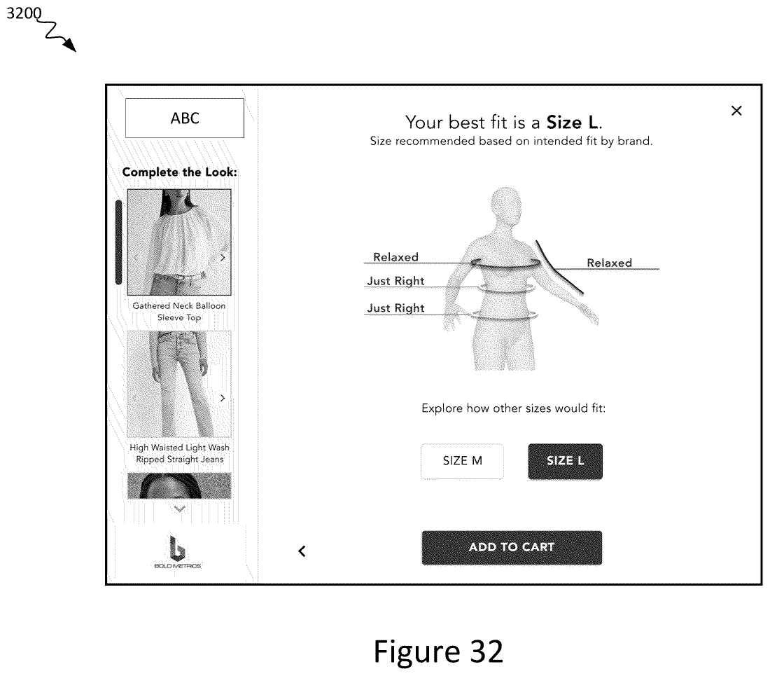

FIG. 32 is a graphical user interface 3200 according to some embodiments of the present disclosure. Graphical user interface 3200 includes information indicating to the user the garment sizing information determined for the user. In some embodiments, graphical user interface 3200 may be displayed to the user after the user provides body metrics (e.g., using graphical user interfaces 600, 700, 800, 900, 1800, 1900, 2300, 2400, 2500). In some embodiments, graphical user interface 3200 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 3200 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “just right.” Graphical user interface 3200 may include a default avatar and/or a user-personalized avatar on which the graphical fit indication is shown. The graphical user interface 3200 may include a graphical representation of the garment of clothing for which the garment sizing information has been determined. In some embodiments, the graphical representation of the garment may correspond to a specific size of the garment for which the garment sizing information has been determined. Graphical user interface 3200 may include garment set information, indicating a set of two or more garment items selected by or to be selected by the user.

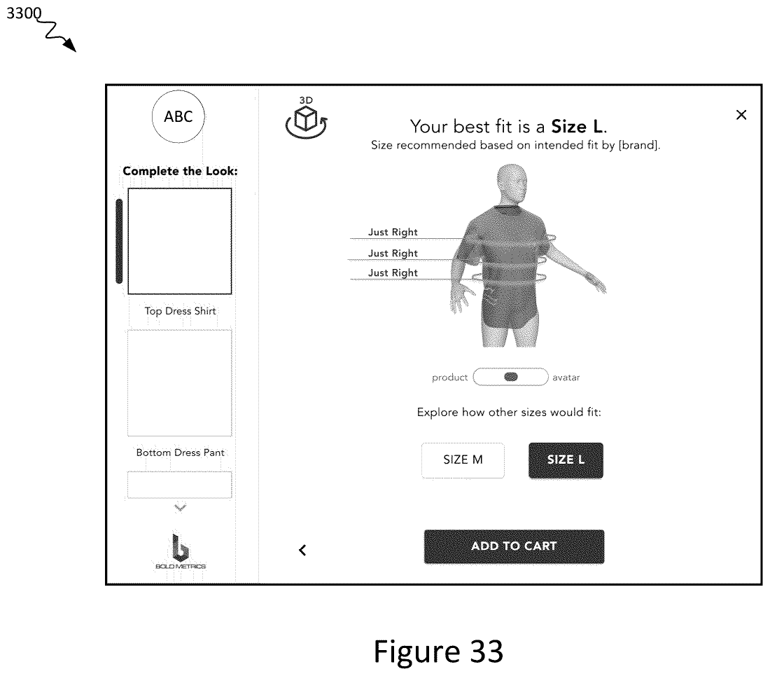

FIG. 33 is a graphical user interface 3300 according to some embodiments of the present disclosure. Graphical user interface 3300 includes information indicating to the user the garment sizing information determined for the user. In some embodiments, graphical user interface 3300 may be displayed to the user after the user provides body metrics (e.g., using graphical user interfaces 600, 700, 800, 900, 1800, 1900, 2300, 2400, 2500). In some embodiments, graphical user interface 3300 may be displayed after the body metrics system 141 and/or artificial intelligence system 151 has used the body metrics provided by the user (e.g., using graphical user interfaces 600, 700, 800, 900, 1800, 1900, 2300, 2400, 2500) and/or a garment specification (e.g., stored by measurements and sizing datastore server 152) to determine additional body measurements for the user and garment sizing information for the user. For example, graphical user interface 3300 may indicate to a user: the best fit size for a specific garment for the user; a selected current size for the specific garment; and fit information for the selected current size for the specific garment for the user. The fit information may include a graphical fit indication of a fit of the specific garment size on the user's body. The graphical fit indication may include a shape-based indication, a color-based indication, and other graphical indications. The fit information may include a textual fit indication of a fit of the specific garment size on the user's body, such as “just right.” Graphical user interface 3300 may include a default avatar and/or a user-personalized avatar on which the graphical fit indication is shown. The graphical user interface 3200 may include a graphical representation of the garment of clothing for which the garment sizing information has been determined. In some embodiments, the graphical representation of the garment may correspond to a specific size of the garment for which the garment sizing information has been determined. Graphical user interface 3300 may include garment set information, indicating a set of two or more garment items selected by or to be selected by the user.

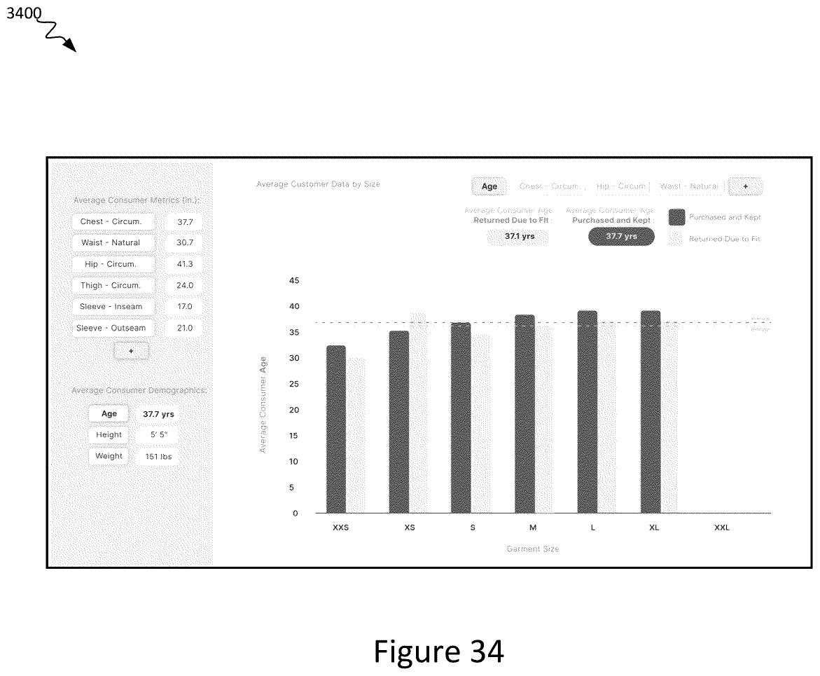

FIG. 34 is a graphical user interface 3400 according to some embodiments of the present disclosure. Graphical user interface 3400 includes user body measurements, garment sizing, and/or transactions information in a dashboard format according to some embodiments of the present disclosure. Graphical user interface 3400 may include information stored and/or generated by body metrics system 141, artificial intelligence system 151, measurements and sizing datastore server 152, and/or transactions datastore server 153. Graphical user interface 3400 includes information describing average user demographics and body measurements.

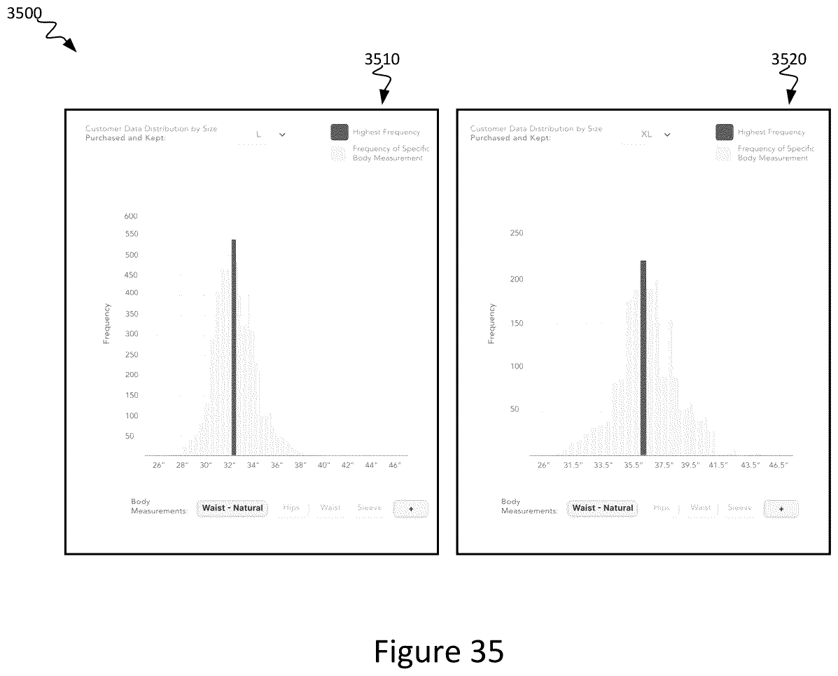

FIG. 35 is a set of graphical user interfaces 3500 according to some embodiments of the present disclosure. The set of graphical user interfaces 3500, including graphical user interfaces 3510 and 3520, includes user body measurements, garment sizing, and/or transactions information in a dashboard format according to some embodiments of the present disclosure. Graphical user interface 3500 may include information stored and/or generated by body metrics system 141, artificial intelligence system 151, measurements and sizing datastore server 152, and/or transactions datastore server 153. The set of graphical user interfaces 3500 includes information describing purchased and kept transactions (e.g., garments of clothing purchase and not returned) grouped by size information for the garments.

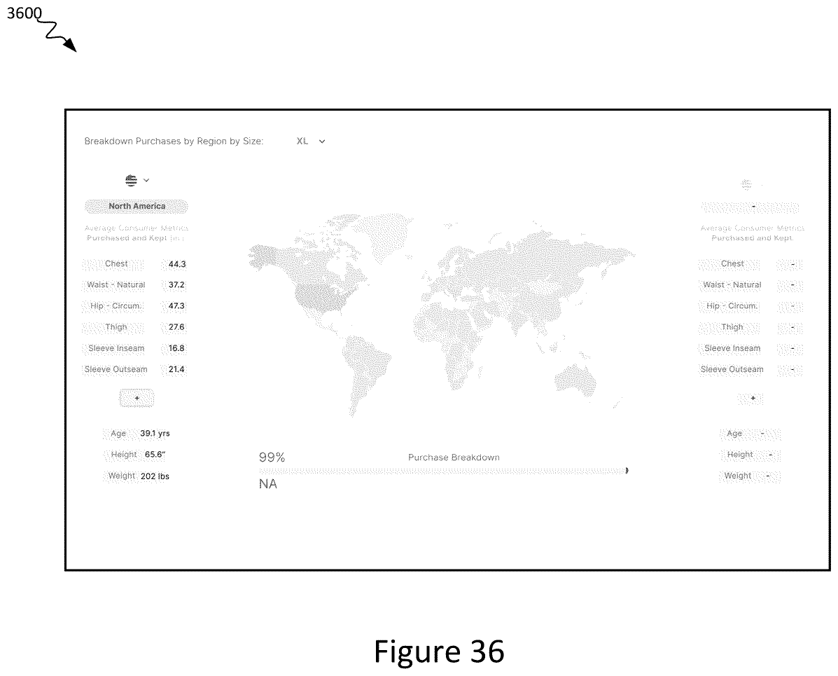

FIG. 36 is a graphical user interface 3600 according to some embodiments of the present disclosure. Graphical user interface 3600 includes user body measurements, garment sizing, and/or transactions information in a dashboard format according to some embodiments of the present disclosure. Graphical user interface 3600 may include information stored and/or generated by body metrics system 141, artificial intelligence system 151, measurements and sizing datastore server 152, and/or transactions datastore server 153. Graphical user interface 3600 includes information describing geographical distribution of users for one or more garments.

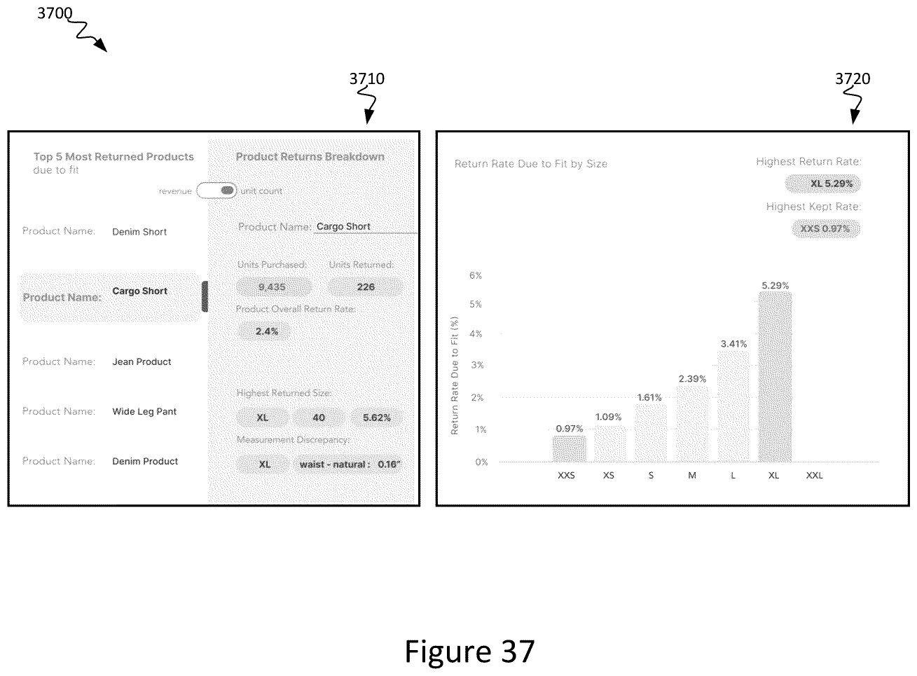

FIG. 37 is a graphical user interface 3700 according to some embodiments of the present disclosure. The set of graphical user interfaces 3700, including graphical user interfaces 3710 and 3720, includes user body measurements, garment sizing, and/or transactions information in a dashboard format according to some embodiments of the present disclosure. Graphical user interface 3700 may include information stored and/or generated by body metrics system 141, artificial intelligence system 151, measurements and sizing datastore server 152, and/or transactions datastore server 153. The set of graphical user interfaces 3700 includes information describing garment return information, including garment return information based on size of garment.

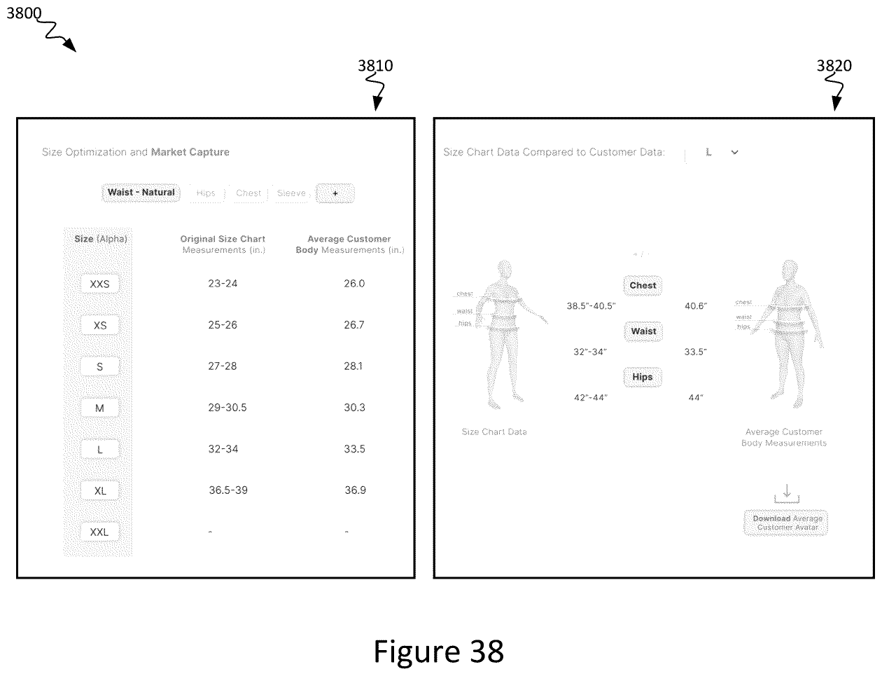

FIG. 38 is a set of graphical user interfaces 3800 according to some embodiments of the present disclosure. The set of graphical user interfaces 3800, including graphical user interfaces 3810 and 3820, includes user body measurements, garment sizing, and/or transactions information in a dashboard format according to some embodiments of the present disclosure. Graphical user interface 3800 may include information stored and/or generated by body metrics system 141, artificial intelligence system 151, measurements and sizing datastore server 152, and/or transactions datastore server 153. The set of graphical user interfaces 3800 includes information describing garment measurement information for specific sizes of the garment, and corresponding user measurement information for the specific sizes of the garment.

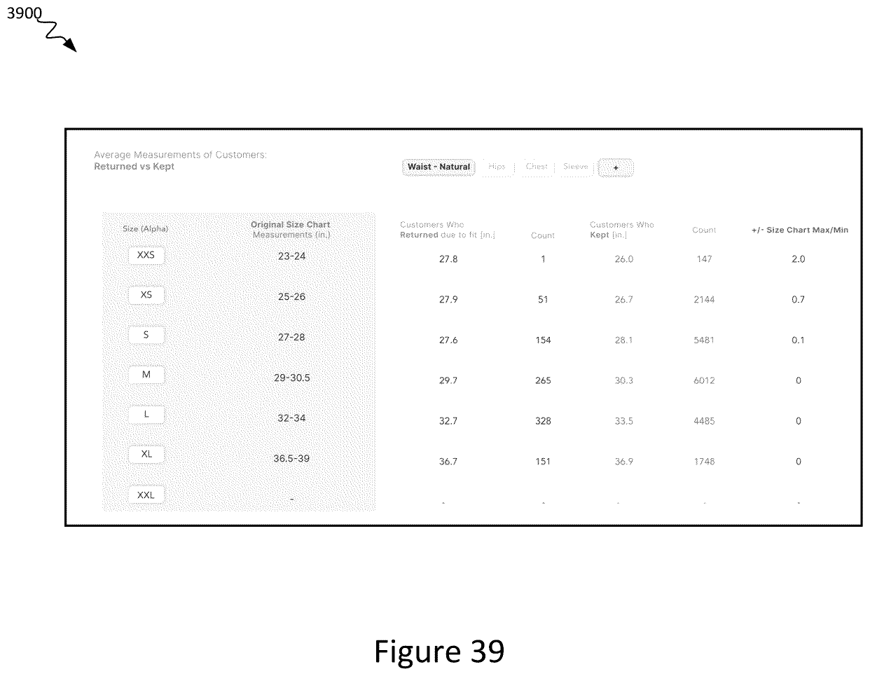

FIG. 39 is a graphical user interface 3900 according to some embodiments of the present disclosure. Graphical user interface 3900 includes user body measurements, garment sizing, and/or transactions information in a dashboard format according to some embodiments of the present disclosure. Graphical user interface 3900 may include information stored and/or generated by body metrics system 141, artificial intelligence system 151, measurements and sizing datastore server 152, and/or transactions datastore server 153. Graphical user interface 3900 includes information describing body measurements of users for garments, grouped by sizes for those garments.

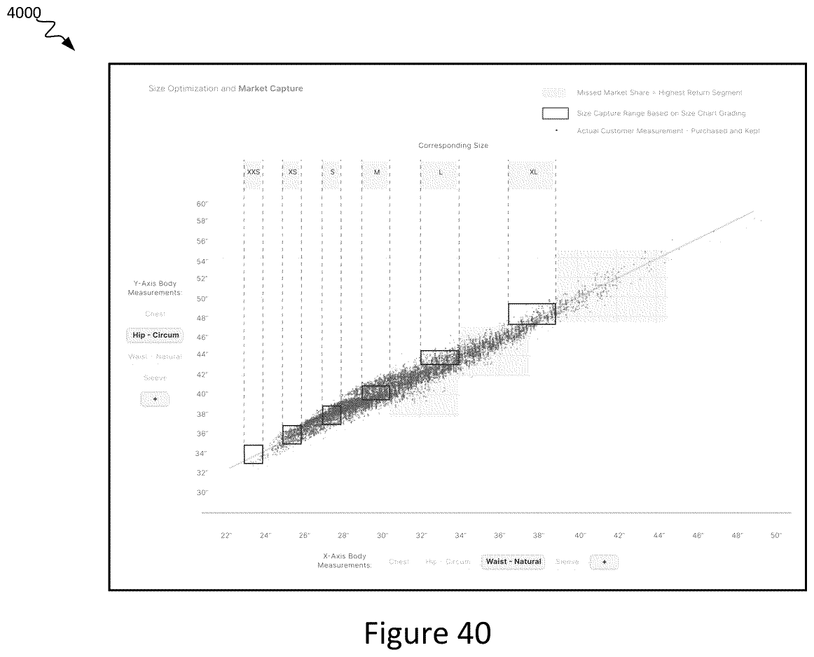

FIG. 40 is a graphical user interface 4000 according to some embodiments of the present disclosure. Graphical user interface 4000 includes user body measurements, garment sizing, and/or transactions information in a dashboard format according to some embodiments of the present disclosure. Graphical user interface 4000 may include information stored and/or generated by body metrics system 141, artificial intelligence system 151, measurements and sizing datastore server 152, and/or transactions datastore server 153. Graphical user interface 4000 includes information describing optimized garment size information. The optimized garment size information included in graphical user interface 4000 may include information indicating measurements for sizes of a specific garment that matches one or more users. The one or more users may be drawn from: users that have purchased the garment of clothing; users that have purchased the garment of clothing and returned the garment of clothing; users that have purchased the garment of clothing and not returned the garment of clothing users that may purchase the garment of clothing; and/or other groups of users. The information included in graphical user interface 4000 may be generated by body metrics system 141 and/or artificial intelligence system 151 using artificial intelligence models and/or machine learning models as described elsewhere herein.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method performed by one or more computing devices comprising one or more processors, the one or more computing devices operating one or more artificial intelligence models trained based on at least one of human body physiological data, such as human body part measurements, and physical garment measurement data, the method comprising:
transmitting a user prompt for presentation to a user, wherein the user prompt includes information for prompting the user to input one or more first physiological attributes for the user;
receiving a user response to the user prompt, wherein the user response includes information describing one or more first physiological attributes of the user;
generating a plurality of estimated body measurements for the user, wherein the plurality of estimated body measurements for the user are generated by applying the information describing one or more first physiological attributes of the user as input to an artificial intelligence model;
generating a garment size determination for the user, wherein the garment size determination for the user is generated based on at least one of the plurality of estimated body measurements for the user and based at least in part on a garment specification, wherein the garment specification includes information describing sizing characteristics of a garment of clothing;
generating, based on at least one of the plurality of estimated body measurements for the user, the garment specification, and the garment size determination, one or more fit indications for the user for one or more sizes of the garment of clothing, wherein the one or more fit indications indicate an expected fit for the garment of clothing on the body of the user at a point of measurement on the body of the user.

2. The method of claim 1, further comprising:
generating a fit indication visualization, wherein the fit indication visualization includes a graphic representation of the fit indication.

3. The method of claim 2, wherein the one or more fit indications for the user for one or more sizes of the garment of clothing include a textual fit description of an estimated fit of the garment of clothing for the user at a point of measurement on the body of the user.

4. The method of claim 3, further comprising:
generating a 3D avatar visualization for the user;
wherein the fit indication visualization includes displaying the textual fit description adjacent to a corresponding point of measurement on the body of the avatar.

5. The method of claim 4, wherein the fit indication visualization further includes one or more colors selected from a predefined color scheme indicating an expected fit for the garment of clothing on the body of the user at a point of measurement on the body of the user.

6. The method of claim 4, wherein the 3D avatar visualization for the user is a default 3D avatar visualization for the user.

7. The method of claim 4, wherein generating the 3D avatar visualization for the user comprises:
generating a 3D representation of the body of the user based on one or more of the plurality of estimated body measurements for the user.

8. The method of claim 7, wherein the 3D avatar visualization is a body-realistic visualization of the user's body.

9. The method of claim 1, further comprising:
receiving transaction information; and
updating the artificial intelligence model based on the received transaction information.

10. The method of claim 9, wherein the transaction information comprises one or more of: garment purchase data; and garment return data.

11. The method of claim 1, wherein the information describing one or more first physiological attributes of the user comprises one or more of: age, height; weight; pant waist; and bra size.

12. The method of claim 1, wherein the plurality of estimated body measurements for the user comprises two or more of: hip circumference; waist circumference; waist circumference at stomach; chest circumference; neck circumference; shoulder length; and
head size.

13. The method of claim 1, wherein information describing sizing characteristics of a garment of clothing comprises one or more of: available sizes for the garment of clothing; available fits for the garment of clothing; and physical measurements for the garment of clothing.

14. The method of claim 1, wherein the garment size determination for the user for the garment of clothing is generated based on a second artificial intelligence model.

15. The method of claim 14, wherein the first artificial intelligence model and the second artificial intelligence model are different artificial intelligence models.

16. The method of claim 1, wherein the artificial intelligence model comprises one or more of: a machine learning model; and an artificial neural network.
